(19) United States
(12) Patent Application Publication
(10) Pub. No.: US 2016/0337223 A1
(43) Pub. Date: Nov. 17, 2016

(54) BANDWIDTH AND LATENCY ESTIMATION IN A COMMUNICATION NETWORK

(71) Applicant: Distrix Networks Ltd., Vancouver (CA)

(72) Inventor: Kenneth J. Mackay, Richmond (CA)

(21) Appl. No.: 15/222,463

(22) Filed: Jul. 28, 2016

Related U.S. Application Data
(63) Continuation of application No. PCT/US2015/014127, filed on Feb. 2, 2015.
(60) Provisional application No. 61/935,483, filed on Feb. 4, 2014.

(51) Int. Cl. H04L 12/26

(52) U.S. Cl. CPC H04L 43/0894; H04L 43/12; H04L 43/16; H04L 43/0841; H04L 43/0864; H04L 43/087

(57) ABSTRACT

The disclosure provides examples of systems and methods for bandwidth or latency estimation in a communication network. In one example, a digital network communication system is configured to manage transmission of data packets among computing nodes of the network. The system is configured to send a bandwidth request to a remote side of the network data link and receive a response from the remote side. The bandwidth request includes a request index, a current timestamp, and an amount of data sent since a previous bandwidth request. The response includes the request index, the current timestamp, an amount of data received since the previous bandwidth request, and a receive interval between when the bandwidth request was received and when the previous bandwidth request was received. The system is configured to calculate an achieved network bandwidth or a link latency based at least in part on the request and the response.

### CROSS-REFERENCE TO RELATED APPLICATIONS

This application is a continuation of international patent application no. PCT/US2015/014127, filed Feb. 2, 2015, entitled “BANDWIDTH AND LATENCY ESTIMATION IN A COMMUNICATION NETWORK,” which claims the benefit of priority to U.S. Patent Application No. 61/935,483, filed Feb. 4, 2014, entitled “BANDWIDTH AND LATENCY ESTIMATION;” each of which is incorporated by reference herein in its entirety to form part of this specification.

### BACKGROUND

Companies and organizations operate computer networks that interconnect numerous computing systems to support their operations. The computing systems can be located in a single geographical location (e.g., as part of a local network) or located in multiple distinct geographical locations (e.g., connected via one or more private or public intermediate networks). Data centers may house significant numbers of interconnected computing systems, such as, e.g., private data centers are operated by a single organization and public data centers operated by third parties to provide computing resources to customers. Public and private data centers may provide network access, power, hardware resources (e.g., computing and storage), and secure installation facilities for hardware owned by the data center, an organization, or by other customers.

As the scale and scope of data networking has increased, the task of provisioning, administering, and managing computing networks has become increasingly complicated.

### SUMMARY

The systems, methods, computer-readable storage media, and devices of this disclosure each have several innovative aspects, no single one (or group) of which is solely responsible for the desirable attributes disclosed herein.

The disclosure provides examples of systems and methods for adaptive load balancing, prioritization, bandwidth reservation, and/or routing in a network communication system. In various embodiments, the disclosed methods can provide reliable multi-path load-balancing, overflow, and/or failover services for routing over a variety of network types. In some embodiments, disconnected routes can be rebuilt by selecting feasible connections. The disclosure also provides examples of methods for filtering information in peer-to-peer network connections and assigning permission levels to nodes in peer-to-peer network connections. Certain embodiments described herein may be applicable to mobile, low-powered, and/or complex sensor systems.

An embodiment of a digital network communication system is disclosed. The system comprises a communication layer component that is configured to manage transmission of data packets among a plurality of computing nodes, at least some of the plurality of computing nodes comprising physical computing devices. The communication layer component comprises a physical computing device configured to receive, from a computing node, one or more data packets to be transmitted via one or more network data links; estimate a latency value for at least one of the network data links; estimate a bandwidth value for at least one of the network data links; determine an order of transmitting the data packets, wherein the order is determined based at least partly on the estimated latency value or the estimated bandwidth value of at least one of the network data link; and send the data packets over the network data links based at least partly on the determined order. In some implementations, the system can identify at least one of the one or more network data links for transmitting the data packets based at least partly on the estimated latency value of the estimated bandwidth value. The system can send the data packets over the identified at least one of the network data links based at least partly on the determined order.

Another embodiment of a digital network communication system is disclosed. The system comprises a communication layer component that is configured to manage transmission of data packets among a plurality of computing nodes, at least some of the plurality of computing nodes comprising physical computing devices. The communication layer component comprises a physical computing device configured to assign a priority value to each of the data packets; calculate an estimated amount of time a data packet will stay in a queue for a network data link by accumulating a wait time associated with each data packet in the queue with a priority value higher than or equal to the priority value of the data packet that will stay in the queue; and calculate an estimated wait time for the priority value, wherein the estimated wait time is based at least partly on an amount of queued data packets of the priority value and an effective bandwidth for the priority value, wherein the effective bandwidth for the priority value is based at least partly on a current bandwidth estimate for the network data link and a rate with which data packets associated with a priority value that is higher than the priority value are being inserted to the queue.

Another embodiment of a digital network communication system is disclosed. The system comprises a communication layer component that is configured to manage transmission of data packets among a plurality of computing nodes, at least some of the plurality of computing nodes comprising physical computing devices. The communication layer component comprises a physical computing device configured to create a queue for each of a plurality of reserved bandwidth streams; add data packets that cannot be transmitted immediately and are assigned to a reserved bandwidth stream to the queue for the stream; create a ready-to-send priority queue for ready-to-send queues; create a waiting-for-bandwidth priority queue for waiting-for-bandwidth queues; move all queues in the waiting for bandwidth priority queue with a ready-time less than a current time into the ready to send priority queue; select a queue with higher priority than all other queues in the ready to send priority queue; and remove and transmit a first data packet in the queue with higher priority than all other queues in the ready to send priority queue.

The disclosure provides examples of systems and methods for bandwidth or latency estimation in a communication network. In one example, a digital network communication system is configured to manage transmission of data packets among computing nodes of the network. The system is configured to send a bandwidth request to a remote side of the network data link and receive a response from the remote side. The bandwidth request includes a request index, a current timestamp, and an amount of data sent since a previous bandwidth request. The response includes the request index, the current timestamp, an amount of data received since the previous bandwidth request, and a receive interval between when the bandwidth request was received and when the previous bandwidth request was received. The system is configured to calculate an achieved network bandwidth or a link latency based at least in part on the request and the response.

An embodiment of a digital network communication system comprises a communication layer component that is configured to manage transmission of data packets among a plurality of computing nodes, at least some of the plurality of computing nodes comprising physical computing devices. The communication layer component comprises a physical computing device configured to estimate network bandwidth of a network data link between two computing nodes by sending a current bandwidth request to a remote side of the network data link, the current bandwidth request comprising a request index, a current timestamp, and an amount of data sent since a previous bandwidth request. The communication layer component is configured for receiving from the remote side of the network data link a response to the bandwidth request, the response comprising the request index, the current timestamp, an amount of data received since the previous bandwidth request, and a receive interval between when the current bandwidth request was received and when the previous bandwidth request was received. The communication layer component is further configured for calculating an achieved network bandwidth based on a ratio of the amount of data received since the previous bandwidth request and the receive interval, and determining an estimated network bandwidth based at least in part on the achieved network bandwidth.

An embodiment of a computer-implemented method for estimating network bandwidth and latency of a network data link between two computing nodes is provided. The method is performed under control of a communication layer component configured to manage transmission of data packets among a plurality of computing nodes, with at least some of the plurality of computing nodes comprising physical computing devices, and with the communication layer component comprising physical computing hardware. The method comprises sending a current bandwidth request to a remote side of the network data link, with the current bandwidth request comprising a request index, a current timestamp, and an amount of data sent since a previous bandwidth request; and receiving from the remote side of the network data link a response to the bandwidth request, with the response comprising the request index, the current timestamp, an amount of data received since the previous bandwidth request, and a receive interval between when the current bandwidth request was received and when the previous bandwidth request was received. The method further comprises calculating an achieved network bandwidth based on a ratio of the amount of data received since the previous bandwidth request and the receive interval; and calculating a link latency based at least in part on a difference between the current timestamp in the response and the current time.

### BRIEF DESCRIPTION OF THE DRAWINGS

Throughout the drawings, reference numbers are re-used to indicate correspondence between referenced elements. The drawings are provided to illustrate embodiments of the disclosure and not to limit the scope thereof.

FIG. 1A is a block diagram that schematically illustrates an example of a system utilizing adaptive load balancing among other features.

FIG. 1B schematically illustrates an example of a high-level overview of a network overlay architecture.

FIGS. 1C-1, 1C-2, and 1C-3 are illustrative examples of implementations of network architectures. FIG. 1C-1 shows an example of a Peer-to-Peer network architecture; FIG. 1C-2 shows an example of a Peer-to-Peer Client-Server architecture; and FIG. 1C-3 shows an example of a distributed Peer-to-Peer Client-Server architecture.

FIGS. 1D-1 and 1D-2 schematically illustrate examples of routes in networks.

FIG. 2 is a diagram that schematically illustrates an example of a situation that could occur in a network in which there are one or more links between two nodes A and B.

FIG. 3 is a diagram that schematically illustrates an example of segmenting, reordering, and reassembling a dataset.

FIG. 4A illustrates an example situation in a network in which there is one input stream with a low priority, sending a 1 KB packet once every millisecond.

FIG. 4B illustrates an example of the behavior of the example network of FIG. 4A after a second higher-priority stream has been added that sends a 1 KB packet every 20 ms.

FIG. 4C illustrates an example of the behavior of the example network of FIGS. 4A, 4B if the high-priority stream starts sending data at a rate greater than or equal to 100 KB/s.

FIG. 4D illustrates an example of the behavior of the example network of FIGS. 4A, 4B, and 4C a time after the state shown in FIG. 4D. At this time, the fast link's queue is filled with high-priority packets in this example.

FIG. 5 schematically illustrates an example of a queue with a maximum queue size.

FIGS. 6A and 6B illustrate examples of queue size and drop probability as a function of time.

FIG. 7 schematically illustrates a flow diagram presenting an overview of how various methods and functionality interacts when sending and receiving data to/from a destination node.

FIG. 8 is an example of a state diagram showing an implementation of a method for rebuilding routes in a distance vector routing system.

FIG. 9 is a diagram that illustrates an example of filtering in an example of a peer-to-peer network.

FIG. 10 is a diagram that illustrates an example of nodes with group assignments.

FIG. 11 schematically illustrates an example of a network architecture and communications within the network.

FIG. 12 is a flow chart illustrating one embodiment of a method implemented by the communication system for receiving and processing, and/or transmitting data packets.

FIG. 13 is a flow chart illustrating one embodiment of a method implemented by the communication system for processing and transmitting data packets.

FIG. 14 is a flow chart illustrating one embodiment of a method implemented by the communication system for transmitting subscription-based information.

FIG. 15 is a flow chart illustrating one embodiment of a method implemented by the communication system for adding a link to an existing or a new connection.

FIG. 16 is a flow chart illustrating one embodiment of a method implemented by the communication system to generate bandwidth estimates.

FIG. 16A is a flow chart illustrating an embodiment of a method to generate a bandwidth estimate or a latency estimate of a network data link between two computing nodes of a communication network.

FIG. 17 is a flow chart illustrating one embodiment of a method implemented by the communication system to provide prioritization.

FIG. 18 is a flow chart illustrating one embodiment of a method implemented by the communication system to calculate bandwidth with low overhead.

FIG. 19 is a block diagram schematically illustrating an embodiment in which a computing device, which may be used to implement the systems and methods described in this disclosure.

FIG. 20 is a block diagram schematically illustrating an embodiment of a node architecture.

### DETAILED DESCRIPTION

The present disclosure provides a variety of examples related to systems, methods, and computer-readable storage configured for adaptive load-balanced communications, prioritization, bandwidth reservation, routing, filtering, and/or access control in distributed networks.

### I. EXAMPLES OF ADAPTIVE LOAD-BALANCED COMMUNICATIONS

Provision of seamless mobility for network users presents two serious challenges. First, point-to-point connections handover automatically as users move in and out of range of satellite, cellular and wireless local area network (WLAN) or other Internet protocol (IP) or non-IP wireless network type base stations. Second, automatic handover between heterogeneous mobile and fixed-line networks of various types enables service providers to deliver connectivity over mixed wireless and/or wired connections (different network services) that may be made available or unavailable over time in order to maximize efficiencies.

In today's environment, mobile users often need to stop using one communication service and initiate a connection to another to maintain connectivity. This may impact the user experience, particularly with streaming media content including but not limited to voice (such as Voice over Internet Protocol (VoIP)) and video (such as h.264 advanced video coding format), as content may often be lost during connection downtime.

The presented adaptive load-balanced communication approach provides methods of providing seamless and reliable mobile communications by automating horizontal and vertical handoff between different network services. In some implementations, the method can achieve this by performing one or more of the following:
Enabling connection set up over multiple different link types at different network layers with different segment sizes and other characteristics.
Providing multi-path load balancing, overflow and failover utilizing available network services.
Providing for different modes for data transmission (for instance unacked, acked, unreliable, reliable, etc.).
Providing for ordered or unordered data transmission.
Providing for a configurable network service prioritization scheme that may work within bandwidth allocation limits.
Providing for a configurable network service prioritization scheme that in some implementations may be defined through the use of other limiting factors such as security level, reliability, stability, etc.
Providing for a configurable prioritized bandwidth reservation scheme for transmitted data streams that may work within bandwidth allocation limits.
Dynamically changing some or all of these and/or other network-related metrics

Generally described, computing devices utilize a communication network, or a series of communication networks, to exchange data. In certain common embodiments, data to be exchanged is divided into a series of packets that can be transmitted between a sending computing device and a recipient computing device. In general, each packet can be considered to include two components, namely, control information and payload data. The control information corresponds to information utilized by one or more communication networks to deliver the payload data. For example, control information can include source and destination network addresses, error detection codes, and packet sequencing identification, and the like. Typically, control information is found in packet headers and trailers included within the packet and adjacent to the payload data. Payload data may include the information that is to be exchanged over the communication network.

In practice, in a packet-switched communication network, packets are transmitted among multiple physical networks, or sub-networks. Generally, the physical networks include a number of hardware devices that receive packets from a source network component and forward the packet to a recipient network component. The packet routing hardware devices are typically referred to as routers. With the advent of virtualization technologies, networks and routing for those networks can now be simulated using commodity hardware rather than actual routers.

As used herein, a network can include an overlay network, which is built on the top of another network. Nodes in the overlay can be connected by virtual or logical links, which correspond to a path, perhaps through many physical or logical links, in the underlying network. For example, distributed systems such as cloud-computing networks, peer-to-peer networks, and client-server applications may be overlay networks because their nodes run on top of a network such as, e.g., the Internet. A network can include a distributed network architecture such as a peer-to-peer (P2P) network architecture, a client-server network architecture, or any other type of network architecture.

As used herein, “dataset” is a broad term and is used in its general sense and can mean any type of data, without restriction. For instance, in some implementations, a dataset may be a complete Layer 2, Layer 3, or Layer 4 of the Open System Interconnection (OSI) model packet; it can also mean the header or payload or other subset therein of the protocol packet. In some implementations, a dataset may also be any structured data from an application held in various memory structures, either by address reference, registers, or actual data. Whereas most protocols define a dataset as a specific format or ordering of bytes, this system may in some implementations not restrict any such understanding. A dataset may be merely a set of information in the most simple and raw understanding; but in some implementations, there may be some underlying structure to the dataset.

As used herein, a “node” in a network is a broad term and is used in its general sense and can include a connection point in a communication network, including terminal (or end) points of branches of the network. A node can comprise one or more physical computing systems and/or one or more virtual machines that are hosted on one or more physical computing systems. For example, a host hardware computing system may provide multiple virtual machines and include a virtual machine (“VM”) manager to manage those virtual machines (e.g., a hypervisor or other virtual machine monitor). A network node can include a hardware device that is attached to a network and is configured to, for example, send, receive, and/or forward information over a communications channel. For example, a node can include a router. A node can include a client, a server, or a peer. A node can also include a virtualized network component that is implemented on physical computing hardware. In some implementations, a node can be associated with one or more addresses or identifiers including, e.g., an Internet protocol (IP) address, a media access control (MAC) address, or other hardware or logical address, and/or a Universally Unique Identifier (UUID), etc. As further described herein, nodes can include Agent nodes and Gateway nodes.

### Example Approach

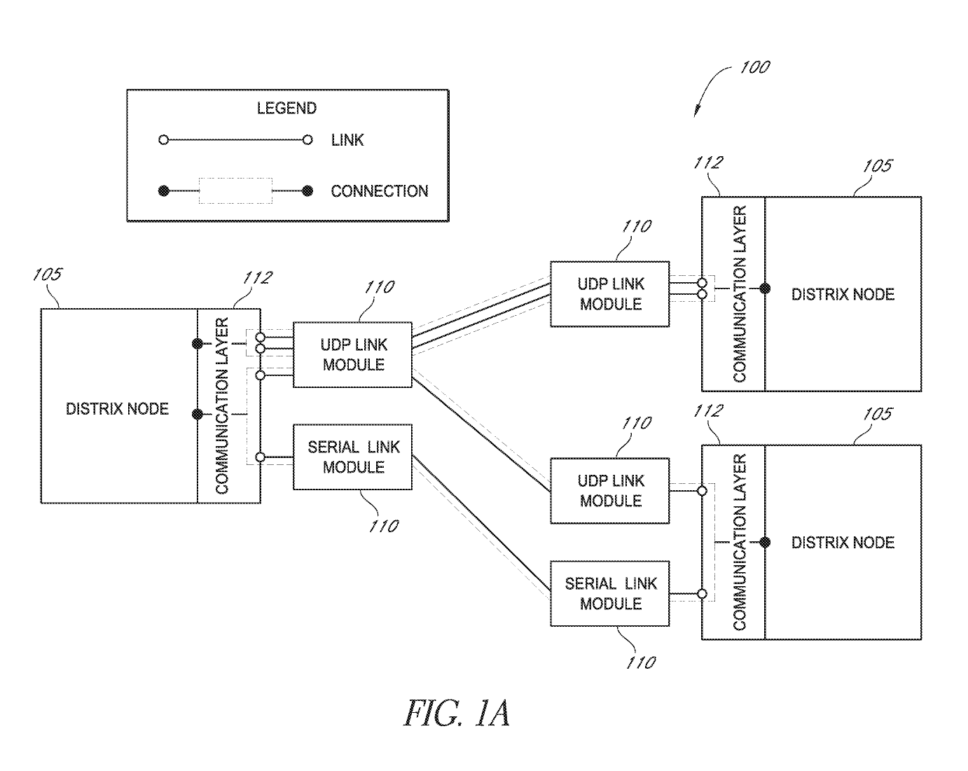

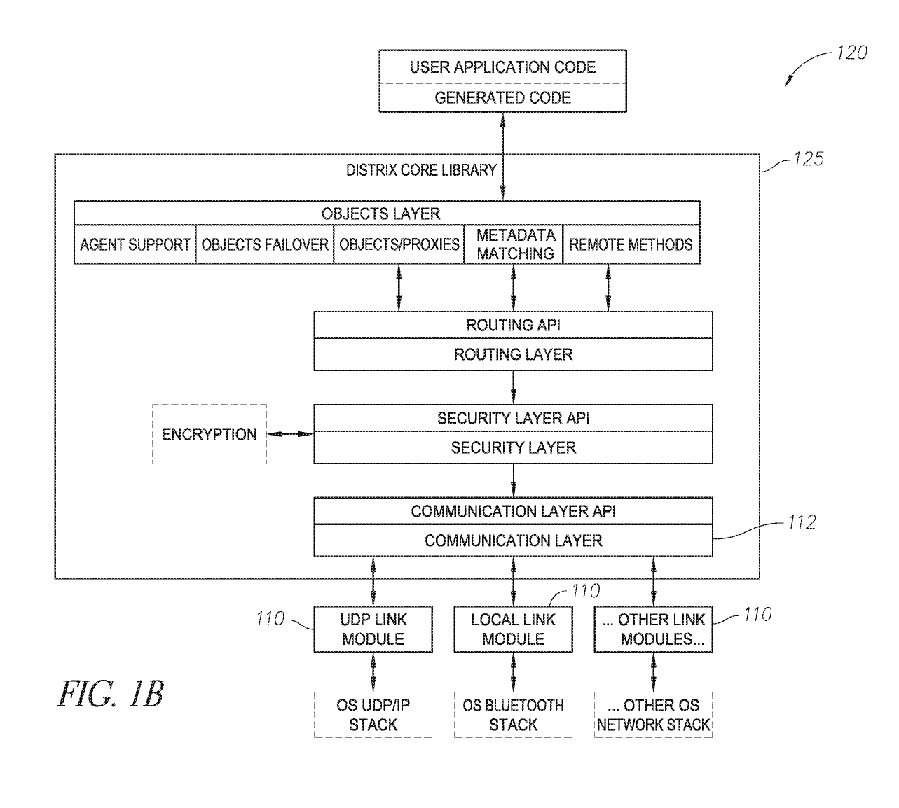

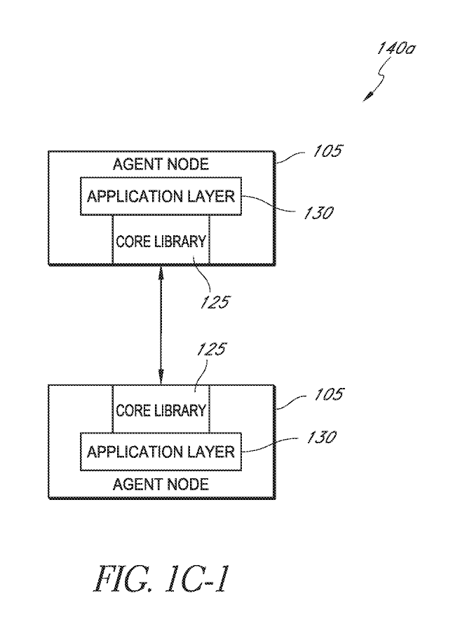

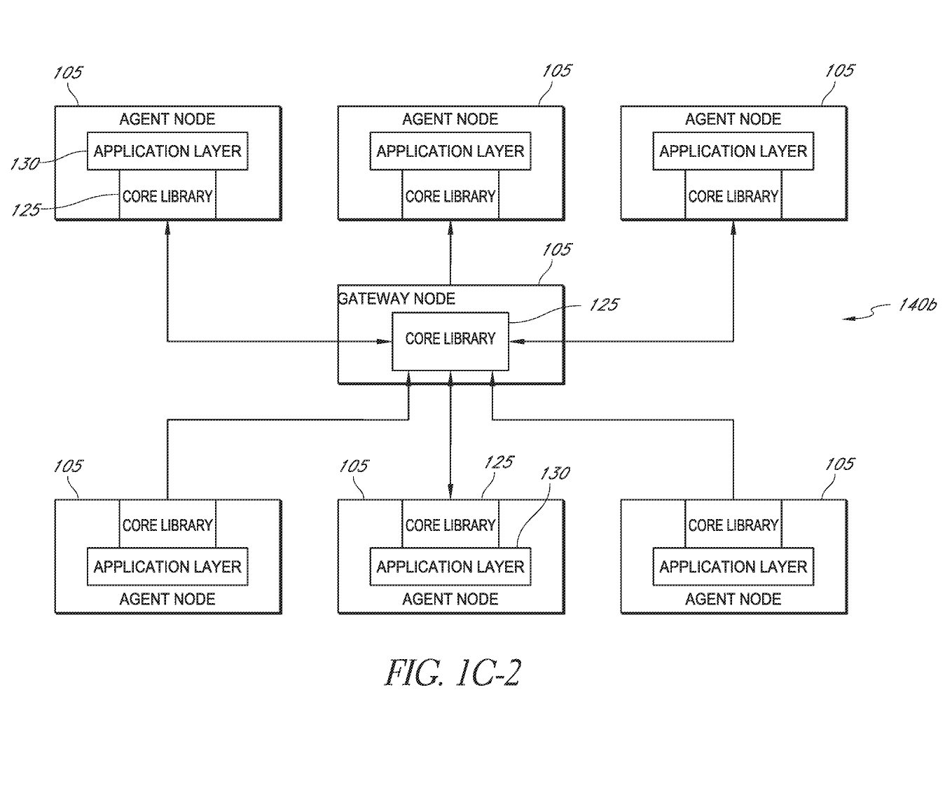

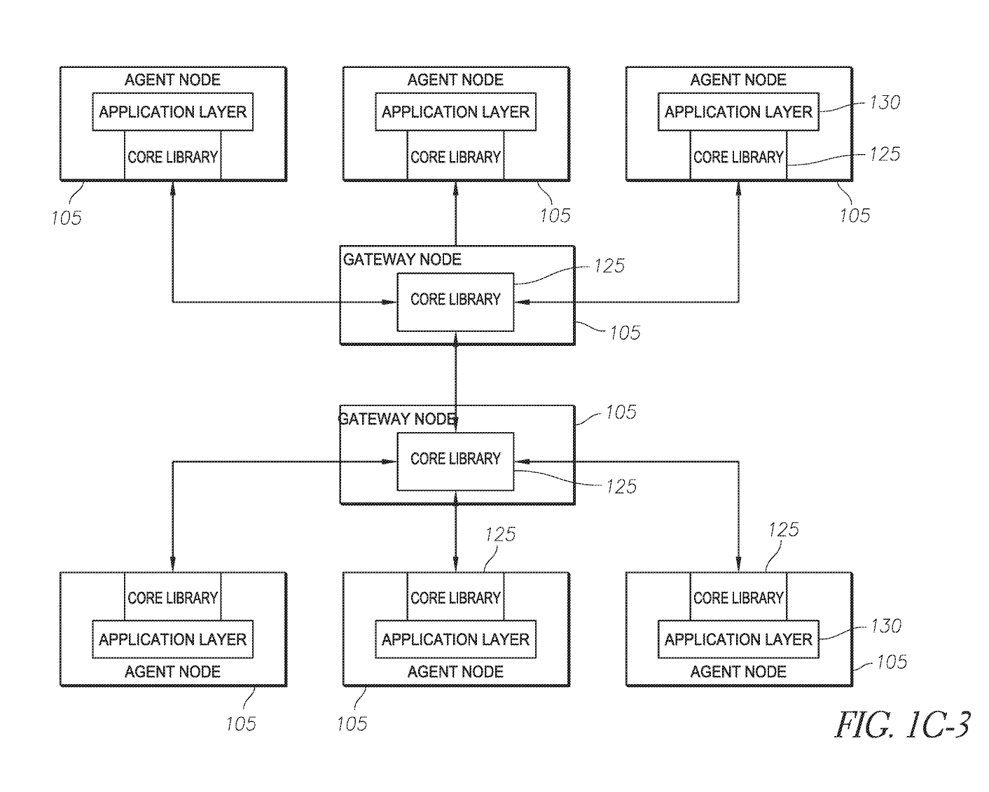

FIG. 1A is a block diagram that schematically illustrates an example of a communication network 100 utilizing adaptive load balancing. The network 100 can include one or more nodes 105 that communicate via one or more link modules 110. As further described herein, the nodes 105 can include Agent Nodes and/or Gateway Nodes. The link modules can implement data transfer protocols including protocols from the Internet protocol (IP) suite such as the User Datagram Protocol (UDP). The system can include serial link modules or any other type of communications module. In some illustrative, non-limiting examples described herein, the architecture, systems, methods, or features are referred to using the name “Distrix”. For example, in some such examples, Distrix can include an embeddable software data router that may significantly reduce network management complexity while reliably connecting devices and systems in easily configured ways. Embodiments of the Distrix application can securely manage information delivery across multiple networks. Embodiments of Distrix can be employed in private, public, and/or hybrid clouds. Embodiments of Distrix can be deployed on fixed or mobile devices, in branch locations, in data centers, or on cloud computing platforms. Implementations of Distrix can provide a self-healing, virtual network overlay across public (or private) networks, which can be dynamically reconfigured. Embodiments of Distrix are flexible and efficient and can offer, among other features, link and data aggregation, intelligent load balancing, and/or fail-over across diverse communication channels. Implementations of Distrix can have a small footprint and can be embeddable on a wide range of hardware including general or special computer hardware, servers, etc. Further examples and illustrative implementations of Distrix will be described herein.

In some implementations of the disclosure, dataset handling, priority, and reliability processes are centralized in a Communication Layer 112. In some implementations, the Communication Layer 112 creates segments from datasets and sends them over links provided by Link Modules. The responsibilities of a link may include sending and receiving segments unreliably. The Communication Layer 112 can aggregate multiple links to the same node into a connection, which is used to send and receive datasets. In some implementations, the Communication Layer 112 may be a component of the Distribution Layer, further described in detail in U.S. Pat. No. 8,078,357, entitled “Application-Independent and Component-Isolated System and System of Systems Framework” (the “'357 patent”), which is incorporated by reference herein in its entirety for all that it contains so as to form part of this specification. In some implementations, the Communication Layer 112 may be a combination of the Distribution Layer, the Connection Objects, and/or all or part of the Protocol Modules further described in detail in the '357 Patent. In various implementations, the functionalities of the Communication Layer, the Distribution Layer, the Protocol Modules, and/or the Connection Objects can be embodied as separate layers or modules, merged into one or more layers or modules, or combined differently than described in this specification.

Various implementations of an adaptive load-balanced distributed communication network, such as the example shown in FIG. 1A, may provide some or all of the following benefits.

Consistent Behavior—Since the dataset transport behavior can be centralized in the Communication Layer 112, there may be no differences in behavior when sending over different protocols (e.g., different Link Modules 110 as described below).

Useful Prioritization—The Communication Layer 112 can provide a flexible prioritization scheme which is available for some or all protocols and may be implemented on a per-Link Module basis or across all or a subset of Link Modules.

Bandwidth reservation—The Communication Layer 112 can provide reserved bandwidth for individual data streams, where stream membership may be determined on a per-packet basis based on packet metadata, contents, or other method. Bandwidth reservations may be prioritized so that higher-priority reservations are served first if there is insufficient available bandwidth for all bandwidth reservations.

Link-specific Discovery and Maintenance—In some implementations, creation and maintenance of links may be delegated to Link Modules 110. A Link Module may manage the protocol-specific functions of discovering and setting up links (either automatically or manually specified), sending and receiving segments over its links, and optionally detecting when a link is no longer operational.

Load-Balancing—The Communication Layer 112 can monitor the available bandwidth and latency of each link that makes up a connection. This allows it to intelligently divide up each dataset that is sent amongst the available links so that the dataset is received by the other end of the connection with little or no additional bandwidth usage. In various cases, the dataset can be sent as quickly as possible, with reduced or least cost, with increased security, at specific times, or according to other criteria.

Failover Options—In some implementations, the design allows links to be configured so that they are used when no other links are available, or when the send queue exceeds a certain threshold. This allows users to specify the desired link failover behavior as a default or dynamically over time.

Reliability Options—In some implementations, the Communication Layer 112 offers four basic different reliability options for datasets: (1) unacked (no acknowledgement at all), (2) unreliable (datasets may be dropped, but segments are acked so that transmission is successful over lossy links), (3) reliable (datasets are sent reliably, but are handled by the receiver as they are received), and (4) ordered (datasets are sent reliably, and are handled by the receiver in the order that they were sent). These strategies can be extended to match other network approaches beyond those described, both those known today and in the future, without direct modification to the senders/receivers using the methods and systems of the present disclosure.

Security Options—In certain circumstances, there may be routes or nodes that may not be acceptable for transmission of datasets. In these cases, a layer above the Communication Layer 112 could dictate that certain paths may be avoided; this could be overridden in other certain circumstances. Some applications may require encryption for datasets. Encryption may be applied before a dataset is sent over a connection (for instance per-dataset) as part of the Communication Layer or may be applied (for instance per-segment) at the Link Layer. In some implementations, when encryption is applied at the Link Layer, this could allow segments to be sent unencrypted over trusted links, restricting the overhead of encryption to untrusted links.

Custom Interface—In some implementations, rather than simply providing an abstracted networking Application Programming Interface (API), the system also may provide for an interface through unique structure specific for the sending and/or receiving party as further described in the '357 patent.

FIG. 1B schematically illustrates an example of a high-level overview of a network overlay architecture 120. FIG. 1B schematically illustrates an example of how in some implementations the Communication Layer can be incorporated into an information exchange framework. Examples of an information exchange framework and core library components are described in the '357 patent. The architecture can include a core library 125 of functionality, such as the Distrix Core Library described further herein.

In some implementations, by using such an information exchange framework, software components and devices may communicate with one or more of the same or different types of components without specific knowledge of such communication across the networks. This provides for the ability to change network set-up and/or participants at run time or design time to best meet the needs of an adaptive, distributed system.

### Example Interactions of the Communication Layer

### Application Layer

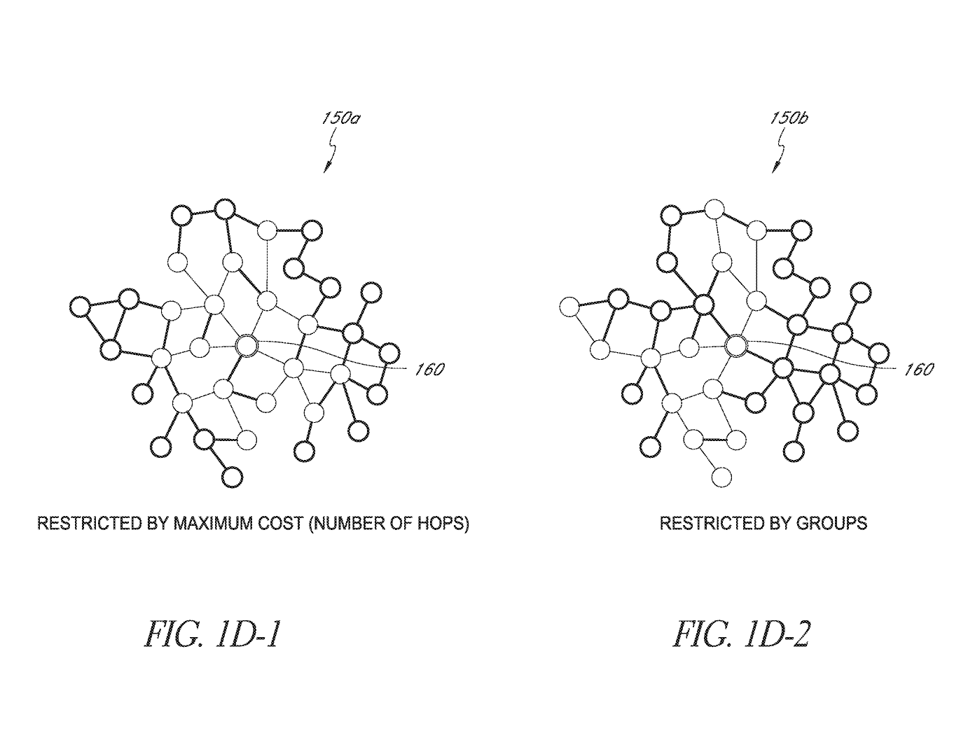

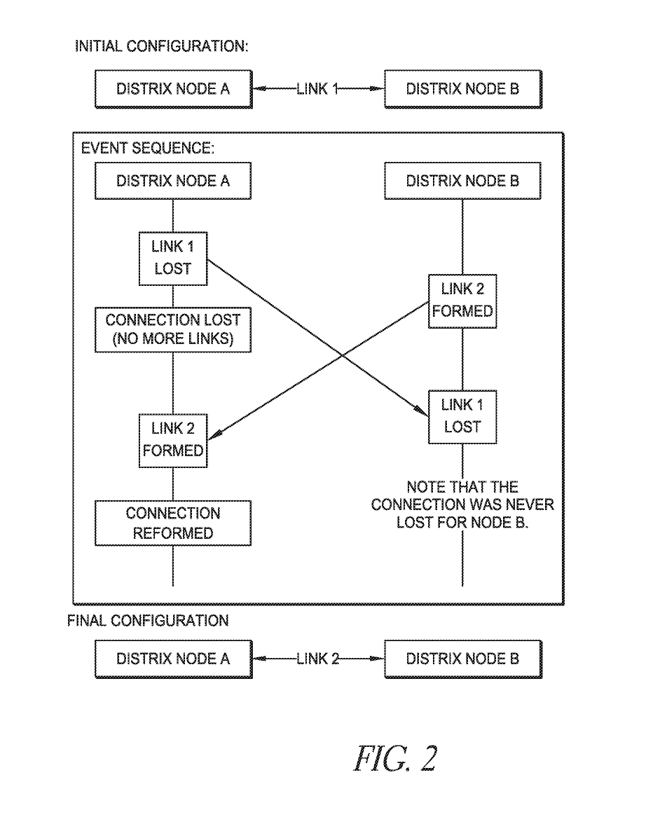

An embodiment of an Application Layer 130, shown in FIGS. 1C-1 and 1C-2, may comprise the User Application Code and Generated Code above the Distrix Core Library Layer 125 as shown in FIG. 1B, and can implement the application logic that does the work of some systems utilizing the Communication Layer 112. In some implementations of the Application Layer 130, the Distrix Core Library 125 may include the Communication Layer 112 that can manage the communications between elements in a system as described herein. The Application Layer of an Agent Node 105 may be a customer interface through a user generated interface such that in some implementations no lower layers may be directly interacted by the participants (users nor software nor hardware devices) in the system. This could allow the lower levels to be abstracted and implemented without impact to the upper-layer third party components. In some implementations, these components, called Agent Nodes 105, may capture and process sensor signals of the real or logical work, control physical or virtual sensor devices, initiate local or remote connections to the network or configuration, or perform higher order system management through use of low level system management interfaces.

### Agent Nodes

In some implementations, the Application Layer 130 may include the software agents that are responsible for event processing. Agents may be written in one or more of the following programming languages, for instance, C, C++, Java, Python, or others. In some implementations, Agent Nodes 105 may use hardware or software abstractions to capture information relevant to events. Agents may communicate with other agents on the same node or Agents on other nodes via Distrix Core Library 125. In some implementations, the routing functionality of Distrix Core Library may be the functionality described herein with respect to the disclosure of the Communication Layer.

In some implementations, devices external to the network may also communicate with a node within the network via Distrix Core Library. A hardware or software abstraction may also be accessed from a local or remote resource through the Distrix Core Library.

### Generated Code

An information model may be a representation of information flows between publishers and subscribers independent of the physical implementation. The information model may be generally similar to various examples of the Information Model described in the '357 patent. In some implementations, an information model can be used to generate software code to implement those information flows. The generated code may be used to provide an object oriented interface to the information model and to support serialization and deserialization of user data across supported platform technologies.

Distrix Peer-to-Peer and/or Client-Server Structure

In some implementations, Distrix may be a peer-to-peer communication platform 140a (see, e.g., FIG. 1C-1), but in certain circumstances it may be easier to conceptualize not as a client-server, but as a client and server 140b, 140c (e.g. as an Agent Node and Gateway Node; see, e.g., FIGS. 1C-2 and 1C-3). In fact, any node 105 can support both or either modes of operation, but some of the nodes may assume (additionally or alternatively) a traditional communication strategy in some implementations.

### Distrix Core Library

The Distrix Core Library 125 may handle communication and manage information delivery between Agents. One specific configuration of Agent Node is a Distrix Gateway in some implementations.

### Gateway Nodes

The Distrix Core Library 125 may provide publish/subscribe and asynchronous request/response data distribution services for distributed systems. Agent Nodes 105 may use the Distrix Core Library 125 to communicate either locally or remotely with a Gateway Node 105 or another Agent Node 105. See FIG. 1C-2 as an illustrative example of an implementation of a Peer-to-Peer Client-Server system 140a, and FIG. 1C-3 as an illustrative example of an implementation of a Distributed Peer-to-Peer Client-Server system 140c.

### Publish/Subscribe Route Creation

Any Distrix node may create publications, assigning arbitrary metadata to each publication. Subscribers specify metadata for each subscription; when a subscription matches a publication, a route is set up so that published information will be delivered to the subscriber.

FIGS. 1D-1 and 1D-2 schematically illustrate examples of routes in networks 150a, 150b, respectively. In some implementations, routes are set up using a method described herein. A cost metric may be specified for each publication to control the routing behavior. In some such implementations, the extent of a publication within the network (shown with lines having lighter weight in FIGS. 1D-1 and 1D-2) may be controlled by setting the publication's maximum cost (for instance, one embodiment may be restricting the publication to a certain “distance” from a publisher 160). FIG. 1D-1 illustrates an example in which the publication is restricted by a maximum number of hops from the publisher 160. In another embodiment, the extent of publication is determined based on the publication's groups (for instance, restricting the publication to nodes with the appropriate groups) as may be seen in FIG. 1D-2. In other embodiments, the extent of publication can be based at least partly on a combination of multiple factors selected from, e.g., distance, cost, number of hops, groups, etc. These factors may be weighted to come up with a metric for determining the extent of publication.

### Request/Response

In some implementations, once a publication is matched to a subscription, the subscriber may send messages directly to the publisher, and the publisher may respond directly. In some implementations, this process may be asynchronous, and there may be multiple requests per response, or multiple responses per request. In some implementations, this feature may be used to implement remote method invocation.

### Filters

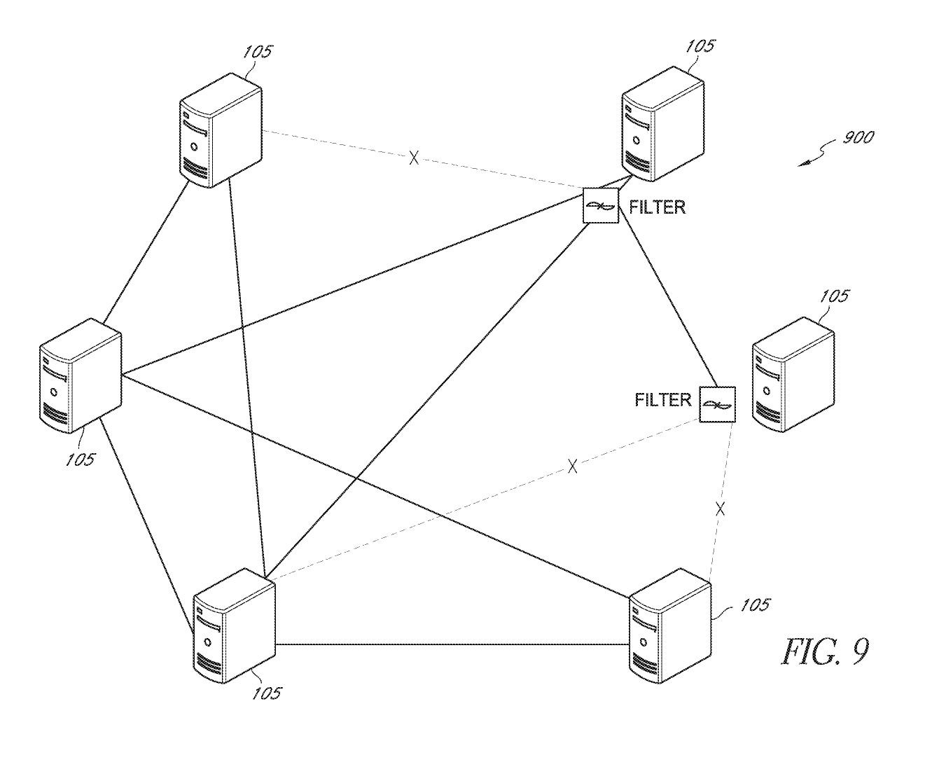

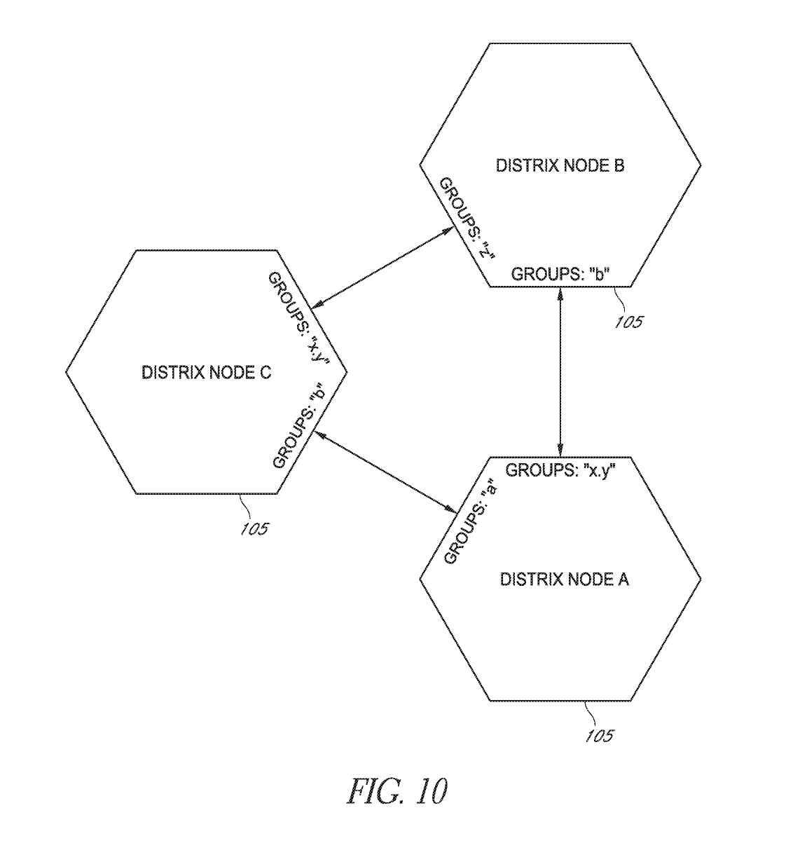

In some implementations, for each matching publication, a subscriber may set up a different set of filters for published information. In some implementations, filters may exclude information that the subscriber may not be interested in receiving. In some implementations, filters may be applied as close to the publisher as possible, to reduce network traffic. See also the discussion with reference to FIG. 9.

### History

Each publication may be configured to store history. History can be stored wherever the published information is routed or delivered. The amount of history stored can be configurable, limited by the number of stored states, the size of the stored history in bytes, or a maximum age for stored history. In some implementations, subscribers can request history at any time; the history may be delivered from as close as possible to the requester, to reduce network traffic. There may be cases where the history is available at the requester already, in which case there is no network traffic. In some implementations, the publication may be configured so that history and the publication information may be stored after the publisher leaves the network. This allows persistent storage of information in the distributed system in one location or many.

### Example Design

The Communication Layer 112 can include a library that can provide communication services to the other layers and user code. In some implementations, it has an API for interacting with Link Modules, and it provides an API for other layers or user code to set up callbacks to handle various events and to configure connection behavior. In some implementations, events may include one or more of: creation of a new link, creation of a new connection, adding a link to a connection, removal of a link, removal of a connection, receiving a dataset from a connection, connection send queue grow over a limit, connection send queue shrinks under a limit, etc.

Each Link Module 110 can be responsible for creating links over its particular communication protocol, and sending and receiving segments over those links. In some implementations, the Link Module may be a network-dependent component that leverages the native strategies for the given underlying network technology and not a generic mechanism. One example might include specifying the maximum segment size for each link that it creates; the Communication Layer can ensure that the segments sent over each link are no larger than that link's maximum segment size. Note that since this transmission strategy may not be dataset-centric in some implementations, a given partial dataset may be split up or combined more in order to traverse different Links depending on the underlying Link Module. This can have implications for security considerations, including access control and/or encryption, as well as general availability of information that is being filtered or in another way not included in the foregoing, restricted.

### Example Connection Setup

Between any two nodes 105, multiple links may be active simultaneously. The Communication Layer 112 can aggregate these multiple links and provide a single “connection” façade to the rest of a node. In some implementations, this façade may not be exposed nor need it be, to the sender or receiver; though, this could be discovered if desirable. A connection may be used by a node to send datasets to another node; the Communication Layer handles the details of choosing which links to send data over, and how much, as well as quality-of-service (QoS) for each dataset. In some implementations, it may be the mechanism by which the sender and receiver interact indirectly with the Communication Layer that allows for different behaviors to be added over time without impact to the sender or receiver thanks to the generation of the unique interface discussed herein.

In order to provide a consistent connection, both sides of the connection may have the same opinion about the connection's status. In some implementations, there may not be a case where one side thinks that a connection has been lost and reformed, and the other side thinks that the connection remained up.

FIG. 2 is a diagram that schematically illustrates an example of a situation that could occur in a network in which there are one or more links between two nodes A and B. To reduce the likelihood of or prevent the situation of FIG. 2 from occurring, the Communication Layer may do some or all (or additional negotiation steps) of the following when a new link is created:
1. Send an initial ID segment. This may contain a local node ID, network ID, message version, and an index. The node on the other side of the link may send an ack back when it receives the ID segment (or close the link if the network ID does not match). The ID segment can be resent from time to time or until a time limit passes. For example, the ID segment can be resent every 3 times the latency estimate (default latency estimate: 100 ms) until the ack is received, or until 1 minute elapses (and the link is closed). The index is incremented each time the segment is resent.
2. The ack segment for the ID contains the index that can be sent. This is used to accurately estimate the link latency.
3. Once the ID segment has been received from the other node, and the ack for the ID segment has been received, the node with the lowest ID may send an “add to connection” segment. It determines if the link would be added to an existing connection or not, and then sends that information to the other node. This segment can be resent from time to time or until a time limit passes, for example, every 3 times the latency estimate until an ack is received, or 1 minute elapses.
4. When the other node receives the “add to connection” segment, it may also determine if the link would be added to an existing connection or not. If the two sides agree, then the link can be either added to the existing connection, or added to a new connection as appropriate. An ack can be sent back to the node that sent the “add to connection” segment. However, if the two sides do not agree, then the link may be closed.
5. When the node receives the ack for the “add to connection” segment, the link may be either added to the existing connection, or added to a new connection as appropriate. If the situation has changed since the “add to connection” segment was sent (e.g., there was a connection, but it has since been lost, or there was not a connection previously, but there is now), then the link may be closed.

In some implementations, to prevent race conditions, only one link to a given node is handled at a time. If a new link is determined to be to the same node as another link that has not yet been added to a connection or closed (based on ID), the new link may be queued until the current link has been handled.

### Example Failover

The links that make up a connection may be divided into three groups: (1) active, (2) inactive, and (3) disabled. In some implementations, only the active links are used for sending segments; segments may be received from inactive links, but are not sent over them. In some implementations, to control when a link is made active or inactive, there may be two configuration parameters: a wake threshold and a sleep threshold. If the send queue size for the connection exceeds the link's wake threshold, the link may be made active; if the send queue size decreases below the link's sleep threshold, the link may be made inactive. The reason for two thresholds is to provide hysteresis, so that links are not constantly being activated and deactivated. A link may be disabled for various reasons, including but not limited to security or stability reasons. No data may be sent or received on a disabled link.

In some implementations, there can be a configurable limited number of active links comprising an active link set in a connection, and unlimited inactive links.

In some implementations, when a link is added to a connection, it can be made active (assuming there is space for another active link) if its wake threshold is no larger than the connection's send queue size, and its wake threshold is lower than the wake threshold of any inactive link. Otherwise, the new link can be made inactive. When a link is removed from a connection, if there are no remaining active links, then the inactive link with the lowest wake threshold can be made active.

In some implementations, whenever a dataset is sent over a connection and is queued (because it cannot be sent immediately), the Communication Layer 112 may check to see if there exists a link can be made active. If the active link set threshold is not exceeded and there are inactive links with a wake threshold no larger than the connection's send queue size, the inactive link with the lowest wake threshold may be made active.

When the send queue shrinks, if there is more than one active link and there are active links with a sleep threshold greater than the send queue size, the active link with the highest sleep threshold may be made inactive.

### Examples of Basic Rules Used in Various Implementations

In some implementations, there may exist (potentially invalid) at least one active link—the last active link cannot be made inactive until another link is made active. Links with a wake threshold of 0 may be active (unless the active link set is full). Inactive links can be made active in order of wake threshold—the link with the lowest link threshold can be made active. Active links can be made inactive in order of sleep threshold—the link with the highest sleep threshold can be made inactive.

### Sample Usage Scenarios

Load Balancing—In some implementations, all links can be active all the time. To do this, all links are given a wake threshold of 0, and so all links may be active. Datasets can be segmented up and sent over all links according to the link bandwidth and latency. In other implementations, not all links are active all the time.

Overflow—In some implementations, one link may be used preferentially, with the other links being used when the preferred link's bandwidth is exceeded. To do this, the preferred link can be given a wake threshold of 0; the other links can be given higher wake thresholds (and sleep thresholds) according to the desired overflow order. If the amount of data being sent over the connection exceeds the bandwidth of the preferred link, the send queue may fill up until the next link's wake threshold is exceeded; the next link may then be made active. If the send queue keeps growing, then the next link may be made active, and so on. Once the send queue starts shrinking, the overflow links may be made inactive in order of their sleep thresholds (typically this would be in the reverse order that they were made active).

Failover—In some implementations, one (preferred) link may be made active at a time; the other (failover) links are not made active unless the active link is lost. To do this, the preferred link can be given a wake threshold of 0. The failover links are given wake and sleep thresholds that are higher than the maximum possible queue size for the connection (which is also configurable). The failover link thresholds can be specified in the desired failover order. For example, in some implementations, if the maximum send queue size for the connection is set to 20 MB, and the desired failover pattern is link A (preferred)→link B→link C, then users may configure the wake threshold of link A to 0, the wake and sleep thresholds for link B to, for example, 40000000, and the wake and sleep thresholds for link C to, for example, 40000001. Then, in these implementations, links B and C may not be active as long as link A is present. When link A is lost, link B can be made active; if link B is lost, link C can be made active. When link A is reformed, the failover links may be made inactive again.

### Examples of Prioritization

In various embodiments, a dataset may be given a priority between a low priority and a high priority. For example, the priority may be in a range from 0 to 7. The priority of a dataset may be used to determine the order queued datasets can be sent in and when non-reliable datasets may be dropped.

In some implementations, when a dataset is sent over a connection, there may not be bandwidth available to send the dataset immediately. In this case, the dataset may be queued. There can be a separate queue for datasets for each priority level. For each queue, there are configurable limits for the amount of data stored for unacked, unreliable, and reliable/ordered datasets. If an unacked or unreliable dataset is being queued, and the storage limit for that type of dataset for the dataset's priority level has been exceeded, the dataset may be dropped. If a reliable or ordered dataset is being queued and the storage limit for reliable/ordered datasets for that priority level has been exceeded, an error may have occurred and the connection may be closed.

When bandwidth becomes available to send a dataset over a connection, the connection queues may be inspected for each priority level to get a dataset to send. This may be done based on bandwidth usage. Each priority level may have a configurable bandwidth allocation, and a configurable bandwidth percentage allocation. Starting with priority 0 and working up, the following procedure can be used (exiting immediately when a dataset is sent):
Each priority may be checked in order to see if it has exceeded its bandwidth allocation. If not, and there is a dataset in that queue, the first dataset in the queue may be removed and sent.
If all priorities have used up their bandwidth allocation, then each priority may be checked in order to see if its used bandwidth as a percentage of the total bandwidth is less that the bandwidth percentage allocation for that priority. If so, and there is a dataset in that queue, the first dataset in the queue may be removed and sent.
If all percentage allocations have been used up, each priority may be checked in order; if a dataset is present in that queue, it may be removed and sent.

In some implementations, bandwidth for each priority level can be continuously calculated, even if datasets are not being queued. For each priority, a total and time are kept. Bandwidth for a priority may be calculated as total/(now−time). The total may be initialized to 0, and the time may be initialized to the link creation time. Whenever a dataset is sent with a given priority, the total for that priority may be increased by the size of the dataset; then if the total is greater than 100, and the time is more than 100 ms before the current time, the total may be divided by 2 and the time is set to time+(now−time)/2 (so the time difference is halved).

### Sample Usage Scenarios

Traditional Priorities—In some implementations, all datasets with priority 0 can be sent before any with priority 1, which can be sent before any with priority 2, etc. To achieve this, the user could configure the bandwidth allocation for each priority to 0, and the bandwidth percentage allocation for each priority to 100%.

Percentage Sharing—In some implementations, priority 0 could get 50% of the available bandwidth, priority 1 could get 25%, and priority 2 could get 25% (with any unused bandwidth falling through to priorities 3-7 as in the traditional priorities scenario). To do this, the user may configure the bandwidth allocation for each priority to 0. The bandwidth percentage allocation may be 50% for priority 0, 25% for priority 1, and 100% (of remaining bandwidth) for all other priorities. The forgoing probabilities are merely examples and the priorities and probabilities can be different in other implementations.

Guaranteed Bandwidth—In some implementations, priority 0 may be guaranteed, for example, 256 KB/s of bandwidth or 30% of all bandwidth, whichever is greater. The remaining bandwidth may be given to priorities 1-7 as in the traditional priorities scenario. To achieve this, certain methods may set the bandwidth allocation for priority 0 to 256 KB, the bandwidth percentage allocation for priority 0 to 30%, and configure priorities 1-7 as in the traditional priorities scenario.

### Example of Reliability

Each dataset can be given a delivery reliability. In some implementations, there are four reliability options:

Unacked. Datasets may be sent unreliably, and are not acknowledged by the receiver. This may use the lowest network bandwidth, but may be very unreliable. Suitable for applications where dropped datasets are not an issue

Unreliable. These datasets may be dropped, but are acked by the receiver (and unacked segments are resent). Suitable for applications requiring large datasets to be sent successfully over lossy links

Reliable. These datasets may be sent reliably, and in some implementations may not be dropped unless the connection is lost. However, they are not ordered; the receiver will handle them in the order that they are received.

Ordered. These datasets may be sent reliably, and may be handled by the receiver in the order that they were sent. This simplifies the developer's efforts.

### Examples of Security

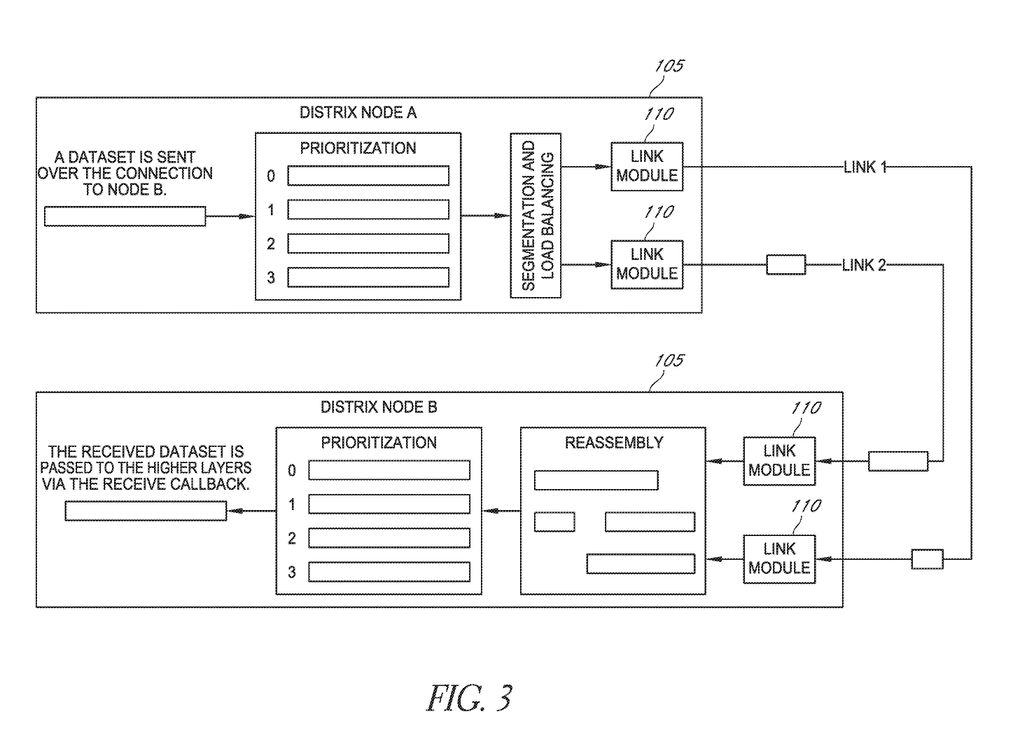

FIG. 3 is a diagram that schematically illustrates an example of segmenting, reordering, and reassembling a dataset. Although two nodes 105 are shown, any number of nodes can be involved in communicating datasets in other examples. When using the Security Layer, each dataset may be sent with a set of groups. In some implementations, a dataset may be only sent over a connection if at least one of the dataset's groups matches one of the connection's groups. Groups are hierarchical, allowing different levels of access permissions within the network.
Each dataset may be flagged as secure. In some implementations, when a secure dataset is sent over an encrypted connection, the dataset can be encrypted; non-secure datasets sent over an encrypted connection may not be encrypted. This allows the user to dynamically choose which data may be encrypted, reducing resource usage if there may be data that may not need Security Groups.
Data access permissions may be implemented in security groups.
Security groups may provide separation in multi-tenant networks and those requiring different security levels.
Groups may be assigned to connections. The connection's group memberships may determine which data may be sent over that connection. to be secure.
Either side of a connection may request that it be encrypted.
In some implementations, Distrix may support datagram transport layer security (DTLS) encryption and other encryption libraries can be added by wrapping them with the Distrix Encryption API.
In some implementations, a public key certificate (e.g., a X.509 standard certificate), or other secure-token technologies—distribution and revocation lists may be supported.
In some implementations, links have different encryption strengths which can be considered in routing across and within groups.
In some implementations, segments may be lost in transit and balancing the trade-offs of lost or out-of-order segments versus data availability while reaming secure can be addressed.
Multiple links and the same connection may have different groups or encryption levels or other access restrictions.
In some implementations, datasets that can be accessed by some participants and not others where there is only one way to route (through untrusted) might be encountered and navigated.
Information security over a single link or single connection can be accomplished, and this may be impacted by decisions of Link Module Layer versus Communication Layer security. This may be addressed by a dynamic switch between the modes.

A variety of security approaches can be applied to a network due to the capabilities of the Communication Layer 112 as described herein and these approaches could be automated to determine experimentally which setups are ideal for the network and user constraints.

### Examples of Sending and Receiving

In some implementations, when a dataset is sent over a connection, the Communication Layer 112 may first queue and prioritize the dataset if the dataset cannot be sent immediately. When the dataset is actually being sent, it may be sent out as segments over one or more of the active links. The dataset may be divided among the active links to minimize the expected time-of-arrival at the receiving end. The receiver may reassemble the segments into a dataset, reorder the dataset if the dataset's reliability is ordered (buffer out-of-order datasets until they can be delivered in the correct order), and pass the received dataset to the higher levels of the library (or to user code).

### Examples of Algorithms

In some implementations, when a dataset is being sent, the Communication Layer 112 may repeatedly choose the best active link based on minimizing cost (for instance least network usage) or maximizing delivery speed (for instance, time-based) or ensuring optimal efficiency through balancing bandwidth reduction versus delays (for instance waiting for a frame to fill unless a time period expires) to send over, and send a single segment of the dataset over that link. This may be done until the dataset has been fully sent. The best link for each segment can be chosen so as to minimize the expected arrival time of the dataset at the receiving end.

If the dataset's reliability is not ‘unacked’, then the receiving side may send acks back to the sender for each received segment. The sending side tracks the unacked segments that were sent over each link; if a segment if not acked within three times the link latency, the segment may be assumed to have been lost, and is resent (potentially over a different link).

### Example Segmentation and Blocks

Since a dataset can be divided among multiple links, each segment of a sent dataset might be a different size (since each link potentially may have a different maximum segment size). The Communication Layer 112 may use a way to track which parts of the dataset have been acknowledged, so that it can accurately resend data (assuming the dataset's reliability is not ‘unacked’). To do this, in some implementations, the Communication Layer may divide up each dataset into blocks (e.g., 16-byte); the Communication Layer may then use a single bit to indicate if a given block has been acked or not.

Every segment may have a header indicating the reliability of the dataset being sent (so the receiver knows whether to ack the segment), the index of the dataset (used for reassembly), and the number of blocks in the full dataset and in this segment. In some implementations, each segment may contain an integer number of blocks (except the last segment of a dataset), and the blocks in a segment are contiguous (no gaps). When a segment is sent over a link, the Communication Layer 112 may record the range of blocks in the segment, and which link it was sent over. The number of blocks in the segment can be added to the link's inflight amount (see Send Windows below). If the segment times out (in one embodiment, more than 3 times the link latency elapses without receiving an ack), then the blocks in that segment can be resent over the best active link (not necessarily the same link the segment was originally sent over). Note that this may use multiple segments if the best link has a smaller maximum segment size than the original link.

In some implementations, when a segment is acked, the ack may contain the range of blocks being acknowledged. The sender may mark that range as acked, so it does not need to be resent. If a segment has been resent, an ack may arrive over a different link from the link that the blocks being acked were most recently sent over. This is advantageous since there may be no wait for an ack over the particular link that was most recently sent over; any link may do.

In some implementations, instead of using blocks, the Communication Layer 112 may simply record the offset and length or each segment. This allows segments to have arbitrary sizes instead of requiring them to be a multiple of some block size. When a segment is acked, the ack may contain the offset and length of the data being acknowledged; the sender may then mark that portion of the dataset as being successfully received.

### Examples of Send Windows

In some implementations, for each active link, the Communication Layer can maintain a send window. This could be the number of blocks that can be sent over that link without dropping (too many) segments. For each link, there can be a configurable minimum segment loss threshold, and a configurable maximum segment loss threshold. From time to time or periodically, the Communication Layer 112 may examine the segment loss rate for each link. If the loss rate is lower than the link's configured minimum threshold, and the send window has actually been filled during the previous interval, then the link's send window size may be increased by a factor of, e.g., 17/16. If the segment loss rate is higher than the link's configured maximum threshold, the link's send window may be decreased by a factor of, e.g., ⅞ (down to the link's configured minimum window size).

As segments are sent over a link, the number of blocks in each segment may be added to that link's inflight amount. This is the number of blocks that have been sent over the link that have not yet been acked. In some implementations, if the inflight amount exceeds the link's send window size, no more segments can be sent over that link. When segments are acked or resent over a different link, the inflight amount is reduced for the link; if the inflight amount is now lower than the link's send window size, there is extra bandwidth available; the Communication Layer may send a queued dataset if there are any.

If a link has never lost any segments, the send window size may be increased by the number of acked blocks for each ack received (up to the maximum window size). This provides a “fast start” ability to quickly grow the send window when a lot of data is being sent over a new link.

### Examples of Bandwidth Estimation

In some implementations, for each active link, the Communication Layer 112 can maintain a bandwidth estimate. This could be the number of bytes that can be sent over that link in a given time period (for example, one second) without losing more than a configurable percentage of the sent data. When a new link is created, the bandwidth estimate for that link may be a configurable value or some default value.

One way to estimate the bandwidth for a link is to use the acks for segments sent over that link in a given time period to estimate the percentage of lost data over that time period. If the loss percentage is higher than some configurable threshold, the bandwidth estimate for that link may be reduced by some factor. The factor may be changed based on the link history. For example, if there was previously no data loss at the current bandwidth estimate, the reduction may be small (e.g., multiply the bandwidth estimate by 511/512). However if several reductions have been performed in a row, the reduction could be much larger (e.g., multiply by ¾).

If the loss percentage is lower than the threshold, and there is a demand for additional bandwidth (for example, data is being queued), then the bandwidth estimate for a link may be increased by some factor. The factor may be changed based on the link history, similar to the reduction factor. The bandwidth estimate should not be increased if the current estimated bandwidth is not being filled by sent data.

### Burst Bucket for Bandwidth Limiting

In some implementations, a “burst bucket” may be used to restrict the amount of data sent over a link. The “burst bucket” may be or represent a measure of how much data is currently in transit. The maximum size of the burst bucket is the maximum amount of data that can be sent in a single burst (e.g., at the same time) and is typically small (e.g., 8*the link maximum transmission unit (MTU)). A packet can be sent over a link if that link's burst bucket is not full. For each link, the system maintains the last time a packet was sent, and the amount of data in the burst bucket at that time. (Note that the amount of data in the burst bucket can exceed the bucket size by any part of a packet (e.g., MTU-1 bytes)) since the system can allow a packet to be sent if there is any room in the burst bucket). At any time when determining if the data can be sent over a link, the system can calculate the amount of data in the burst bucket as B1=max(0, (B0−(T1−T0)*bandwidth)), where T1 is the current time, B1 is the new amount of data in the burst bucket, T0 is the last time a packet was sent, B0 is the amount of data in the burst bucket after the last packet was sent, and bandwidth is the estimated bandwidth of the link. If B1 is less than the maximum burst bucket size, then a packet can be sent over that link.

### Example Acks

When a segment is received (for an ackable dataset), the Communication Layer 112 may send an ack segment back over the link that the segment was received on. If possible, the Communication Layer may attempt to concatenate multiple ack segments into one, to reduce bandwidth overhead. The maximum time that the Communication Layer may wait before sending an ack segment is configurable. Acks that are sent more than 1 ms after the segment was received may be considered to be delayed, and may not be used for latency calculations (see Latency below).

### Example Latency

In addition to determining which blocks have been received, acks may also be used to calculate the latency for each link. When each segment is sent, the send time can be recorded; when the ack is received for that segment, if the ack was received over the link that the segment was sent over, the round-trip time (RTT) can be calculated; the latency estimate can be simply RTT/2. In some implementations, non-delayed acks may be used for latency calculations.

To reduce the effects of jitter, a weighted average can be used. For example, the new latency for a link can be calculated as: new latency=((latency*7)+(RTT/2))/8.

### Examples for Choosing a Link

When sending a dataset, the Communication Layer 112 balances segments between the active links to minimize the expected time-of-arrival of the dataset at the receiving end. In some implementations, it does this by continually finding the best link to send over and sending one segment over that link, until the dataset is completely sent, or all the active links' send windows are full.

In some implementations, best links may be chosen either randomly or preferably by minimizing cost from among the active links that do not have full send windows. For each such link, a cost may be calculated as:

cost=(L+S/B)*C

where L is the latency estimate for the link, S is the amount of data remaining to be sent, B is the available bandwidth, calculated as B=W/L, where W is the send window size in bytes, and C is a configurable cost multiplier. The link with the lowest cost can be chosen. If there are no links available, the unsent portion of the dataset can be stored. When more data can be sent (e.g., a segment is acked), the unsent portion of a partially sent dataset can be sent before any other queued datasets.

### Examples of Resending

In some implementations, when there are unacked segments for a connection, the Communication Layer 112 may check every 100 ms or at a configurable rate (or whenever a new dataset is sent or other time frame) to see if any segments in need of resending could be resent. A segment may be resent if no ack has been received for it for N (for instance, N=3) times L, where L may be the latency of the link that the segment was last sent over. The resend timeout may also depend on the latency jitter for the link that the segment was last sent over.

### Examples for Receiving

When a segment is received for a dataset, the Communication Layer 112 first determines if a segment for the given dataset has already been received. If so, then the Communication Layer copies the newly received data into the dataset, and acks the segment. Otherwise, a new dataset may be created. This can be done by taking the number of blocks in the dataset (from the segment header) and multiplying by the block size to get the maximum buffer size. The segment data can then copied into the correct place in the resulting buffer. The Communication Layer can keep track of how much data has been received for each dataset; when all blocks have been received for a dataset, the actual dataset size can be set appropriately.

For each type of dataset (unacked, unreliable, or reliable/ordered), a certain number of partially received datasets can be present at any given time. In some implementations, if a new dataset is to be created, but cannot because there may be already too many partially received datasets, then the incoming segment can be ignored—it is not acked, so it can be resent eventually. This has the effect of decreasing the sender send rate.

Once all blocks have been received for a dataset, the dataset is ready to be handled. If the dataset is unacked or unordered, it may be immediately delivered to the receive callback. Otherwise, the dataset is ordered. Ordered datasets are delivered immediately if in the correct order; otherwise, they may be stored until they can be delivered in the correct order.

### Examples of Checksums and Heartbeats

In some implementations, if a Link Module 110 cannot reliably deliver segments without corruption, links can optionally be configured so that the Communication Layer 112 adds a checksum to each segment. The checksum can be a 32-bit cyclic redundancy check (CRC) that is prepended to each segment; the receiving side's Communication Layer 112 may check the checksum for each incoming segment, and drop the segment if the checksum is incorrect.

If a Link Module 110 has no built-in way to determine when the other end of a link is no longer available it can optionally request the Communication Layer 112 to use heartbeats to determine when a link is lost. This may be done by configuring the heartbeat send timeout and heartbeat receive timeout for the link. If the heartbeat send timeout is non-zero for a link, the Communication Layer can send a heartbeat once per timeout (in some implementations, no more frequently than once per 300 ms) if no other data has been sent over the link during the timeout period. Similarly, if the heartbeat receive timeout is non-zero, the Communication Layer can periodically check if any data has been received over the link during the last timeout period (in some implementations, no more frequently that once per 1000 ms). If no data was received, then the link can be closed.

In some implementations, heartbeats may be sent (and checked on the receiving end) for active links.

### Latency Equalization and Prioritization Over Multiple Links

In network environments where bandwidth is constrained, it is important to have the ability to prioritize certain types of network traffic. On the sending side, prioritization may be for latency (higher-priority packets are sent first), bandwidth guarantees, or for particular link characteristics such as low jitter. This is typically implemented using a priority queue mechanism which can provide the next packet to be sent whenever bandwidth becomes available. In situations where there is only one link to the receiver, this method is effective. However, when multiple links to the receiver are available with varying bandwidth and latency characteristics, some complications arise.

One issue is that when the link latencies are very different, packets from a single stream will arrive significantly out of order (assuming that the bandwidth requirements are such that both links are being used). This could be easily solved by having a simple queue for each link with latency lower than the highest-latency link; when bandwidth is available on any link, that link would send any data from its queue. The next packet would be removed from the priority queue and the expected arrival time of the packet would be calculated over each link by taking into account the link latency and bandwidth, and the size of that link's queue. For example, the estimated arrival time (ETA) could be calculated as ETA=latency+(queue size/bandwidth). The packet would be sent over the link with the lowest ETA (or added to that link's queue if the packet cannot be sent immediately over that link). The system would continue doing this until the calculated ETA is greater than or equal to the maximum link latency (or the priority queue is empty).

This solution is effective at equalizing that link latencies. However, it causes the latencies for all packets to be equal, regardless of packet priority. It would be better to allow high-priority packets to be sent preferentially over a low-latency link if the low-latency link has enough bandwidth to support the high-priority data. In general if there are multiple links and there is a mixture of high- and low-priority data, the high-priority data should fill up the links in order of least latency, with the low-priority data using the remaining bandwidth on the low-latency links (if any) and spilling over to the highest-latency link.

One way to address this deficiency is to have a priority queue per link (instead of a simple queue). The ETA for a link would then be calculated as: ETA=latency+Q/bandwidth, where Q is the amount of data of equal or higher priority in that link's queue. However, this solution may not be suitable in certain cases. If a packet is added to a link's priority queue, and then higher-priority traffic is continually added after that, the packet will not be sent for an unbounded amount of time. The packet could be dropped in this situation, but since the overall prioritization scheme assumes that packets that leave the initial priority queue are sent, this may result in incorrect bandwidth usage or other quality of service disruptions.

To solve these issues, the system in certain implementations can use a priority queue for each link, but the queue priority can be based on the estimated send time for each packet rather than the data priority. For each packet, the system can estimate when that packet would be sent based on the amount of equal or higher-priority data already in the queue, plus the estimated rate that new higher-priority data is being added to the queue. Higher-priority data should be sent ahead of lower-priority data in general, so the amount of bandwidth available to lower-priority data is equal to (the total link bandwidth)−(add rate for higher-priority data). For each priority level equal to or higher than the packet in question, the system can calculate the effective bandwidth for that priority over the link; the system can then calculate the estimated amount of time to send the data already in the queue that is of an equal or higher priority (the “wait time”). This gives us the expected send time as (current time)+(wait time);

Note that if there are a large number of priorities, it may be advisable to have a tree of add rates and queue size information to reduce the cost of computing the wait time. For example, if there were 256 priorities, a 2-level tree would be obtained with the first level containing combined add rate and queued data size information for priorities 0-15, 16-31, 32-47, etc. The second level of the tree would contain the information for individual priorities. Then if the system were finding the send time for a packet of priority 128, the system would sum the add rates and queued data size from the first level of the tree for ranges that are larger than 128 (there would be 7 such ranges), and then add the add rates and queued data size from the second level of the tree for the specific 128-143 range. This reduces the number of things to sum from 127 to 23. The number of levels in the tree can be varied to trade off memory usage and speed. Nodes in the tree with an add rate and queued data size of 0 do not need to be populated.

The expected arrival time for a packet is calculated for each link as ETA=(link latency)+(wait time). When sending a packet, the system can choose the link with the lowest expected arrival time. If necessary, the packet will be added to that link's send queue based on the expected send time ((current time)+(wait time)). Packets with the same expected send time will be sent in the order that they were added to the queue. If the expected arrival time for every link is greater than the largest link latency, then the packet should not be sent now; it stays in the QoS priority queue, and will be reconsidered for sending later. Note: to accommodate link-specific QoS requirements such as minimum jitter or packet loss requirements, links that do not meet the requirements can be penalized by increasing their expected arrival time for those packets.

### Examples of Latency Equalization and Prioritization Behavior in Different Scenarios

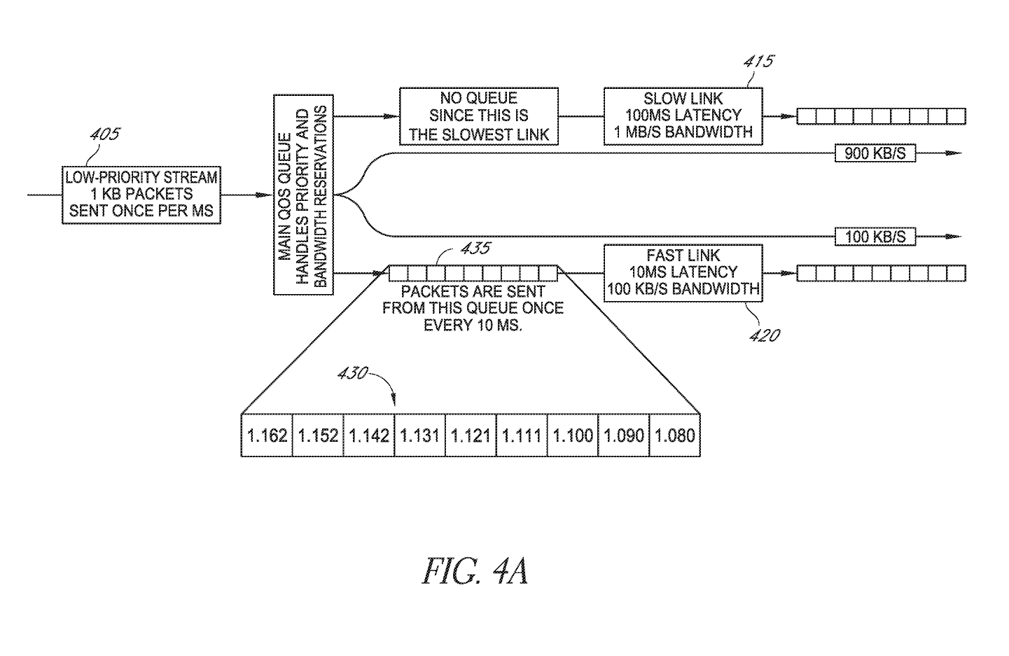

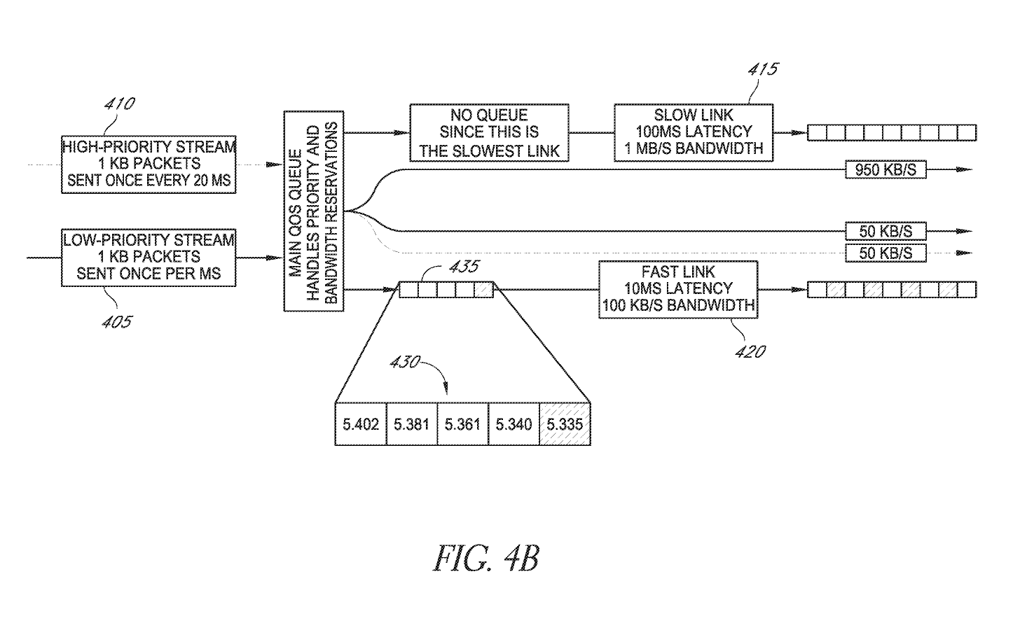

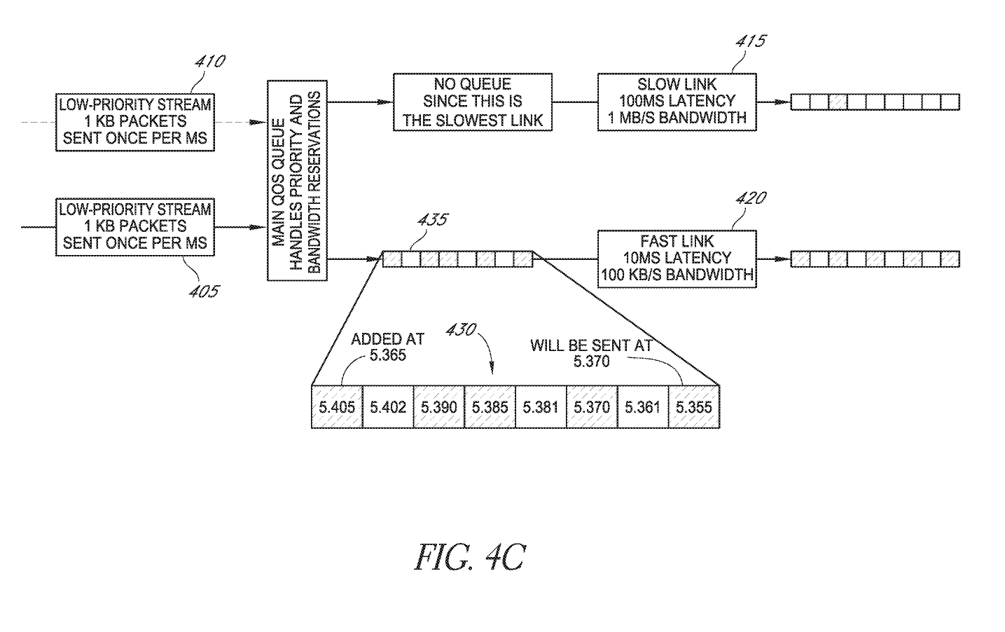

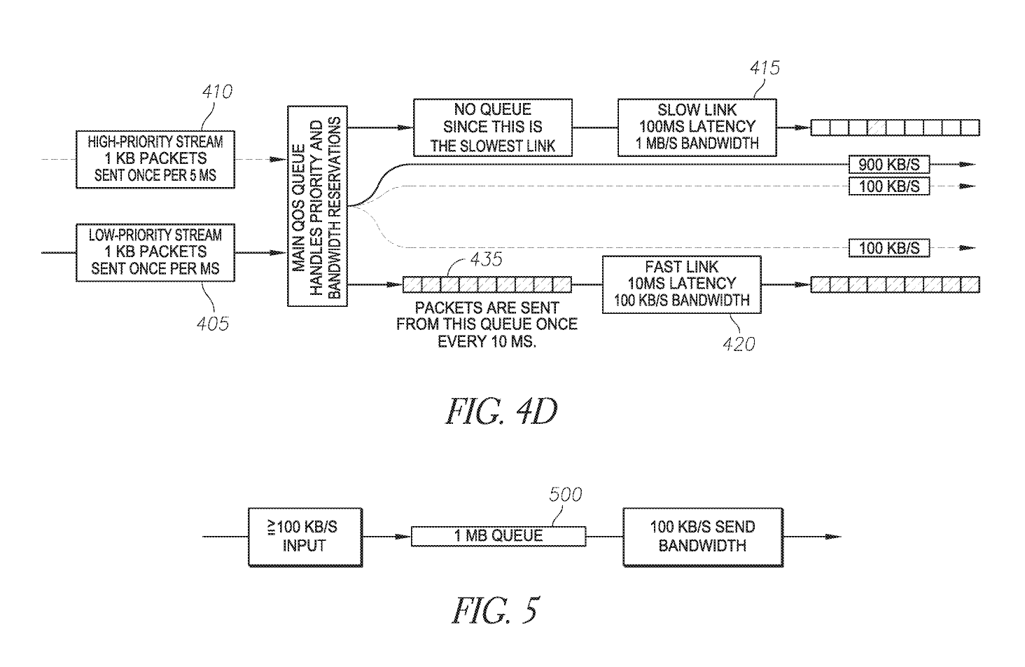

FIG. 4A shows an example situation in a network where there is only one input stream 405 with a low priority, sending a 1 KB packet once every millisecond (ms). Whenever a packet arrives, the system can calculate the expected arrival time (ETA) over each link: a slow link 415 and a fast link 420. For the slow link 415, the ETA is simply (now+100 ms). For the fast link 420, it is (now+wait time+10 ms); since all packets are the same priority, the wait time is just the queue size in bytes divided by the bandwidth. With the given link latencies and bandwidths, there will typically be 9 packets in the fast link's queue 435. The numerical values in the boxes 430 at the bottom of FIG. 4A (see also FIGS. 4B and 4C) are examples of estimated send times for each packet. In this example, these values correspond to the absolute time (in seconds) that it was estimated that the packet would be sent at (at the time the link was being chosen) based on the wait time estimate.

In this example, 100 KB/s of the low-priority stream 405 is sent over the fast link 420; approximately every 10th packet. The queue for the fast link delays the packets sent over that link so that packets arrive at the destination in approximately the same order that they were in the input stream. The effective latency for the low-priority stream 405 is 100 ms since packets sent over the fast link 420 are delayed by that link's queue to match the latency of the slow link 415.

FIG. 4B illustrates the behavior of the example network of FIG. 4A after a second higher-priority stream 410 has been added that sends a 1 KB packet every 20 ms. Whenever a high-priority packet arrives, there are no packets of an equal or higher priority in the fast link's queue. Therefore, the estimated send time of the high-priority packet is equal to the current time, which puts it at the front of the queue. The low-priority stream 405 sees an effective bandwidth of 50 KB/s on the fast link 420, since high-priority data is being added to the fast link's queue at a rate of 50 KB/s. This means that now only 4 or 5 low-priority packets will be queued for the fast link (to match the 100 ms latency of the slowest link).

In this example, the effective latency for the low-priority stream 405 is 100 ms; the effective latency for the high-priority stream 410 is 10-20 ms. In this example, the current time is 5.335, and a high-priority packet has just been added to the queue. Since there are no other high-priority packets in the queue 435, the estimated wait time is 0, so the estimated send time is the current time. The high-priority packet will be the next packet sent over the fast link (at approximately 5.340). The next high-priority packet will arrive at approximately 5.355, and will be put at the front of the queue again (the “5.340” low-priority packet and the “5.335” high-priority packet will have been sent by that time).

FIG. 4C illustrates an example of the behavior of the example network of FIGS. 4A, 4B if the high-priority stream 410 starts sending data at a rate greater than or equal to 100 KB/s. In this example, the incoming streams 405, 410 send more data than the available bandwidth can handle, so some low-priority packets will be dropped. If the high-priority stream 410 suddenly starts sending data at a rate greater than or equal to 100 KB/s, the fast link's queue 435 will fill with up to 9 high-priority packets (since the high-priority packets are queued as if the low-priority packets did not exist). The low-priority packets remain in the queue and will be sent according to their previously estimated send time. No more low-priority packets will be added to the queue since the effective bandwidth of the fast link for low-priority packets is now 0 (e.g., all of the link's bandwidth is used by high-priority packets). This example is shown in FIG. 4C. The high-priority stream 410 increased its send rate at 5.335. The current time is now 5.365. The last queued low-priority packet will be sent over the fast link at 5.430.

FIG. 4D illustrates an example of the behavior of the example network of FIGS. 4A, 4B, and 4C a time after the state shown in FIG. 4D. At this time, the fast link's queue 435 is filled with high-priority packets in this example. Now, the fast link's queue is filled with high-priority packets. The effective latency for both the high-priority and low-priority streams is 100 ms. The main QoS queue may drop 100 KB/s of low-priority traffic, since there is no longer enough bandwidth to send everything.

Continuous Bandwidth Calculation with Low Overhead

Calculating average bandwidth is straightforward. The system can evaluate bandwidth as (amount of data)/(time). However, a moving average of the bandwidth were desired (e.g., over the last 100 ms) then the system could keep track of the amount of data sent over the averaging period, adding to the amount as new packets are sent, and removing from the amount packets that were sent too long ago. Typically the system would store a buffer containing the relevant packet sizes; however this can use a large amount of memory in some cases. To reduce the likelihood of or avoid this, the system can instead track two values: a “start time” and the amount of data sent since that start time. Initially the start time is set to the current time, and the amount is set to 0. Whenever a packet is sent, the system can first check the interval (current time−start time); if that interval is greater than the averaging period (e.g., 100 ms), then the system can decrease the amount: (new amount)=(previous amount)*(averaging period)/(interval). The system can then set the start time to (current time)−(averaging period). Finally, the amount is increased by the packet size. At any time the system can calculate the bandwidth as: amount/((current time)−(start time)).

Note that this is not truly a moving average since it contains an “inverse decay” of all sent packets. This property is desirable since it still produces a non-zero bandwidth estimate even if no packets have been sent for longer than the averaging period, which is useful for allocating bandwidth reservations (for example).

### Bandwidth Reservation System

In a system that supports multiple priority levels for network traffic, it may also be useful to provide a means of reserving bandwidth for certain traffic streams. If a stream has a bandwidth reservation, then packets from that stream take priority over normal packets when the bandwidth reservation has not been filled. Packets from that stream that arrive when the bandwidth reservation has been filled are treated like normal packets (e.g., are sent according to their priority). If there are multiple streams with reserved bandwidth, the streams may be prioritized so that the stream with the highest “bandwidth priority” takes precedence.

To implement bandwidth reservations, the system can create a queue for each reserved-bandwidth stream. This can be done on-demand when the first packet in each stream arrives. In some implementations, a stream queue can be in 3 different states:

1. No packets in queue.

2. Waiting for bandwidth—the amount of bandwidth used by the stream (calculated using the method above) is greater than or equal to the bandwidth reservation.

3. Ready to send—the amount of bandwidth used by the stream is less than the bandwidth reservation.

The system can maintain two priority queues, each of which contain stream queues. The first priority queue is the “waiting for bandwidth” queue; the stream queues within it are ordered by the estimated absolute time at which the calculated stream bandwidth will fall below the bandwidth reservation for that stream (the “ready time”). The second priority queue is the “ready to send” queue; the stream queues within it are ordered based on their bandwidth priority.

When a packet from a reserved-bandwidth stream arrives and cannot be sent immediately, the system can add it to the stream's queue as well as the normal priority queue. If the stream's queue was previously empty, the system can calculate the current sent bandwidth for that stream. If the stream's bandwidth is greater than the reservation, the system can add it to the “waiting for bandwidth” queue, with a “ready time” estimate of ((start time)+amount/(bandwidth reservation)), with (start time) and amount defined as in the bandwidth calculation method. If the stream's bandwidth is less than the reservation, the stream is added to the “ready to send” queue.

When picking a packet to send, the system can first check the “waiting for bandwidth” stream queues and put any that are ready into the “ready to send” priority queue. To efficiently determine which “waiting for bandwidth” stream queues are ready, the system may only examine those stream queues with a “ready time” less than or equal to the current time (this is fast because that is the priority order for the “waiting for bandwidth” queue). Of those stream queues, those that have sent a packet since they were added to the “waiting for bandwidth” queue can have their bandwidth recalculated to see if it exceeds the reservation or not. Those that have not exceeded their reservation (or did not send a packet) are added to the “ready to send” priority queue; the others remain in the “waiting for bandwidth” queue with and updated “ready time” estimate.

The system can then examine the first “ready to send” stream queue (based on priority order). If there are no packets in it then the system can remove it and go to the next one. Otherwise the system can send the first queued packet in the stream, and then check to see if the stream is still ready to send (e.g., has not exceeded its bandwidth reservation). If so, then the stream queue stays in the “ready to send” queue. Otherwise, the system can remove that stream queue from the “ready to send” queue and add it to the “waiting for bandwidth” queue. If the stream queue had no packets left in it, it is just removed from the “ready to send” queue. If there are no ready stream queues, the system can just send from the main priority queue. Whenever a packet is sent from a stream queue, it can also be removed from the main priority queue, and vice versa.

### Smart Queue Management Technique

In a system where there is unconstrained input to a rate-limited process, a queue is typically used to absorb variability in the input to ensure that the rate-limited process is utilized as fully as possible. For example, suppose that the rate-limited process is a computer network capable of sending 1 packet every second. If 5 packets arrive to be sent at the same time once every 5 seconds, then if no queue is used, only one of those 5 packets will be sent (the other 4 can be dropped), resulting in 1 packet sent every 5 seconds—the network is only 20% utilized. If a queue is used, then the remaining packets will be available to send later, so 1 packet will be sent every second—the network is 100% utilized.

If the average input rate is higher than the process rate limit, then the queue will grow to an unbounded size. FIG. 5 schematically illustrates an example of a queue 500 with a maximum queue size. In this example, a newly queued input packet will stay in the queue for 10 seconds, resulting in an additional 10 seconds of latency, which is undesirable. When queuing packets, this is usually managed by defining a maximum queue size (in bytes or packets) and accepting packets into the queue only if the queue is smaller than the maximum size. Packets that are not accepted into the queue are dropped. This works well enough, but has a potential issue—if the queue is always full, then packet latency is increased by (queue size)/(send rate), since any packet that is sent must have traversed the entire queue before being sent (as illustrated in FIG. 5). This leads to questions about queue sizing, since the desire to absorb long packet bursts must be balanced against the desire to reduce latency. This is particularly important in the Internet since there is usually a queue at every hop in a route.

It can be advantageous if the queue can accept bursts of input and keep the process utilization as high as possible, but not increase latency significantly when the average input rate is higher than the processing rate. To do this, the system can define a “grace period” for the queue; this is the maximum amount of time that the system can accept all input into the queue, starting from when the queue last started filling. If the queue is not empty and a packet arrives after the grace period has elapsed, then a packet will be dropped with some probability. The system can in some cases use a quadratic drop rate function. As further discussed below, in one implementation, if the queue started filling at time T, the drop rate is 0 until the grace period G has elapsed; from (T+G) to (T+3G), the drop rate is 100%*(now−(T+G))²/4G²; and after (T+3G) the drop rate is 100% until the queue is drained. This allows a smooth transition between the 0% drop rate and the 100% drop rate, and is efficient to calculate. The system can also define a (large) maximum queue size so that memory used for queuing is bounded; if input arrives and the maximum queue size has been exceeded then a packet can be dropped.

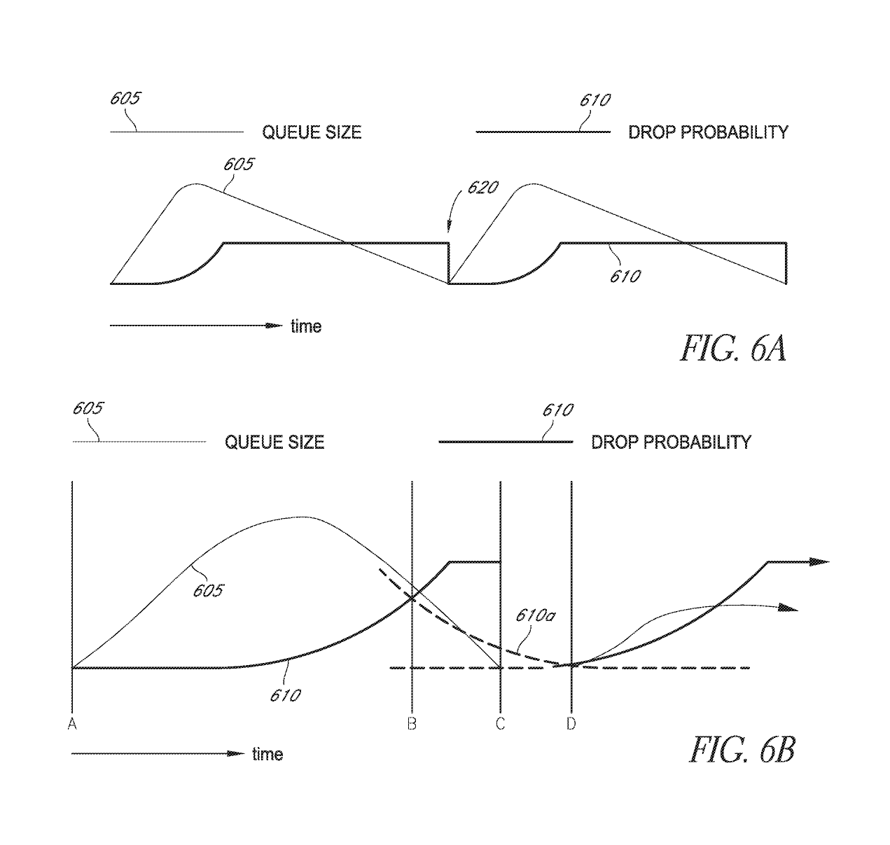

This method will accept input bursts that are no longer than the grace period, and will smoothly taper off input bursts longer than the grace period. FIGS. 6A and 6B illustrate examples of queue size 605 and drop probability 610 as a function of time. Consider a scenario where the input rate is continually much higher than the processing rate (see FIG. 6A). If the drop probability and grace period are reset whenever the queue is emptied (e.g., at a time indicated by reference numeral 620), an input rate that is continuously higher than the processing rate may result in periodic queue size (and/or latency) fluctuations. With the above method, the queue would grow until the drop rate reached 100%, and then shrink until it drained; then it would grow again. However, in this situation the queue should actually not grow significantly, since new input is generally always available. To achieve this, the system can first note that if the average input rate is less than the processing rate, input should in general not arrive while the queue is full (e.g., the grace period has elapsed). Conversely, if the input rate is continually much higher than the processing rate, the system would expect new input to continually arrive while the queue is full.

Therefore, instead of resetting the drop rate to 0% as soon as the queue is empty, the system can allow the drop rate to decay from the last time that a packet was dropped or from the last time that a packet was added to the queue. Therefore in some implementations, the drop rate decays as a mirror of the drop rate increase calculation. Then, when input starts being queued again, the drop rate calculation starts from the current point in the decay curve rather than starting with the grace period from the current time (see FIG. 6B). In the example shown in FIG. 6B, at time A, packets start to be queued. The queue becomes empty at time C. The last packet was added to the queue at time B. At time D, packets begin being queued again. The decay curve is the drop rate curve 610 mirrored around time B and is shown as a dashed line 610a near time B in FIG. 6B. Similarly, the drop rate curve at time D is shifted so that it is the equivalent to the decay curve mirrored around time D. In this example, the drop probability rises sooner than it would have if the grace period started at time D. Thus, in such implementations, the drop rate can be efficiently calculated by shifting the start of the grace period back from the current time, based on the last time that input was added to (or dropped from) the queue. By doing this, if input is continuously arriving while the queue is full, the drop rate will be already high if data starts being queued again immediately after the queue is drained (preventing the queue from growing very much). Note that, in this example implementation, the drop rate is 0% for the first packet to be queued (so the system can always accept at least one packet into the queue).

A non-limiting example of an algorithm for determining a drop probability and a drop rate will now be presented. Suppose that the queue is currently non-empty. Let t be the current time, and a be the age of the queue, notionally the length of time that the queue has been non-empty. Whenever an input packet arrives, the system can add it to the queue. The system can then potentially drop a packet from the input queue based on the drop probability. The system can calculate the drop probability, p(a), in this example as follows:

$$p ( a ) = \{ \begin{matrix}0 & \text{:} a < G \\ r ( a ) & \text{:} G \leq a < L \\ 1 & \text{:} a \geq L\end{matrix}$$

where G is the grace period, r(a) is the drop rate function, and L is the value of a for which r(a)≧1. The system can use a quadratic drop rate,

$$r ( a ) = \frac{{( a - G )}^{2}}{4 {G}^{2}} ,$$

so L is equal to 3G in this example. Other drop rates can be used, such as, linear, cubic, exponential, or any other mathematical or statistical function.

To implement the drop rate decay, whenever a packet is added to the queue, the system can calculate and store the time D when the decay curve will end. The idea is that the drop probability function p(a) is mirrored around the last time a packet was added to the queue to form the decay curve; once the queue is empty, the drop probability function will be calculated as the decay curve mirrored around the current time.

$$D = \{ \begin{matrix}t + a & \text{:} a < L \\ t + L & \text{:} a \geq L\end{matrix}$$

Suppose that the queue has emptied, and now a packet has arrived and cannot be processed immediately (so it should be queued). The system can store the new queue growth start time Q:

$$Q = \{ \begin{matrix}t - ( D - t ) & \text{:} t < D \\ t & \text{:} t \geq D\end{matrix}$$

and then calculate the queue age a(t)=t−Q from the current time t whenever the current value of a is needed.

Continuing with this example, the system can determine which packet to drop. When dropping a packet (based on the calculated drop probability), the system does not drop the packet that just arrived. Instead, the system can drop the oldest packet in the queue (front drop). This minimizes the average age of queued packets, reducing the latency effect the queue has. Since the system can support multiple packet priorities, the dropped packet will be the oldest queued packet with the lowest priority (e.g., of all of the lowest-priority packets, drop the oldest one). This can be efficiently implemented using a separate priority queue with the priority comparison function reversed.

In a scenario where there are input streams with reserved bandwidth, packets in those streams that have not filled their bandwidth reservation can be dropped if there are no other queued packets. Packets from streams that have filled their reserved bandwidth (e.g., have recently sent as much as the reserved amount) are considered equivalent to packets that are not part of a reserved-bandwidth stream for dropping purposes. One possible way to implement this is to examine the set of all reserved-bandwidth streams that have filled their bandwidth reservation, and take the oldest packet from the lowest-priority stream. Compare that packet to the oldest lowest-priority packet from the non-reserved bandwidth data (using the reversed priority queue) and drop whichever one is lower priority (or drop the older packet if they are both the same priority). If all queued packets are part of reserved-bandwidth streams that have not filled their bandwidth reservation, then drop the oldest packet from the lowest-priority stream.

### Overview of Example Interactions

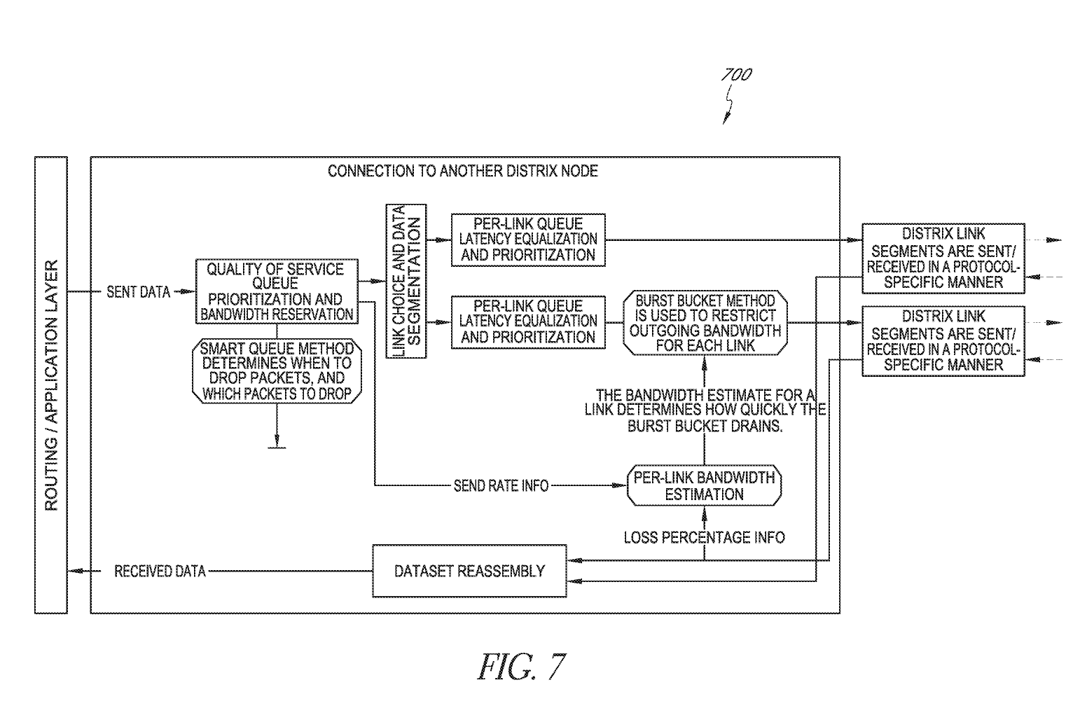

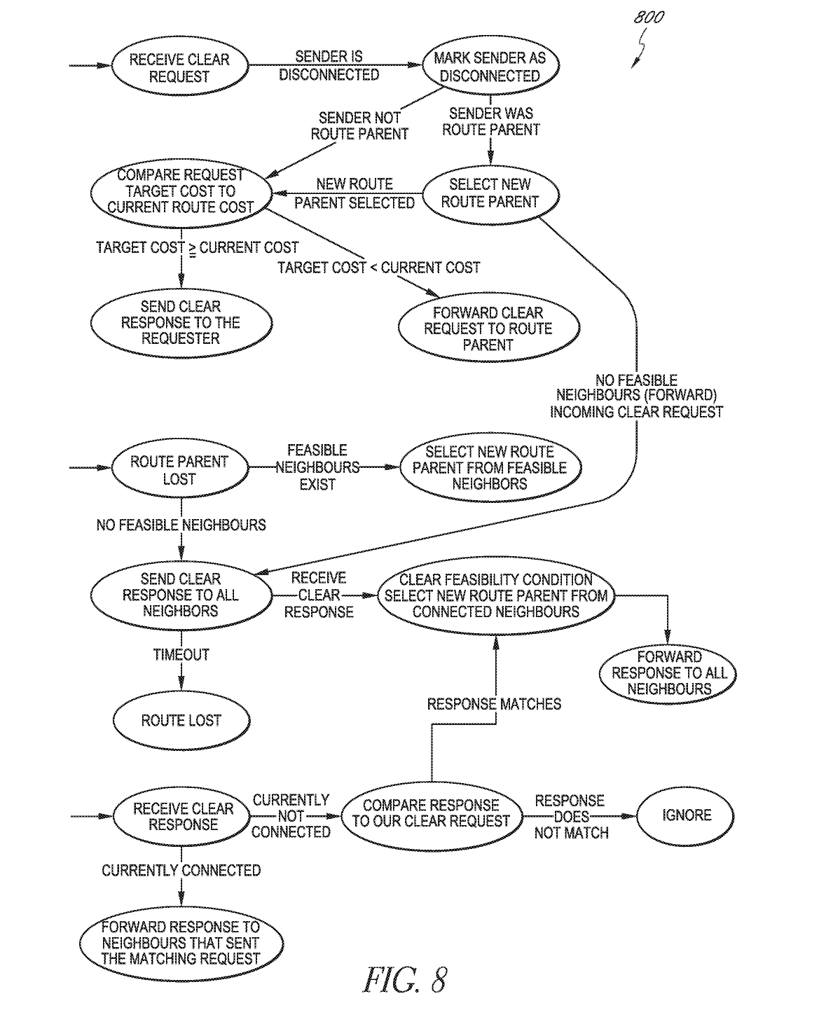

FIG. 7 schematically illustrates a flow diagram 700 presenting an overview of how various methods and functionality interacts when sending and receiving data to and/or from a destination node.

### II. EXAMPLES OF METHODS FOR REBUILDING ROUTES IN A DISTANCE VECTOR ROUTING SYSTEM

When a disconnection occurs, the routes over the lost connection can be reestablished. One way to do this would be to just have the subscriber-side of the connection select the next best connection (with the lowest cost) and send a message over that connection to set up the route. This would eventually propagate back to the publisher. However, if the publisher is no longer reachable at all, this algorithm may lead to an infinite loop (the “count-to-infinity” problem).

To solve this problem, in some implementations, feasible connections can be selected. FIG. 8 is an example of a state diagram 800 showing an implementation of a method for rebuilding routes in a distance vector routing system. For a given node, a connection may be considered feasible for a route if the reported cost over that connection (before adding the connection's cost) is strictly less than the lowest cost that the node has ever sent out for that route (the feasible cost). This criterion ensures that a routing loop is not formed. However, it can lead to a situation where there is still a route available to a publisher, but it cannot be selected because it is not feasible.

In some implementations, when a connection is removed, each route whose parent (route to the publisher) was over that connection may reselect the route parent, choosing the feasible connection with the lowest route cost. If no feasible connections exist for a route, then the node can determine if a route still exists. In some implementations, this can be done by sending out a clear request. The request may contain the route and node Universally Unique Identifier (UUID), and a sequence number to uniquely identify the request. It may also contain the feasible cost for the route, and a flag indicating that the sender has no feasible route anymore. The clear request may be sent to neighbors in the network that may be potential route parents or children (any connection that can be sent the access groups for the publication, and any connection that a route update has been received from).

In some implementations, when a clear request is received, if the request indicates that the sender is disconnected, then that connection can be marked as disconnected (so it may not be selected as a route parent). Then, if the receiving node has no feasible route, nothing happens. Otherwise, if the sender is the current route parent, then a new route parent may be selected. If there are no feasible connections remaining, then the clear request can be forwarded to appropriate neighbors (unless it has already been cleared—see below). Otherwise, if the current route cost for the route is less than or equal to the feasible cost in the request, or the current node is the publisher, then a clear response may be sent (see below). A clear response may also be sent if a clear response has already been received for the given request. If a clear response is not sent, then the request may be forwarded to the route parent (without the flag indicating that there is a disconnection).

Once a clear request reaches a point in the network that could not have the original requester as part of the route, then a clear response may be sent. The clear response may contain the route and requester UUID and the request sequence number, so that it can be matched to the request. The clear response can be sent back through the network over connections that the request was received from. When the response reaches any node that was disconnected due to the original request (either the original requester, or a node that had no feasible route after the request was processed), that node can reset the feasible cost for the route (allowing any connection to be feasible) and reselect a route parent, re-establishing the route. In some implementations when a connection is lost, routes may be rebuilt if possible. Since each node knows a configurable amount of its neighbors' neighborhood, it can attempt to rebuild its routes (received through the lost connection, not sent to avoid 2x the work) based on the known neighborhood. If that fails, then each node may send out a Help Me Broadcast. When all or most of a Server's neighbors return a message such as “already asked” or “not interested” or disconnected, then what may be returned to sender is “not interested.” This may back-propagate, deleting the invalid routes for non-connected object sources (may only apply to subscriptions in some implementations). Note that in some implementations, the route-reformation does not need to reach the original publisher, just a node routing the information. The Help-me Routing Algorithm can restrict the network distance of the initial-routing algorithm and then expand as needed. This type of re-routing can be considered as a subscription to a route regardless of the route being a publication or subscription.

In some implementations, a special case can be if a node receives a clear request from the route parent, and the request has already been responded to, then the node may reselect a route parent as usual, but if no feasible route remains, the clear request may not be forwarded to other nodes. Instead, a new clear request can be made originating from the node. This can prevent infinite loop issues where parts of the network are slow, and the clear response can arrive before the request has propagated to the newly selected parent.

If no clear response is received for a configured timeout (larger than the maximum propagation time through the network), then the publisher can be assumed to be unreachable, and the route can be removed. Clear responses are stored for the same timeout period so that requests over slow network paths can be responded to immediately rather than having to go farther through the network.

In one example of an improved algorithm, the disconnected node (with no feasible routes) may send unicast messages to its neighbors that are not route children. Each message may be forwarded along the route until it hits a node which may be closer to the route destination than the originating node (in which case a “success” response would be sent back), a disconnected route (in which case “failure” would be sent back), or the originating route (in which case that neighbor would be ruled out). When all or most of the neighbors are ruled out, the route children may be informed and they can repeat the process. In some implementations, this method's advantage is that users can set it up to use very little network bandwidth (in which case only 1 neighbor is tried at a time, in order of cost) at the expense of making the reconnection process potentially take a long time. On the other hand, nodes can send the message to all or most potential neighbors at once, and nodes can even inform the route children immediately. So users can tune it between bandwidth usage and reconnection speed without affecting the correctness (e.g., route loops can still be avoided). Accordingly, implementations of the system can provide one or more of the following:
Tunable between bandwidth usage and reconnection speed.
No periodic updates, more feasible routes (since there are no sequence numbers) (compared to the Babel protocol).
If configured to use the least possible bandwidth, some of the implementations use much less bandwidth than the other methods.

The advantages over other methods may include that there is no need for periodic sending (data may be sent only when needed in some implementations), and less of the network is contacted when fixing a route on average. This reduces network bandwidth and makes rerouting faster.

The differences may arise in how the algorithms handle the situation where a node has no remaining feasible routes (to a given destination). When this happens, the node may need to determine if there are any remaining routes to the destination that are currently infeasible. If there are, then one of those routes can be chosen, and the feasibility condition can be updated.

In the existing Diffusing Update Algorithm (DUAL) algorithm, this is done using a “diffusing computation.” The node with no feasible routes broadcasts to each of its neighbors. Each neighbor may respond if it still has a feasible route (with the original node removed from the set of possible routes); if a neighbor does not have any feasible route remaining, it may perform the same broadcast in turn. Once the neighbors have responded, a node may send a response to a broadcast, and may choose a new route (since the nodes whose routes may have passed through it have been notified that it is no longer feasible, and have updated their routes accordingly). In some cases, this method may need a broadcast by the nodes that are affected by the disconnection (or whatever event made the original route infeasible) and a reply from each node that receives the broadcast.

The existing Babel routing protocol uses sequence numbers to fix infeasible routes. If a node has no remaining feasible route, it broadcasts to its neighbors requesting a sequence number update. The neighbors then forward that message down the route chain until they hit either the origin or a node with the requested sequence number or higher. The route updates are then sent with the updated sequence number back along the message chain to the original sender. In some implementations, nodes may choose routes with a sequence number equal to their current sequence number or higher (if equal, the feasibility condition may hold). If the neighbors were using the original node as the route parent, they may treat that route as invalid and choose a new route parent (performing the same broadcast if there are no feasible routes). However, the Babel protocol also calls for periodic sequence number updates regardless of network errors. If it relies on the periodic updates, then there may be a long delay for route reconnection in some cases. This method makes it so that on average, 50% of routes that would otherwise be feasible cannot be chosen (because their sequence number is lower). This may mean that the reconnection process can happen more frequently. It may also utilize periodic route updates even if the network connectivity is not changing.

In some implementations, after a broadcast is sent out, every node with no remaining feasible routes forwards the broadcast to its neighbors. Nodes with feasible routes may forward the broadcast to their route parents, until it reaches a node that is “closer” to the route destination than the originating node. That node may send a response which is forwarded back to all requesters; when it is received by a node with no feasible routes, that node can reset its feasibility condition. This may, in some cases, utilize more aggregate network bandwidth than the DUAL algorithm, but may result in faster reconnection since a response can come from any valid node (there may be no need to wait for all nodes to respond in order to fix the route). It may not need the periodic updates of the Babel algorithm, and may need reconnection less frequently (since there are no sequence numbers). It may also utilize less bandwidth since the requests may need to travel to a node that is “closer” than the originating node (this may depend on network layout and history though).

### III. EXAMPLES OF METHODS FOR DISTRIBUTED FILTERING OF PUBLISHED INFORMATION IN A PEER-TO-PEER SYSTEM

In some implementations, the disclosed publish/subscribe system may use a distance vector method to set up peer-to-peer routes between publishers and subscribers. These routes may typically be one-to-many. To reduce network bandwidth, subscribers may filter published information so that desired information can be received. The filters can be applied at the subscribing node, and also at intermediate nodes in the route between publisher and subscriber, in such a way that published information can be filtered out as soon as possible (when no nodes farther along the route are interested in the information, it may not be sent any farther).

FIG. 9 is a diagram that illustrates an example of filtering in an embodiment of a peer-to-peer network 900 comprising a plurality of nodes 105. Once a route has been set up to a subscriber, the subscriber can begin receiving published information. However, the subscriber may be interested in a subset of that information. To reduce network bandwidth, one implementation offers filters which may be used to prevent unwanted information from being delivered.

For each publication that matches a subscription, the subscriber may define a filter. This filter can be modified at runtime. The filter can be a function that may be applied to incoming published information; if the information passes the filter, it can be passed to the subscriber; otherwise, the information may not be wanted. If the information does not pass any filters, then there may be no destinations that want it, so it may be dropped. When this happens, the set of filters can be passed to the route parent so that the filters may be applied there, so unwanted information may not be sent across the network. Once filters are sent, they may be sent to any new route parents as well. Each filter can be tagged with the subscription UUID it is associated with, so that it can be removed if the subscriber disconnects or no longer wants to receive any published information.

Each filter may have an index so it may be replaced at runtime. When a filter is replaced, the old filter can remain in effect until the new filter propagates up through the route.

Procedures to evaluate whether changing an internode's update rate or subset of information, can be changed or if a new path to a node earlier in the chain is more ideal are present. In one implementation, if a node 105 is sending 100 updates but current receivers only need 10, then it can decrease to 10 close to the sender; if near the recipient there is another node requesting 50 updates, it is more efficient to upgrade all internodes in between to 50. However, individual links may not have sufficient bandwidth. In some implementations where other links/paths are available it may not be ideal to increase the bandwidth on all links to nodes in between so those that have available capacity may be subject to an increase in bandwidth. Also, that this is updated at runtime may not preclude forcing no override at run time.

### IV. EXAMPLES OF METHODS FOR TRUST AND ACCESS PERMISSIONS IN A DISTRIBUTED PEER-TO-PEER SYSTEM

In some implementations, a distance vector method can be used to set up routes from publishers to subscribers in a distributed peer-to-peer system. Each node may assign group permissions to its connections to other nodes based on the properties of each connection (such as protocol, certificate information, etc.). Publications may be assigned “trust groups” and “access groups,” which may control how the routes are formed. Publication information may be sent over connections that have permissions to receive the “access groups.” This ensures that routes are formed through nodes that are authorized to receive the publication. Nodes 105 that receive publication information may ignore that information unless the sender is authorized to have the publication's trust groups; this may ensure that the information can be trusted by subscribers. The separation into trust and access groups allows configuration of nodes that can publish information that they cannot subscribe to, or vice versa.

In some implementations, the workings of the trust groups and access groups need not be known by the routing layer. An access list or trust list can be generated by any means and independent of the routing according to such rules.

The “trust” in trust groups may be assigned and modified over time. In some implementations, there can be a method to adjust trust based on transitive trust and supply this to a user or other process to make a decision, rather than, for example, requiring everything to be hard coded.

Each publication may be assigned a set of trust groups, and a set of access groups. These groups may be sent along with the route information. Route updates (and other route information) can be sent over connections that the publication's access groups are allowed to be sent to; this allows information to be routed around nodes in the network that are not allowed to access the published information. When a node receives a route update, it can accept the update if the publication's trust groups are allowed to be sent to the sending connection's groups. This allows subscribers to be confident that the route through the network back to the publisher is at least as trusted as the publication's trust groups (for sending messages to the publisher).

In some scenarios, there may not be any route through the network with the appropriate groups to allow a publication to reach a subscriber. In some implementations, an encrypted tunnel module may be used to set up an encrypted tunnel between publisher and subscriber, and forms a ‘virtual connection’ which can be secured and given whichever groups are desired, allowing confidential information to be routed across an untrusted network. In some implementations, the workings of Access Control may not be known by the routing layer and this case may not be different: a trust list or access list can be generated by any means and may be independent of the routing according to such rules. A virtual connection may be required from a higher level, but the routing may not make this decision or how to route the connection, rather the Access Control components may initiate a new subscription/publication that may be allowed to be routed with protected (encrypted) information contained inside.

The trust and access groups can be used to control the transmission of information for a publication. Any data sent out along the route (towards subscribers) may only be sent over connections with the access groups—this may include route updates, published information, history, and message responses. Any data sent back towards the publisher can be sent over connections with the trust groups (this happens naturally, because route updates can be accepted from connections with the trust groups). Information received from the publisher direction (route updates, published information, history, or message responses) can be accepted from connections with the trust groups; information received from the subscriber direction (route confirmation, messages, history requests) can be accepted from connections with the access groups.

In certain embodiments of this disclosure, the role of permissions can be filled by “groups”. For example, each connection can be assigned a set of one or more groups, which determine which datasets may be sent over that connection. The implementation provides the tools to correctly use groups.

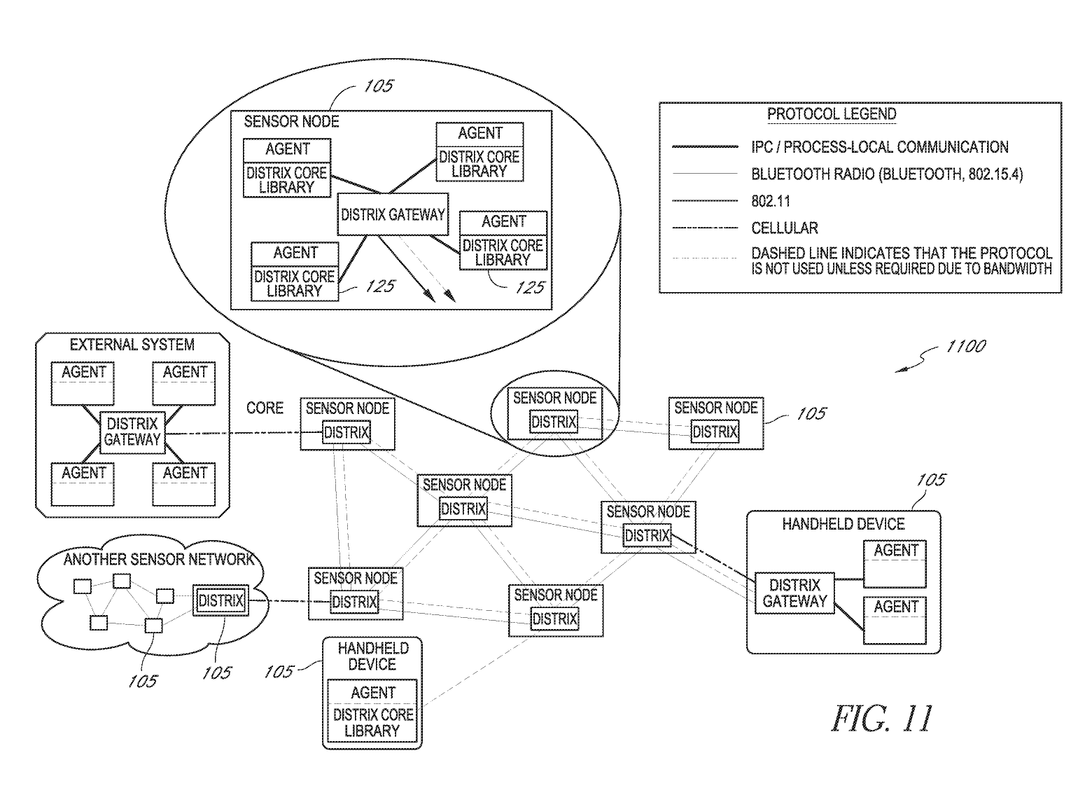

FIG. 10 is a diagram that illustrates an example of nodes 105 with group assignments. Note that in some implementations, node A and node B have assigned different groups (“a” and “z” respectively) to their connections to node C.

In some implementations, groups may be assigned to each connection before the connection becomes “ready to send”, via callback functions. If the callbacks are not present, the connection may be given the null group. In some implementations, groups may be added to a connection at any time using functions that add connection groups, but may not be removed from a connection. Note that groups for each connection may be determined on a per-connection and per-node basis. This means that different nodes can give different group sets to connections to the same node.

### Examples of Group Matching

When using groups, some or all of the datasets may have a set of groups associated with it. A dataset may be sent to a given connection if the dataset's groups can be sent to the connection's groups. In some implementations, to determine if a dataset's groups can be sent to a connection's groups, users can use functions that find available connection groups.

In some implementations, a group may be a string identifier. Groups may be hierarchical; different levels of the hierarchy may be separated by “.”. The highest level group can be “.” (or the empty string); any dataset can be sent to the “.” group. Otherwise, groups lower in the hierarchy can be sent to groups higher in the hierarchy. For example, a dataset with groups “a.b.c” and “x” may be sent to a connection with groups “a.b”, but may not be sent to a connection with (only) groups “x.y”.

In some implementations, the special null group can be assigned to connections with no other groups. A null group can be sent to a null group.

For a dataset to be sendable to a connection, at least one of the dataset's groups may be sendable to that connection. In some implementations, to determine if a single group can be sent to a connection's groups, function calls can be made.

In some implementations, a single dataset group can be sent to a connection's groups if one of the following is true:
The dataset group is the null group.
The connection's groups contain the dataset group, or a parent group of the dataset group (a parent group is a group higher in the hierarchy).
The dataset group is a wildcard group, and the wildcard matches one of the connection's groups.

### Examples of Wildcard Groups

Dataset groups can be wildcard groups. In some implementations, a wildcard group string may end in a “*” character. A wildcard group may match a connection group if the string preceding the wildcard “*” exactly matches the connection group's string up to that point. For example, the wildcard group “a.b*” would match the connection groups “a.b”, “a.bb” and “a.bcd”, but not “a.a”. It would also match the group “a” since “a” is a parent group of “a.b*”.

### Example of Transitive Properties

In some implementations, trust based on transitive trust may be deduced and presented to a user to make a decision, rather than having everything to be hard configured into the system. This runtime modification of trust and access lists can also be done automatically but may create a damaging access condition where an invalid access connection is propagated.

### V. EXAMPLES OF USE OF A COMMUNICATION LAYER-CENTRIC APPROACH FOR ADAPTIVE LOAD BALANCED COMMUNICATIONS, ROUTING, FILTERING, AND ACCESS CONTROL IN DISTRIBUTED NETWORKS WITH LOW-POWER APPLICATIONS

Various examples of uses of the disclosed technology are described herein. These examples are intended to illustrate certain features, systems, and use cases; these examples are for understanding purposes and are not intended to be limiting. In one embodiment, a system may allow non-full-time powered nodes 105 to self-identify, prioritize, filter, and/or adapt to route information through changing network conditions. In some implementations, it may be assumed that the simpler case of always-on nodes 105 is also covered by this more complex example.

The system may communicate with one or more sensor nodes 105. Certain of these sensor nodes 105 may not be primarily focused on sensing or actuating. For example, one or more of the nodes 105 can be Agent Nodes, Gateway Nodes, etc. Any (or all) of the nodes 105 can implement the Distrix functionality described herein including, e.g., the Core Library 125 and/or the Communication Layer 112. After a sensor node is powered on, one or more of the following actions might take place:
1. The firmware may bootstrap the operating system.
2. The operating system may load.
3. Since the operating system may be configured to automatically start the Distrix server on boot, the Distrix server may be started.
4. The Distrix server may discover neighboring sensor nodes over any wired connections.
5. If no such wired connections are available, which is likely for mobile scenarios, a wireless radio may be used to detect any other sensor nodes.
6. Once identified through discovery, hard-addressed pre-configured, remotely configured, or a combination there-in, Distrix connections may be established.
7. The Distrix server may start the agents as configured with the Process Management service.
8. All agents may indicate that they are ready to sleep.
9. When the Distrix server determines that everything is ready to sleep, it may instruct the sensor node that the processor into sleep mode.
10. The processor may store its current state and enters sleep mode.

The node 105 may wake up periodically to complete tasks on a time-event-basis or can be woken up based on other events as discussed below. The specific task that may be undertaken may be the behavior of the Communications Layer 112 and routing, filtering, access control, and/or overall adaptation to various conditions (network going up and down which may be well exemplified by mobile nodes going on/off).

For some of the items below, it may be assumed that a low-level connection has been established per the earlier discussion.

### Joining the Network

In some implementations, when a sensor node is turned on, it may join the local Distrix network of sensor nodes 105 in order to participate in the distributed system. In order to do this, Distrix may perform discovery of local nodes. The Distrix Link Modules 110 for the Bluetooth radio may be configured to auto discover neighbors on startup. The exact discovery mechanism may depend on the protocol. In general, a broadcast signal may be sent out and then connections may be made to any responders.

In some implementations, Distrix may automatically detect when neighbors leave the network (based on that neighbor not replying/not sending any data when it is expected to). If the network configuration is changing (e.g., the sensor nodes are moving) then discovery of local nodes could take place periodically to detect neighbors that are newly in range. In some implementations, it may be assumed that Bluetooth and Wi-Fi radios may offer similar range characteristics and therefore the constraint on using one or other of the technologies might be bandwidth related.

Once a neighbor is found, Distrix may set up a connection with that neighbor using the Distrix transport protocol. The neighbor may then send initial connection information so that the Distrix network can be set up.

Each side may then exchange IP addresses so that a Wi-Fi connection may be set up. In some implementations, once the Wi-Fi connection is set up with a neighbor, Wi-Fi may not be used further unless needed for bandwidth reasons. This may be done by configuring the Distrix transport layer to only use the Wi-Fi connection to a given server when the send queue for that server is larger than a given threshold value (determined by the number of milliseconds it would take to send all the data in the queue, given the send rate of the Bluetooth radio).

In some implementations, at this point, the node 105 may confirm access control via group permissions to its connections to other nodes based on the properties of each connection (such as protocol, certificate information, etc.). If the access and trust groups are allowed by the hierarchy, once the neighbor connections have been set up and all agents have indicated that they are ready for sleep, Distrix may instruct the sensor node 105 it is ready to communicate.

### Low-Powered Communications

In some implementations, some or all nodes 105 may turn on their low-power transceiver periodically to see if there may be data available to receive. When data is available, the node may continue receiving the limited filtered data until no more is available. If the required bandwidth is too high (the data queues up on the sending side), then the sender may instruct the receiver to turn on the Wi-Fi transceiver for high-bandwidth communication.

### Idle Mode

In some implementations, when a node 105 is not receiving anything, it may goes into idle mode. In this mode, the radio transceiver may only be turned on for short intervals. The length of the interval may be determined by the time it takes to receive a “wake up” signal, and the time between intervals may be governed by the desired latency. For example, if it takes 5 ms to receive a “wake up” signal, and the system may want a latency of 100 ms, then the system could configure the nodes to only turn on the transceiver (in receive mode) for 5 ms out of every 100. The specific timing of the interval could be chosen randomly, and transmitted to other nodes. For example, given the numbers above, the node could pick a random number i between 0 and 19 inclusive, and inform other nodes that it may be using that interval (receiving every 100 ms at t=k*100+5*i ms).

### Waking Up a Node

In some implementations, when node A (from the processor) has data to send to node B, it may wake up node B first (assuming B is in idle mode). To do this, A may wait until node B is receiving (node A may know this because it may know which receive interval B is using, and the clocks may be synchronized closely enough). A may then send a wakeup signal to B continuously so that the signal may be transmitted at least once during B's receive interval. It may then wait for an ACK from B. If B does not ACK, then the signal may be retried in the next receive interval. If B does not respond for some timeout period (e.g. 10 receive intervals), then A can consider it to be lost and cancel communication.

The system may prevent an attacker from continuously waking up nodes. To do this, in some implementations, the system may need to ensure that the wakeup signal is from a valid node before a node takes action on it. To do this, the system may embed a secret key into each node (e.g., the same key for all nodes in the network).

Once B wakes up, the processor may take over all direct communication control.

### Wakeup Packet

In some implementations, the counter may be incremented by the sender whenever a wakeup signal is sent. Each node 105 may maintain a counter for each other node it may know about. The magic number may be a known constant value. The random number, counter and magic number may be encrypted using the shared secret key (in some implementations, using cipher block chaining (CBC) mode). Note that this information in some implementations may not be secret; the system may verify that the sending node has the same secret key. When a wakeup signal is received, the counter and magic number may be decrypted using the receiver's secret key. If the magic number does not match, or the counter is not within a 32-bit (which may be configurable) range of the previous counter received from the sender, then the wakeup signal may be ignored.

### Entering Active Mode

Once B receives the wakeup signal from A and verifies it, it may turn on the processor, sends an ACK back to A, and enter active mode. The ACK packet format can be identical to the wakeup packet. The source and destination fields may be swapped, and the type may be set to “wakeup-ack”. The counter value may be set to one greater than the value sent in the wakeup packet.

While in active mode, B may continuously receive packets, acking as appropriate. In some implementations, data packets may not be acked since the higher level protocol may take care of that. In some implementations, if a timeout period (e.g. 100 ms) elapses without any new packets being received, then B may shut off the transceiver and the processor and return to idle mode (if nothing else needs to be done).

In some implementations, once in Active Mode, there may be no filtering based on time or dataset update rate. In fact, this change in filter can be a trigger to enter Active Mode. For instance, when relevant datasets are received, the filtering update rate may be increased for additional processing of the data in question. In this case, the filters could be passed to the route parent.

### Embodiment of a Network Architecture

FIG. 11 schematically illustrates an example of a network 1100 and communications within the network. Note that in the example network 1100 shown in FIG. 11, there may be one or more types of networks. In some implementations, inter-process communication (IPC) networks may run on the given node 105, while Bluetooth®, Institute of Electrical and Electronics Engineers (IEEE) 802.11 (Wi-Fi) run-inter-node; cellular may be used as a back-haul to other systems or other groups of nodes. Certain handheld devices may connect to a variety of networks and can access any information in the Information Model, regardless of the initial Link connection, thanks to the Communication Layer strategies employed.

### Potential to Selectively Use the Wi-Fi Radio

In some implementations, when Distrix is sending a large amount of data to a neighbor, the data rate may exceed the available bandwidth of the Bluetooth radio, and so data may begin to be queued. Once the queue grows to a given configured size, Distrix may activate a wireless (e.g., Wi-Fi) connection. This may send a signal over the Bluetooth radio connection to the neighbor to turn on its Wi-Fi radio, and then begin load-balancing packets between the Bluetooth radio and the Wi-Fi radio. Once the send queue has shrunk below a configurable threshold value, the Wi-Fi connection may be put to sleep, and the Wi-Fi radios may be turned off.

### Connecting to the Sensor Network

To get information from the sensor network, or to manage the network, one can join the Distrix network. In some implementations, this may be done either with a Distrix server (with agents connected to that server for user interface), or with a single agent using the Distrix client library. In some implementations, using a Distrix server may be preferred since it could seamlessly handle moving through the network—as connections may be added or removed, the Distrix routing algorithms within the Communication Layer may handle updating the routes. When using a single agent with the Distrix client library, there may be some user interaction interruption under the non-robust scenario where there may be a single connection where one connection may be lost and a new connection could be found.

In some implementations, when in the vicinity of a sensor node, a user may connect to the sensor network in the same way as a new sensor node. The user's device may do discovery of local sensor nodes using the Bluetooth radio, and may connect to neighbors that reply. Distrix may set up appropriate routes based on the publications and subscriptions of the user, and then data may be transferred accordingly.

In some implementations, if a user wishes to connect to the sensor network from a remote location that is not within range of the low-power radios, then they may connect to a sensor node using the cellular radio. In some implementations, it may be assumed that the user's power constraints may not be as tight as that of an sensor node.

One way to perform the connection may be to assign a given period during the day for each sensor node to listen on the cellular radio. In some implementations, these periods may not overlap, depending on user needs. For example, if a 1 minute wait for connection to the sensor network is acceptable, then there could be 1-minute gaps between listen periods. Similarly, the listening sensor node may not be listening continuously during its listen period. In some implementations, it could listen only for 100 ms out of every second. The user's device could have a list of Internet protocol (IP) addresses to attempt to connect to. Based on the time of day it could continuously try to connect until a connection may be successful. Once a connection is formed, the Distrix network connection setup could proceed as usual. In some implementations, under external control the active connection could be switched to a new sensor node periodically to reduce power drain on any single sensor node.

In some implementations, for external network connection over cellular where there may be no prior Bluetooth discovery the connection may be configured at either end. Given that this is not likely to be an ad hoc situation then this approach may be assumed to be viable.

### Event Publishing/Subscribing Through the Information Model

In some implementations, there may be two options for distributing events to users. The first option may be to configure the event publications to be broadcast throughout the network whenever a new event occurs. User applications could subscribe to those events, but restrict the subscription to the immediate Distrix server (so that the subscription may not broadcast throughout the network). Since events of interest may be broadcast to all nodes, events could be immediately available to a user joining the network. In some implementations, new events could be delivered to the user as long as the user may remain connected (since the subscription could remain active and new events could be broadcast to the user's device).

The second option may be to configure the event publications to distribute events to subscribers. User applications could subscribe to the event publications as an ordinary subscription. In some implementations, when the subscription is made (or the user device joins the network), the subscription could be broadcast through the network, and routes could be set up for event information. Event history for each publisher may be delivered along the routes, and new events may be delivered as they occur as long as the user remains connected.

In some implementations, the first option could be appropriate in cases where network latency is high, and events occur infrequently. For example, if it takes 1 minute on average for information to travel from one sensor node to another (e.g. the sensor nodes have a very low duty cycle), then in a large network it may take half an hour to set up routes and deliver the event information (as in option 2). In this case it may be better to choose option 1. Furthermore, if events occur as frequently or less frequently than user requests for event information, the first option may consume less network bandwidth.

If network latency is lower and events occur more frequently, then the second option may be more appropriate because it may reduce the network bandwidth requirement.

### Higher Bandwidth Auto-Rollover

In some implementations, each Link Module 110 may have within it a set of Cost Metrics published that may allow Distrix to choose the best communication path. However, the first path may not always be enough. At any time, it may be automatically required or a sender may request that another node turn on its Wi-Fi (or other network) for high-bandwidth communication.

In some implementations, when the send or receive buffer may be too big (using IEEE 802.15.4 failover to 802.11.b as an example):
The 802.11.b Link Module could reduce its cost below the other link
Distrix may start the 802.11.b connection
Distrix may stop using the 802.15.4 connection
When a Link is not used, its Link Module may request the OS to power off the radio
When the send or receive buffer falls back within defined limits, the 802.11.b Link Module may increase its cost above the other link
In some implementations, Distrix may not immediately swap between the two links, but may wait until the buffer may not require the use of the secondary-preferred link, and then may switch to the 802.15.4 Link.
When a Link is used, the Link Module may request the OS to power on its radio.

In this manner, the routing may be recalculated and a new route may be set up for data transport in some implementations. Similarly, in some implementations, Distrix can transmit the metadata to specific interested nodes throughout the network. When there is reason, a request for resource can be sent back and the two Distrix Servers can connect directly over a long-distance, pre-agreed-upon network.

### VI. EXAMPLES OF COMMUNICATION METHODS

Certain illustrative examples of methods that can be implemented by the systems and devices disclosed herein will now be described. These examples methods are intended to illustrate and not to limit the scope of the disclosure. Computer hardware such as, e.g., the computing device 1900, the node 105, a hardware router, general and/or specialized computing devices, etc. can be configured with executable instructions that perform embodiments of these methods. In various embodiments, these methods can be implemented by the Communication Layer 112, the Application Layer 130, the Core Library 125, and/or other layers. In various implementations, embodiments of the following methods can be performed by an Agent Node and/or a Gateway Node.

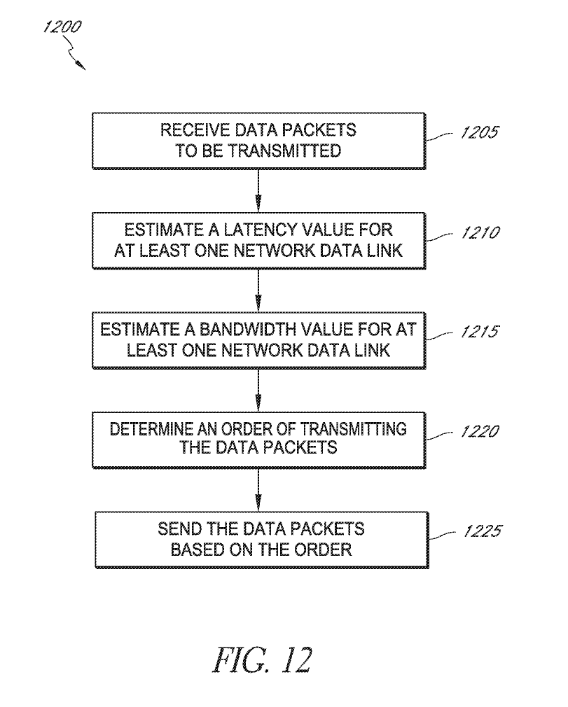

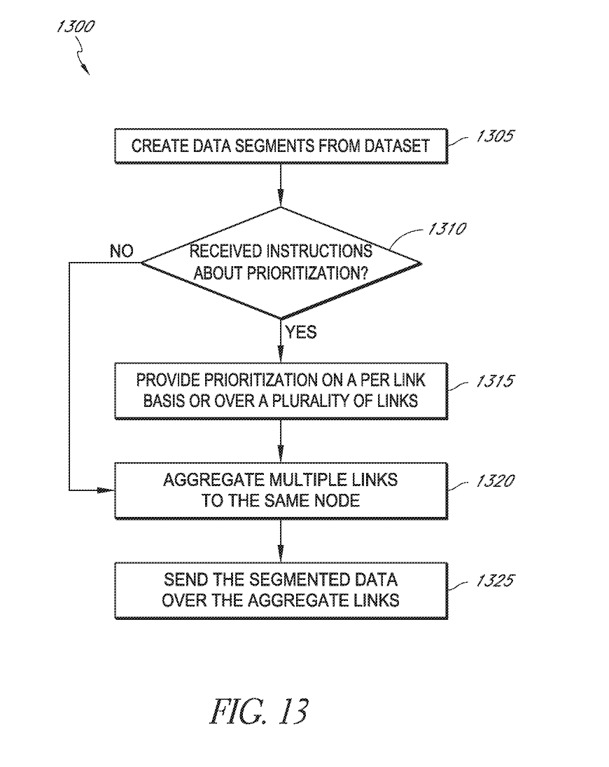

FIG. 12 is a flow chart illustrating one embodiment of a method 1200 implemented by the communication system for receiving and processing, and/or transmitting data packets. The method 1200 begins at block 1205, where communication system receives data packets to be transmitted via a plurality of network data links. In some embodiments, such data packets are received from a computing node. In some other embodiments, such data packets may be received from another computing or data routing device.

The method 1200 proceeds to block 1210, where the communication system estimates a latency value for at least one of the network data links. In some embodiments, a latency value may be estimated for each of the plurality of network data links. In some other embodiments, latency values are only calculated for a selected few of all the network data links.

The method 1200 then proceeds to block 1215, where the communication system estimates a bandwidth value for at least one of the network data links. In some embodiments, a bandwidth value may be estimated for each of the plurality of network data links. In some other embodiments, bandwidth values are only calculated for a selected few of all the network data links. Moreover, the estimation of bandwidth values may be done periodically, continuously, or only in certain situations such as the beginning of a transmission session.

The method 1200 then proceeds to block 1220, where the communication system determines an order with which the data packets may be transmitted. For example, the communication system may determine the order of transmitting the data packets based on the estimated latency value and the estimated bandwidth value. In some other situations, the determination may be based on other factors or additional factors, such as priority of a queue, security type, and so forth. In some implementations, the method 1200 can identify at least one network data links for transmitting the data packets based at least partly on the estimated latency value of the estimated bandwidth value. The method can send the data packets over the identified network data link (or links) based at least partly on the determined order.

The method 1200 then proceeds to block 1225, wherein the communication system sends the data packets over the network data links based at least partly on the determined packet order for transmitting the data packets. In some embodiments, the network data links are further aggregated into a single connection. The data packets may also be sent on different network data links for load balancing purposes or in fail-over situations. In an alternative embodiment, the method 1200 may include determining whether a queue for data packets is empty. The method 1200 may further include adding a new data item to the queue and removing a data item from the queue for processing. The method 1200 may further include removing a data item from the queue without processing the data item. In some embodiments, removing the data item from the queue without processing further may include selecting the item based at least partly on a probability function of time, which may have a value of zero for a period of time but increase as time goes on. As used herein, a data item is a broad term and used in its general sense and includes, for example, a data packet, a data segment, a data file, a data record, portions and/or combinations of the foregoing, and the like.

FIG. 13 is a flow chart illustrating one embodiment of a method 1300 implemented by the communication system for processing and transmitting data packets. The method 1300 begins at block 305, where the communication system creates data segments based on a received dataset. In some embodiments, the system may record the offset and length of each data segment, which may have variable sizes.

The method 1300 then proceeds to a decision block 1310 to determine whether prioritization is applied to some or all of the data packets. If the answer is yes, then the method 1300 proceeds to block 1315, where the communication system may provide prioritization on a per link basis. In some other situations, instead of providing prioritization per each link, the system may prioritize data transmission over a plurality of links. The method 1300 then proceeds to block 1320 If the answer is no (prioritization is not applied to some or all of the data packets), the method 1300 proceeds to block 1320.

At block 1320, the communication system may aggregate multiple network data links to form a single connection or multiple connections. In some situations, the multiple network data links may be data links of various types, such as data link transmitted over cellular networks, wireless data links, land-line based data links, satellite data links, and so forth.

The method 1300 then proceeds to block 1325, where the communication system sends the segmented data over the aggregated links to a destination computing node or device. As described previously, the aggregated network data links may be links of various types.

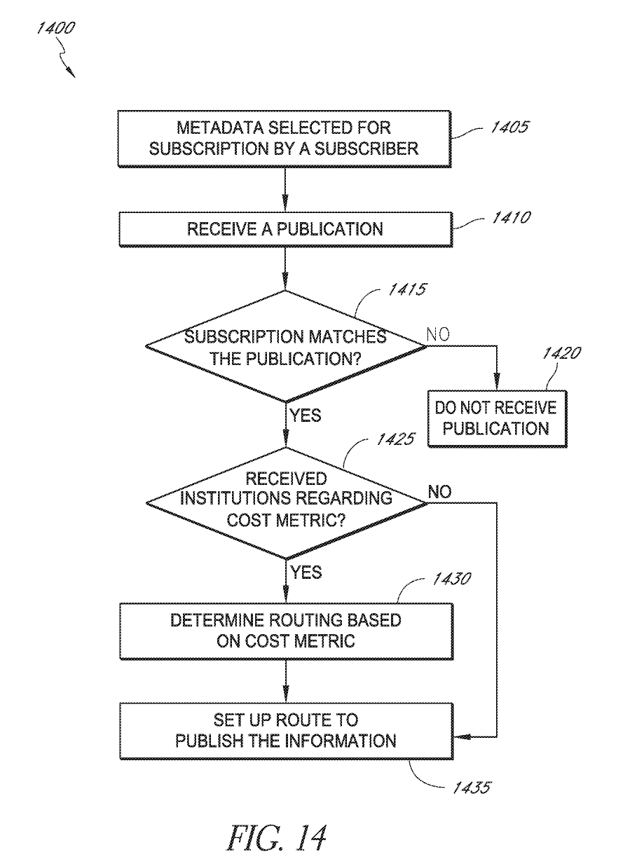

FIG. 14 is a flow chart illustrating one embodiment of a method 1400 implemented by the communication system for transmitting subscription-based information. The method 1400 begins at block 1405, where a subscriber selects metadata or other types of data for subscription. The method 1400 then proceeds to block 1410, where the communication system receives a publication containing metadata and/or other types of information. The method 1400 then proceeds to a decision block 1415, where the communication system determines whether the subscriber's subscription matches one or more parameters in the publication. If the answer is no, then the method 1400 proceeds to block 1420, where the publication is not selected for publication to the subscriber, and the method 1400 stops. If the answer is yes, however, the method 1400 then proceeds to a second decision block, 1425, where the system determines whether there are any cost-metric related instructions.

If the answer to the question in decision block 1425 is yes, the method 1400 then proceeds to block 1430 to determine routing of the publication based on the cost metric. For example, the routing may be based on a maximum cost related to a publication (such as a certain “distance” from the publisher), and so forth. The method 1400 then proceeds to block 1435.

If the answer to the question in decision block 1425 is no, the method 1400 proceeds to block 1435, where the communication system sets up a route to publish the information represented in the publication.

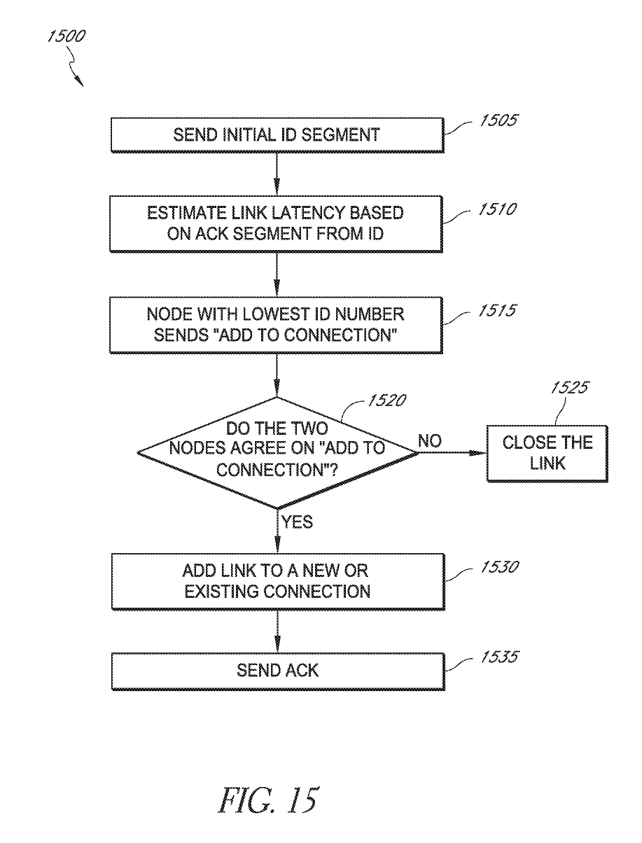

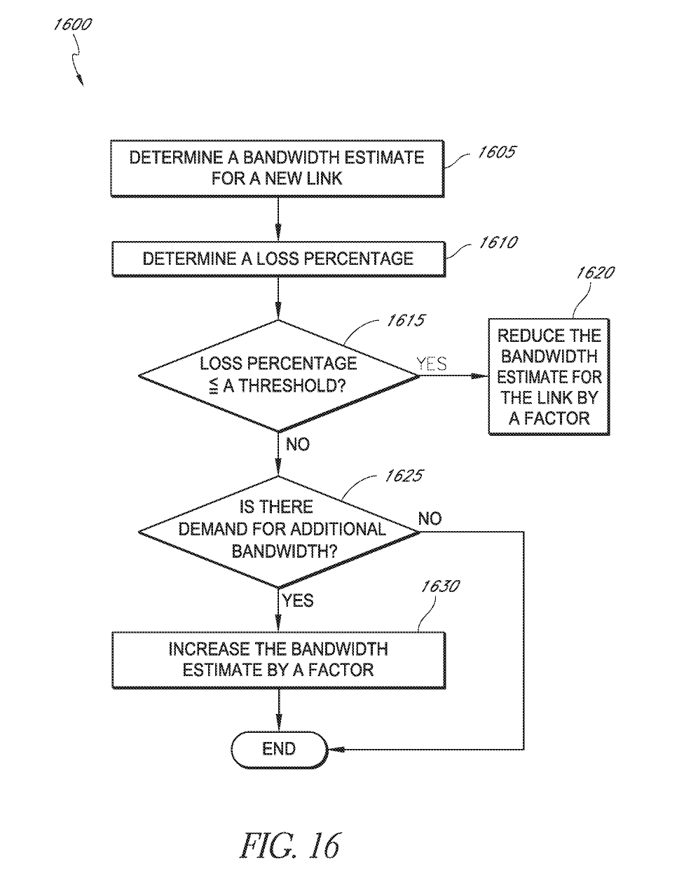

FIG. 15 is a flow chart illustrating one embodiment of a method 1500 implemented by the communication system for adding a link to an existing or a new connection. The method 1500 begins at block 1505, where an initial ID segment was sent to a computing node or device. The method 1500 then proceeds to block 1510, where link latency is estimated based at least on the “ACK” segment of the initial ID that was sent.

The method 1500 then proceeds to block 1515, where a node with the lowest ID number sends a request to add a link to a connection. In some embodiments, the request may be to add the link to an existing connection. In some other embodiments, the request may be to add the link to a new connection.

The method 1500 then proceeds to a decision block 1520, where it is determined whether the node with the lowest ID number the node to which the connection is destined agree on adding the link to the connection. If the answer to the question is no, the method 1500 proceeds to block 1525 and closes the link.

If, however, the answer to the question in decision block 1520 is yes, then the method proceeds to block 1530, where the link is added to a new or existing connection. In some embodiments, the link may be of the same or a different type than other links in the same connection. For example, the link may be a link based on cellular networks on the other links in the same connection are wireless Internet links. The method 1500 then proceeds to block 1535, where an ACK was sent to acknowledge the addition of the link to the connection.

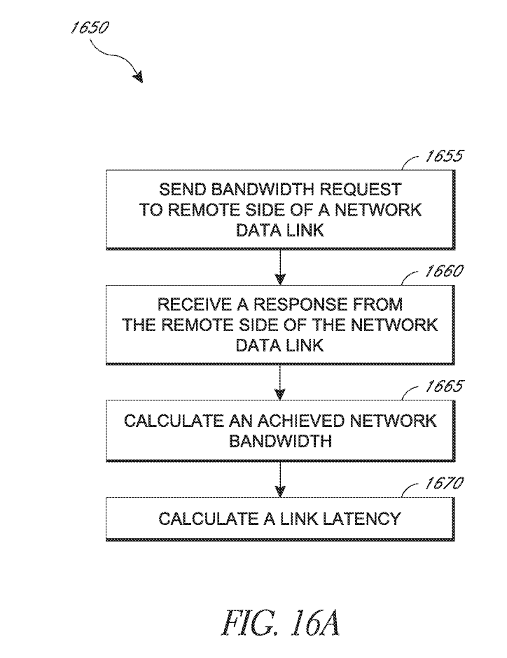

FIG. 16 is a flow chart illustrating one embodiment of a method 1600 implemented by the communication system to generate bandwidth estimates. The method 1600 begins at block 1605, where the communication system determines a bandwidth estimate value for a new link. In some embodiments, when a new link is created, the bandwidth estimate for that link may be a pre-configured value or a default value.

The method 1600 then proceeds to block 1610, where the communication system determines a loss percentage value. The system may, for example, use the ACK for segments sent over that link in a time period to estimate a loss percentage value over that period of time. The method then proceeds to decision block 1615, where it is determined whether the loss percentage is smaller or equal to a threshold. If the answer to the question is no, then the method 1600 may proceed to block 1620, where the initial bandwidth estimate for the link may be reduced by a factor. The value of the factor may be determined in turn, for example, based on the frequency of bandwidth reduction. For example, if several bandwidth reductions have been performed in a row, the reduction could be larger than in situations where no bandwidth reduction has been performed for a while.

If, however, the answer to the question in decision block 1615 is yes, then the method 1600 proceeds to another decision block 1625, where it is determined whether there is demand for additional bandwidth. If the answer is no, the method 1600 ends or starts a new round of bandwidth estimate for continuous bandwidth estimation. If the answer is yes, the method 1600 proceeds to block 1630 and increase the bandwidth estimate by a factor. In some embodiments, the factor may be changed based on link history or the reduction factor. The method 1600 then proceeds to end at block 1640.

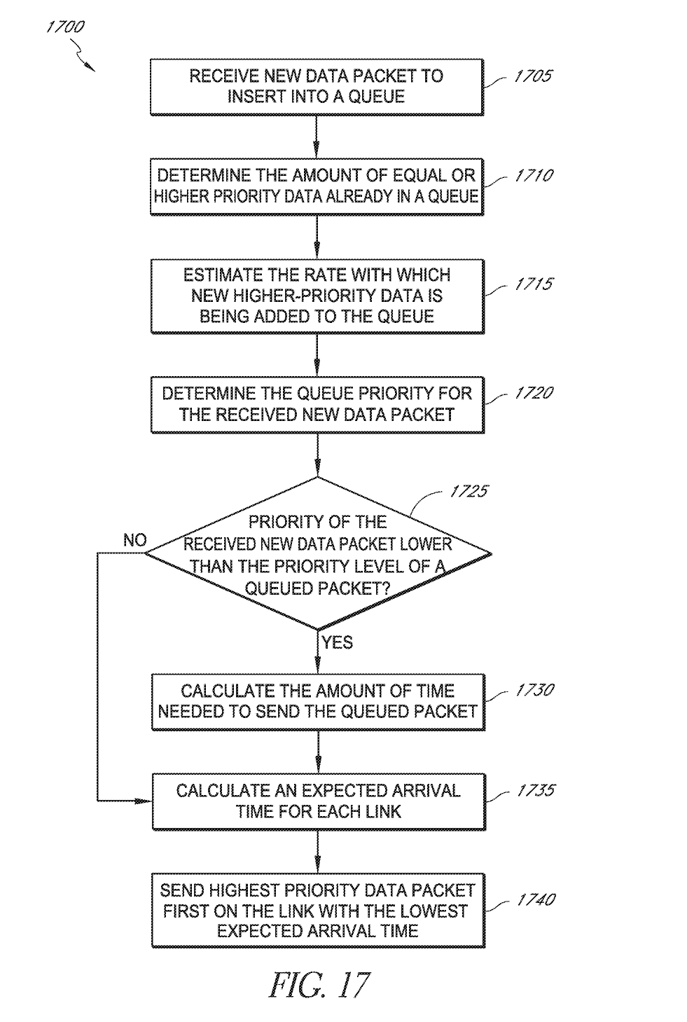

FIG. 17 is a flow chart illustrating one embodiment of a method 1700 implemented by the communication system to provide prioritization. The method 1700 begins at block 1705, where the communication system receives new data packets to be inserted into a queue. In some embodiments, the system also receives information or instructions regarding the priority of the data packets to be inserted.

The method 1700 then proceeds to block 1710, where the communication system determines the amount of data with equal or higher priority that is already in the queue. The method 1700 then proceeds to block 1715, where the communication system estimates the rate with which the new higher-priority data is being added to the queue. The method 1700 then proceeds to block 1720, where a queue priority is determined based on the estimated send time for each packet rather than the data priority of the packet. The method 1700 then proceeds to a decision block 1725, where it is determined whether the priority of the received new data packet is lower than the priority level of an in-queue packet. If the answer is yes, then the method 1700 proceeds to block 1730 and calculates the amount of time still needed to send the in-queue packet(s). The method 1700 then proceeds to block 1735. However, if the answer is no, then the method 1700 proceeds to block 1735, where the expected arrival time is calculated for each link. In some embodiments, the expected arrival time is (link latency+wait time). The expected arrival time may be calculated via other methods and/or formula in some other situations. The method 1700 then proceeds to block 1740, where the link with the lowest expected arrival time is used to send a packet. If necessary, the packet will be added to that link's send queue based on the expected send time (e.g., current time+wait time). In some embodiments, packets with the same expected send time may be sent in the order they were added to the queue.

In an alternative embodiment, the method 1700 may further include calculating an estimated amount of time a data packet will stay in a queue for a network data link. This calculation may, in some embodiments, by done by summing a wait time associated with each data packet with a priority value that is higher than or equal to the priority value of the data packet that will stay in the queue. The method 1700 may further include calculating an estimated wait time for each or some of the priority values as (amount of queued data packets for the priority value)/(an effective bandwidth for the priority value). The effective bandwidth for the priority value comprises (a current bandwidth estimate for the network data link—a rate with which data packets associated with a priority value that is higher than the priority value is being inserted to the queue).

In another alternative embodiment, the method 1700 may further include creating a queue for each of a plurality of reserved bandwidth streams and adding data packets that cannot be transmitted immediately and are assigned to a reserved bandwidth stream to the queue for the stream. The method 1700 may also include creating a priority queue for ready-to-send queues and creating a priority queue for waiting-for-bandwidth queues. The method 1700 may also include moving all queues in the “waiting-for-bandwidth” priority queue with a ready-time less than a current time into the “ready to send” priority queue. The method 1700 may further include selecting a queue with higher priority than all other queues in the “ready to send” priority queue and “removing and transmitting a first data packet in the queue with higher priority than all other queues in the “ready to send” priority queue.

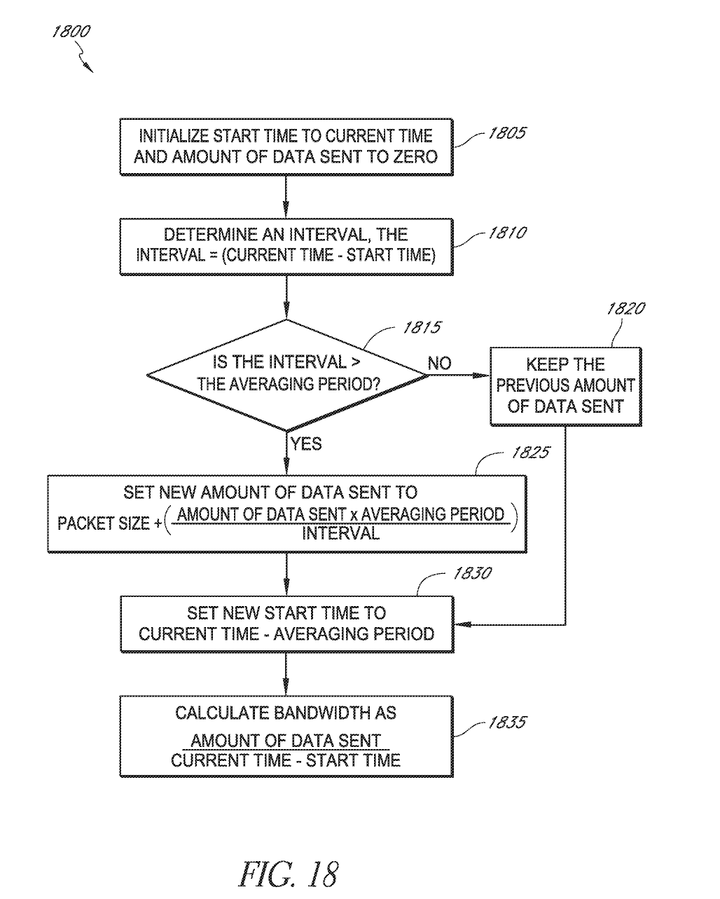

FIG. 18 is a flow chart illustrating one embodiment of a method 1800 implemented by the communication system to calculate bandwidth with low overhead. The method 1800 begins at block 1805, where the communication system initialize a start time variable to current time and an amount of data sent variable to zero. The method 1800 then proceeds to block 1810, where an interval variable's value is set as (current time−start time). The method 1800 then proceeds to decision block 1815, where the communication system may check whether the interval is greater than the averaging period (for example, 100 ms or some other number). If the answer is no, the method 1800 then proceeds to block 1820, where the original amount of data set is kept and not changed. The method 1800 then proceeds to block 1830. However, if the answer is yes, the method 1800 then proceeds to block 1825, and an new or updated amount of data sent is set to: (packet size+(amount of data sent*averaging period)/interval)). The method 1800 then proceeds to block 1830, where start time is set to (current time−averaging period). The method 1800 then proceeds to block 1835, where the bandwidth is calculated as (amount of data sent/(current time−start time)).

### VII. EXAMPLES OF COMMUNICATION ARCHITECTURE, DEVICES, AND NODES

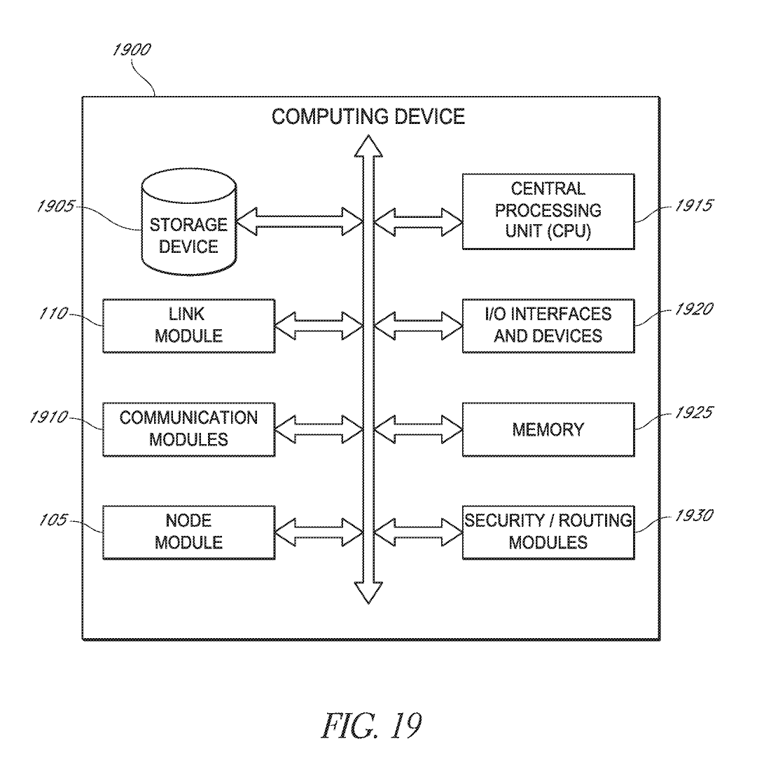

FIG. 19 is a block diagram schematically illustrating an embodiment of a computing device 1900. The computing device 1900 may be used to implement systems and methods described in this disclosure. For example, the computing device 1900 can be configured with executable instructions that cause execution of embodiments of the methods 1200-1800 and/or the other methods, processes, and/or algorithms disclosed herein.

The computing device 1900 includes, for example, a computer that may be IBM, Macintosh, or Linux/Unix compatible or a server or workstation. In one embodiment, the computing device 1900 comprises a server, desktop computer or laptop computer, for example. In one embodiment, the example computing device 1900 includes one or more central processing units (“CPUs”) 1915, which may each include a conventional or proprietary microprocessor. The computing device 1900 further includes one or more memory 1925, such as random access memory (“RAM”) for temporary storage of information, one or more read only memory (“ROM”) for permanent storage of information, and one or more storage device 1905, such as a hard drive, diskette, solid state drive, or optical media storage device. Typically, the modules of the computing device 1900 are connected to the computer using a standard based bus system 418. In different embodiments, the standard based bus system could be implemented in Peripheral Component Interconnect (“PCI”), Microchannel, Small Computer System Interface (“SCSI”), Industrial Standard Architecture (“ISA”) and Extended ISA (“EISA”) architectures, for example. In addition, the functionality provided for in the components and modules of computing device 1900 may be combined into fewer components and modules or further separated into additional components and modules.

The computing device 1900 is generally controlled and coordinated by operating system software, such as Windows XP, Windows Vista, Windows 7, Windows 8, Windows Server, Unix, Linux, SunOS, Solaris, or other compatible operating systems. In Macintosh systems, the operating system may be any available operating system, such as MAC OS X. In other embodiments, the computing device 1900 may be controlled by a proprietary operating system. Conventional operating systems control and schedule computer processes for execution, perform memory management, provide file system, networking, I/O services, and provide a user interface, such as a graphical user interface (“GUI”), among other things.

In certain embodiments the computing device 1900 can be configured to host one or more virtual machines executing on top of a virtualization infrastructure. The virtualization infrastructure may include one or more partitions (e.g., a parent partition and one or more child partitions) that are configured to include the one or more virtual machines. Further, the virtualization infrastructure may include, for example, a hypervisor that decouples the physical hardware of the computing device 1900 from the operating systems of the virtual machines. Such abstraction allows, for example, for multiple virtual machines with different operating systems and applications to run in isolation or substantially in isolation on the same physical machine. The hypervisor can also be referred to as a virtual machine monitor (VMM) in some implementations.

The virtualization infrastructure can include a thin piece of software that runs directly on top of the hardware platform of the CPU 1915 and that virtualizes resources of the machine (e.g., a native or “bare-metal” hypervisor). In such embodiments, the virtual machines can run, with their respective operating systems, on the virtualization infrastructure without the need for a host operating system. Examples of such bare-metal hypervisors can include, but are not limited to, ESX SERVER or vSphere by VMware, Inc. (Palo Alto, Calif.), XEN and XENSERVER by Citrix Systems, Inc. (Fort Lauderdale, Fla.), ORACLE VM by Oracle Corporation (Redwood City, Calif.), HYPER-V by Microsoft Corporation (Redmond, Wash.), VIRTUOZZO by Parallels, Inc. (Switzerland), and the like.

In other embodiments, the computing device 1900 can include a hosted architecture in which the virtualization infrastructure runs within a host operating system environment. In such embodiments, the virtualization infrastructure can rely on the host operating system for device support and/or physical resource management. Examples of hosted virtualization layers can include, but are not limited to, VMWARE WORKSTATION and VMWARE SERVER by VMware, Inc., VIRTUAL SERVER by Microsoft Corporation, PARALLELS WORKSTATION by Parallels, Inc., Kernel-Based Virtual Machine (KVM) (open source), and the like.

The example computing device 1900 may include one or more commonly available input/output (I/O) interfaces and devices 1920, such as a keyboard, mouse, touchpad, and printer. In one embodiment, the I/O interfaces and devices 1920 include one or more display devices, such as a monitor, that allows the visual presentation of data to a user. More particularly, a display device provides for the presentation of GUIs, application software data, and multimedia presentations, for example. The computing device 1900 may also include one or more multimedia devices, such as speakers, video cards, graphics accelerators, and microphones, for example.

In the embodiment of FIG. 19, the I/O interfaces and devices 1920 provide communication modules 1910. The communication modules may implement the Communication Layer 112, the communication system, the Distrix functionality, and so forth, as described herein. In the embodiment of FIG. 19, the computing device 1910 is electronically coupled to a network, which comprises one or more of a LAN, WAN, and/or the Internet, for example, via a wired, wireless, or combination of wired and wireless, communication links and/or a link module 110. The network may communicate with various computing devices and/or other electronic devices via wired or wireless communication links.

According to FIG. 19, information is provided to the computing device 1900 over the network from one or more data sources including, for example, data from various computing nodes, which may managed by node module 105. The node module can be configured to implement the functionality described herein such as, e.g., the Core Library 125, the Application Layer 130, and/or the Communication Layer 112. The node module can be configured to implement an Agent Node, a Gateway Node, and/or a sensor node. The information supplied by the various computing nodes may include, for example, data packets, data segments, data blocks, encrypted data, and so forth. In addition to the devices that are illustrated in FIG. 19, the network may communicate with other computing nodes or other computing devices and data sources. In addition, the computing nodes may include one or more internal and/or external computing nodes.

Security/routing modules 1930 may be connected to the network and used by the computing device 1900 to send and receive information according to security settings or routing preferences as disclosed herein. For example, the security/routing modules 1930 can be configured to implement the security layer and/or routing layer illustrated in FIG. 1B.

In the embodiment of FIG. 19, the modules described in computing device 1900 may be stored in the mass storage device 1905 as executable software codes that are executed by the CPU 1915. These modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. In the embodiment shown in FIG. 19, the computing device 1900 is configured to execute the various modules in order to implement functionality described elsewhere herein.

In general, the word “module,” as used herein, is a broad term and refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a non-transitory computer readable medium, such as a compact disc, digital video disc, flash drive, or any other tangible medium. Such software code may be stored, partially or fully, on a memory device of the executing computing device, such as the computing device 1900, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

In some embodiments, one or more computing systems, data stores and/or modules described herein may be implemented using one or more open source projects or other existing platforms. For example, one or more computing systems, data stores, computing devices, nodes, and/or modules described herein may be implemented in part by leveraging technology associated with one or more of the following: the Distrix® VL embeddable software data router and application, the Distrix® Core Services software platform for information exchange, the Distrix® Network Services that provide distribution mechanisms for networks, the Distrix® Application Services that provide semantics and handling of information flowing through a network, and the Distrix® Development Toolkit that provides APIs and development tools (available from Spark Integration Technologies, Vancouver, BC, Canada).

### Example Node Architecture

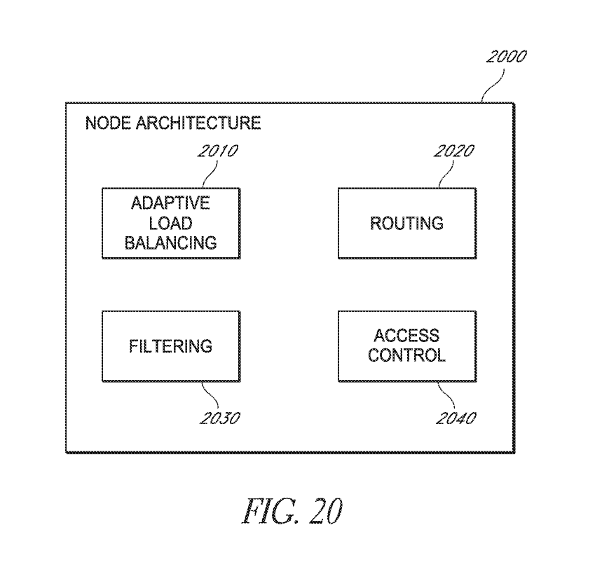

FIG. 20 is a block diagram schematically illustrating an embodiment of a node architecture 2000. The node architecture 2000 can be configured to implement an Agent Node, a Gateway Node, a sensor node, or any other type of node 105 described herein. The computing device 1900 shown in FIG. 19 (e.g., the node module 105) can be configured with executable instructions to execute embodiments of the node architecture 2000. The node architecture 2000 can include one or more modules to implement the functionality disclosed herein. In the example shown in FIG. 20, the node architecture 2000 includes modules for adaptive load balancing 2010, routing 2020, filtering 2030, and access control 2040. Bandwidth and/or latency estimation can be performed by one (or more) of these modules. The modules 2010-2040 can be configured as a Communication Layer 112, Application Layer 130, and/or one or more components in the Core Library 125. In other embodiments, the node architecture 2000 can include fewer, more, or different modules, and the functionality of the modules can be merged, separated, or arranged differently than shown in FIG. 20. None of the modules 2010-2040 is necessary or required in each embodiment of the node architecture 2000, and the functionality of each of the modules 2010-2040 should be considered optional and suitable for selection in appropriate combinations depending on the particular application or usage scenario for the node 105 that implements the node architecture.

### VIII. ADDITIONAL EXAMPLES OF BANDWIDTH AND/OR LATENCY ESTIMATION

Certain implementations of Distrix may benefit if the bandwidth and/or latency over each link are accurately estimated for at least 2 reasons. First, the traffic can be distributed over each link according to the available bandwidth/latency, and second, the prioritization can function correctly (e.g., if the bandwidth of a link is overestimated, then data will be lost regardless of priority).

In some versions, Distrix estimates link bandwidth and latency using an ack-based method. This may have several disadvantages in some applications or implementations. For example, an ack-based method may require that at least some of the traffic be acked by Distrix (which may not otherwise be necessary), leading to additional bandwidth overhead. For traffic going over Distrix tunnels (e.g., TCP traffic over an Ethernet tunnel) an ack-based method can lead to 3 or more ack packets for every data packet (since the data packet would typically be fragmented, with an ack for each fragment, and the TCP ack response would be acked by Distrix as well). Further, an ack-based method may be sensitive to varying latency. If latency for some packets is very high, then the packets would be seen as lost because the ack would time out. This can be common over wireless links where the latency for a single packet might be 20 times the average latency. Note that with some ack-based methods, it may be beneficial to not set the timeout for an ack too high (to avoid latency sensitivity for example) since that might cause the response to actual packet loss to take a long time. Also, it may be complicated to determine the actual achieved bandwidth based on the acks. For example, the system can determine the bandwidth at the sending side that was acked, but there may be no easy way to determine what the bandwidth at the receiving side was. For example, the bandwidth on the receiving side might be significantly lower due to queuing in the network.

In view of at least some of the foregoing disadvantages, certain implementations of Distrix that are described below use embodiments of new methods of bandwidth estimation that solve one or more of these issues. The basic idea of one embodiment is that the system (e.g., the Communication Layer 112 discussed with reference to FIG. 1B) does not ack any of the data flowing over the links (any reliability is provided by higher layers). Instead, for each link the system periodically sends a bandwidth request to the remote side of the link, ensuring that the bandwidth overhead is low by not sending too frequently. The bandwidth request contains a request index, a current timestamp, and an amount of data that has been sent since the previous request (in some cases, the system includes the amount sent in a number (e.g. 4) of the most recent periods, to deal with packet loss of the bandwidth request/response). The bandwidth request can also (additionally or alternatively) contain the total amount of data sent since creation of the data link (and/or total amounts from one or more previous requests).

When the receiving side receives a bandwidth request, it can respond with one or more of (1) the same request index, (2) the timestamp (copied from the request), (3) the amount of data received since the last received bandwidth request, and/or (4) the amount of data that the sender sent since the last received request. This can be calculated from the sent amounts contained in the request, so that if up to, e.g., 3 requests were lost in the network, a value can still be calculated. If the last received request was too old (e.g., more than 3 consecutive requests were lost) then this value can be set to “unknown” (e.g., −1). The receiving side can also respond with (5) the interval between when the current request was received and when the previous request was received and/or (6) the calculated interval between when the current request was sent, and when the previous request was sent (this can be calculated from the request timestamps). In some current implementations, the bandwidth request and response are both about 100 bytes (including headers and encryption).

Further, in some implementations, the bandwidth request can contain a total amount of data sent since the creation of the data link up to the time of the request, as well as one or more totals from previous requests. When the request is received by the remote side, the remote side can use the totals in the bandwidth request to calculate the amount sent since the last request that it received (which might not be the last request that was sent, due to packet loss). Such implementations can allow accurate bandwidth measurement even when some request packets are lost. In some such implementations, the receiving side can track the amount of data received since the last bandwidth request was received.

When the sending side receives the bandwidth response, it can adjust its bandwidth estimate accordingly. The actual achieved bandwidth can be calculated by dividing the amount of data received by the receive interval. The percentage of data lost in transit can be calculated based on the amount sent and the amount received. The link latency can be determined by subtracting the timestamp in the response from the current time. Note that the sending side may track the amount of data sent. The receiving side can track the amount of data received since the last received request, and the receipt time and timestamp of the last received request.

FIG. 16A is a flow chart illustrating an embodiment of a method 1650 to generate a bandwidth estimate or a latency estimate of a network data link between two computing nodes of a communication network. The method 1650 can be performed under control of a communication layer component (e.g., the Communication Layer 112 or the network overlay architecture 120) configured to manage transmission of data packets among a plurality of computing nodes. At least some of the plurality of computing nodes comprise physical computing devices, and the communication layer component comprises physical computing hardware. The method 1650, at block 1655, sends a bandwidth request to a remote side of the network data link. The bandwidth request can comprise a request index, a current timestamp, and an amount of data sent since a previous bandwidth request. The method 1650 continues at block 1660 by receiving from the remote side of the network data link a response to the bandwidth request. The response can comprise the request index, the current timestamp, an amount of data received since the previous bandwidth request, and a receive interval between when the current bandwidth request was received and when the previous bandwidth request was received. At block 1665, the method 1650 calculates an achieved network bandwidth based at least partly on the bandwidth request and the response. For example, the achieved network bandwidth can be calculated based on a ratio of the amount of data received since the previous bandwidth request and the receive interval. Additionally or optionally, at block 1670, the method 1650 calculates a link latency based at least partly on the bandwidth request and the response. For example, the latency can be calculated based at least in part on a difference between the current timestamp in the response and the current time.

The bandwidth estimation method 1650 may be run simultaneously and independently on each side of a data link (since data flow is generally bidirectional); here the discussion focuses on the bandwidth estimation on just one side of the link (since the bandwidth estimation on the other side of the link can be performed similarly).

In some embodiments, the bandwidth estimation method 1650 includes the following actions. The bandwidth estimation method can be implemented, for example, by the Communication Layer 112 of the communication network 100 or network overlay architecture 120.

1. Initialize the bandwidth estimate to a small value (e.g., 10 KB/s by default). The latency estimate is set based on the latency calculated during initial link setup.

2. Send an initial bandwidth request to initialize the information tracked by the receiving side.

3. Periodically send bandwidth requests to the receiving side. For example, the system initially can send requests with a small period (e.g., 10 ms) to get a reasonable bandwidth estimate quickly. The system can then slow down the request period to a longer period (e.g., every 50 ms). Requests are only sent if data is also being sent (e.g., a request is sent only if at least 8 KB of data has been sent since the last request—this is to ensure that the overhead for bandwidth estimation is not too large); if no data is being sent at all, the system can send a request over a much longer period, e.g., every 10 seconds or 10 (or some other multiple) times the RTT (whichever is larger) just to maintain the latency estimate. RTT is the Round-Trip Time for a link. For example, acks may be used to calculate the latency for each link. When each segment is sent, the send time can be recorded; when the ack is received for that segment, if the ack was received over the link that the segment was sent over, the round-trip time (RTT) can be calculated.

For some implementations of Distrix, it can be beneficial that the bandwidth request period is no larger than ½ the time to drain the maximum queue size, so that at least some request periods will be filled with maximum-rate data flow. Otherwise the bandwidth estimation may think that the current estimate is not being fully used, and will not increase the estimate even if data is being dropped and there actually is available bandwidth.

4. Each bandwidth request can be given a timeout of (1 RTT)+max(1 second, 4*max jitter). If no response is received before the timeout elapses, the request is assumed to have been lost, and the following operations can be taken in some embodiments: (A) the bandwidth estimate is reduced by a small amount (e.g., to 31/32 of its old value); and (B) if 3 requests have timed out in a row, the bandwidth estimate is reduced to ¾ of its old value, and the max jitter is doubled. Also, the rate at which the bandwidth estimate increases is reduced.

5. When a bandwidth response is received, the system first calculates the latency as (current time)−(response timestamp). The jitter may be calculated as abs(latency, latency estimate). If the jitter is higher than the current max jitter, the max jitter is set to the new jitter value. Note that the max jitter value for a link can be reduced to ⅞ of its value every second or 2 RTT, whichever is longer.

The latency estimate for the link can be updated as a weighted average of the previous latency estimate and the calculated latency, e.g., ((7*old latency estimate)+(calculated latency))/8. This advantageously provides smoothing of the latency estimate. Different smoothing weights can be used. Likewise, in some embodiments, the network bandwidth estimate can be updated as a weighted average of the previous bandwidth estimate and the current calculated bandwidth.

6. The system can calculate the achieved bandwidth as (amount received)/(receive interval). The system generally cannot simply set the bandwidth estimate to the achieved bandwidth, since there may not have been much traffic being sent during that period (e.g., the link is not always fully saturated with traffic). Instead, if the amount of data sent during the period is less than the amount received, the system may need to reduce the bandwidth estimate. In some cases, the system allows a packet loss of up to a threshold amount (e.g., 1/128) of data sent—this is so that Transmission Control Protocol (TCP) running over Distrix does not throttle itself due to loss (TCP can usually handle packet loss of up to 1%). If the packet loss is greater than the threshold amount (e.g., > 1/128), and the achieved bandwidth is less than (1−threshold amount (e.g., 127/128) of the current bandwidth estimate, then the bandwidth estimate can be reduced. Note that if the achieved bandwidth is similar to or greater than the current estimate, then the system does not need to reduce the bandwidth estimate even if the packet loss was high.

When reducing the bandwidth estimate, the system could simply set it to the actual achieved bandwidth. However, this may be undesirable in some instances, since if the amount of data sent during that period was low (and some packets happened to be lost or were reordered), the bandwidth estimate may be reduced to a very small number unnecessarily. Instead, the system can scale the current bandwidth estimate by (amount received)/(amount sent). This is accurate when the amount sent was close to the current bandwidth estimate, and is fair when the amount sent was small. When bandwidth is reduced, the rate at which the bandwidth estimate can increase is reduced.

The system can track by how much the bandwidth was reduced, and the amount of missing data that caused that reduction. In subsequent periods, if the amount received was greater than the amount sent, it means that some packets were reordered (rather than lost), and so the previous reduction was unnecessary. In that case, the system can restore the bandwidth estimate by (amount previously reduced)*(extra data)/(previously missing data). If there is no previously missing data (or fewer than the extra data) then the system can assume that some data was “borrowed” from the next period. This borrow amount is stored and can be added to the “amount received” for the next period.

7. Queue detection. This optional feature allows detection of queuing within the network (e.g., “buffer bloat”). When there are large queues within the network, overall latency can be greatly increased without any increase in achieved bandwidth. This can be detected by noting that when a queue is filling up, no data will be lost, but the data will be received slower than it was sent. Using the send interval and the receive interval in the bandwidth response, the system can detect any “interval stretch” that might indicate queuing. For each link the system can maintain the current interval stretch; whenever a new bandwidth response is received, the system can add the interval stretch for that period to the current interval stretch. Note that the stretch may be positive or negative depending on latency variation. If the current interval stretch for the link exceeds some threshold value (e.g., 10 ms or latency/4, whichever is larger), then queuing is assumed to be occurring. The bandwidth estimate is reduced to a fraction (e.g., 15/16) of the maximum achieved bandwidth over a number (e.g., 4) of the last periods (to try to get the queue to drain, the system sets the bandwidth estimate slightly lower than the achieved bandwidth), and the interval stretch can be set back to 0. The interval stretch can also be set to 0 if it was negative whenever the bandwidth estimate is increased.

8. If the bandwidth estimate was not decreased, it may be increased. This may happen whenever the achieved bandwidth is at least a factor (e.g., 127/128) of the current bandwidth estimate (minus one maximum segment size to avoid issues when the bandwidth is very low). The bandwidth estimate can be increased by some increase ratio, which may change over time (e.g., in some implementations, it is increased by at least min(1024, estimate/100)). The initial increase ratio is, for example, 5/4. If more than a number (e.g., 3) increases happen in a row (e.g., the bandwidth is not decreased between increases) then the ratio is increased. Whenever the bandwidth estimate is reduced, the ratio is decreased. Examples of the available ratios are: 1, 129/128, 65/64, 33/32, 17/16, 9/8, 5/4, 3/2, and 2; however, other ratios can be used in other implementations. By changing the ratio, the bandwidth estimate will rapidly approach the true bandwidth and then oscillate around it, getting closer and closer. If the available bandwidth increases, the bandwidth estimate will start to increase as well, at first slowly, and then faster as the ratio increases, until it exceeds the available bandwidth and reductions start occurring again.

### Reliable Data:

This bandwidth estimation method can also be used by the system for reliable data. For example the system can use this method when creating a reliable stream for remote Application Programming Interface (API) manipulation. The method when applied to reliable streams can have a few differences.

Rather than measuring the effective bandwidth at the received end, the system can measure the effective bandwidth that was successfully acked at the sender side. The receiver simply echoes the bandwidth request back; the sending side tracks the sent amount and the acked amount.

Queue detection is generally not necessary as it can be done by the link bandwidth estimation.

The system can allow higher packet loss since the system is not tunneling another reliable stream (such as TCP) over the reliable stream. For example, the system can use a threshold packet loss of 1/32 rather than 1/128.

The bandwidth response can contain the queue size on the receiving side so that the system can determine when it is acceptable to send more data.

### Intrinsic Packet Loss Estimation:

It is possible to use the bandwidth estimation information to estimate the intrinsic packet loss (e.g., packet loss caused by transmission errors rather than by congestion). This may be useful for wireless link which are typically fairly lossy (and the loss rate can change based on environmental changes). In some systems, the following operations can occur:

Along with the bandwidth estimate, the system can maintain an estimate of the current packet loss (initially set to 0) and some measure of confidence in each estimate (representing the width of the probability distributions of the bandwidth estimate and packet loss estimate).

The system can create a model for how the packet loss and available bandwidth can change over a given time period. For example, a simple linear model would be effective, but other models (e.g., higher order polynomial models, splines, etc.).

For each bandwidth response, a new measurement of packet loss and achieved bandwidth can be determined. This can be used to update the packet loss estimate and bandwidth estimate. For example, in some applications, a Kalman filter (or similar algorithm) based on the models for packet loss and bandwidth can be used. A Bayesian model, Markov model, or other estimation model can be used.

As discussed further herein, code modules that implement the functionality described herein can be included in the Distrix core library, for example in the Communication Layer 112. The code modules can be stored on non-transitory computer storage. A physical computing system (e.g., a hardware processor) can execute particular code modules to provide the Communication Layer 112 the functionality described herein.

### IX. ADDITIONAL EXAMPLES AND EMBODIMENTS

The '357 patent, which is incorporated by reference herein in its entirety for all it contains so as to form a part of this specification, describes additional features that can be used with various implementations described herein. For example, the '357 patent describes examples of a DIOS framework and architecture with specific implementations of some of the features discussed herein. In various implementations, the DIOS architecture includes features that may be generally similar to various features of the Distrix architecture described herein. Many such features of the DIOS examples described in the '357 patent can be used with or modified to include the functionalities described herein. Also, various examples of the Distrix architecture can be used with or modified to include DIOS functionalities. The disclosure of the '357 patent is intended to illustrate various features of the present specification and is not intended to be limiting.

### Additional Example Implementations

In accordance with one aspect of the disclosure, a digital network communication system comprises a communication layer component that is configured to manage transmission of data packets among a plurality of computing nodes, at least some of the plurality of computing nodes comprising physical computing devices, the communication layer component comprising a physical computing device configured to receive, from a computing node, one or more data packets to be transmitted via one or more network data links; estimate a latency value for at least one of the network data links; estimate a bandwidth value for at least one of the network data links; determine an order of transmitting the data packets, wherein the order is determined based at least partly on the estimated latency value or the estimated bandwidth value of at least one of the network data link; and send the data packets over the network data links based at least partly on the determined order. In some implementations, the system can identify at least one of the one or more network data links for transmitting the data packets based at least partly on the estimated latency value of the estimated bandwidth value. The system can send the data packets over the identified at least one of the network data links based at least partly on the determined order.

In some embodiments, the communication layer component is further configured to calculate the estimated latency value and the estimated bandwidth value periodically. In some embodiments, the communication layer component is further configured to restrict a rate at which the data packets are sent over the at least one of the network data links, wherein the rate is configured to be lower than the estimated bandwidth value. In some embodiments, the communication layer component is further configured to determine whether a data packet can be sent over the at least one of the network data links without exceeding the estimated bandwidth value using a burst bucket. In some embodiments, the communication layer component is further configured to aggregate two or more of the network data links into a single connection to a computing node. In some embodiments, the two or more of the network data links are configured to implement different transmission protocols. In some embodiments, the communication layer component is further configured to divide at least one of the data packets to be transmitted to the computing node into one or more segments; and transmit the one or more segments for the at least one of the data packets over the single connection or over two or more data links.

In some embodiments, the communication layer component is further configured to receive the one or more segments; and assemble the one or more segments into the at least one of the data packets. In some embodiments, the communication layer component is further configured to sort the two or more network data links in the single connection based at least partly on an overflow priority associated with each of the network data links; and send the data packets over a first network data link upon determining that there is no network data link that is associated with an overflow priority that is lower than the overflow priority of the first network data links. In some embodiments, the communication layer component is further configured to upon creation of a new network data link, automatically aggregate the new network data link into the single connection to the computing node; and upon termination of the new network data link, automatically remove the new network data link from the single connection to the computing node.

In some embodiments, the communication layer component is further configured to calculate an expected arrival time for at least one of the data packets for each of the network data links; and send all or part of the at least one of the data packets via one of the network data links with an expected arrival time that is lower than all other network data links. In some embodiments, the communication layer component is further configured to upon determining that all or part of the at least one of the data packets cannot be sent immediately via the one of the network data link with the expected arrival time that is lower than all the other network data links, wherein the expected arrival time is less than an estimated latency value that is higher than all other estimated latency values of the network data links, insert the data packet into a queue; remove the data packet from the queue; and send the data packet via one of the network data links with the expected arrival time that is lower than all the other network data links. In some embodiments, the communication layer component is further configured to calculate the expected arrival time of the data packet based at least partly on the estimated latency value and an estimated amount of time the data packet stays in the queue before being sent via one of the network data links.

In some embodiments, the communication layer component is further configured to set a start time to a current time, and a data amount to zero; determine whether a data packet of the one or more data packets is a member of a subset of data packets; upon determining that a data packet of the one or more data packets is a member of the subset, calculate an interval as (the current time−the start time); upon determining that the interval is larger than an averaging period, set an updated data amount to (size of the data packet+(the data amount*the averaging period)/(the interval)), and an updated start time to (the current time−the averaging period); and calculate an estimated data rate for the subset as (the updated data amount)/(the current time−the start time). The system may also be configured such that the communication layer component is further configured to provide a plurality of reserved bandwidth streams, wherein each of the reserved bandwidth streams further comprises a bandwidth allocation; assign each data packet of the one or more data packets to a reserved bandwidth stream; and determine the order of transmitting each data packet of the one or more data packets based at least in part on a determination that the data rate of a reserved bandwidth stream for which a data packet is assigned to does not exceeded the bandwidth allocation for the reserved bandwidth stream.

In accordance with another aspect of the disclosure, a digital network communication system comprises a communication layer component that is configured to manage transmission of data packets among a plurality of computing nodes, at least some of the plurality of computing nodes comprising physical computing devices, the communication layer component comprising a physical computing device configured to assign a priority value to each of the data packets; calculate an estimated amount of time a data packet will stay in a queue for a network data link by accumulating a wait time associated with each data packet in the queue with a priority value higher than or equal to the priority value of the data packet that will stay in the queue; and calculate an estimated wait time for the priority value, wherein the estimated wait time is based at least partly on an amount of queued data packets of the priority value and an effective bandwidth for the priority value, wherein the effective bandwidth for the priority value is based at least partly on a current bandwidth estimate for the network data link and a rate with which data packets associated with a priority value that is higher than the priority value are being inserted to the queue.

In some embodiments, the estimated wait time for the priority value is (the amount of queued data packets of the priority value)/(the effective bandwidth for the priority value), and the effective bandwidth for the priority value is (the current bandwidth estimate for the network data link minus the rate with which data packets associated with a priority value that is higher than the priority value is being inserted to the queue). In some embodiments, the communication layer component is further configured to set a start time to a current time, and a data amount to zero; determine whether a data packet is a member of a subset of data packets; upon determining that a data packet is a member of the subset, calculate an interval as (the current time−the start time); upon determining that the interval is larger than an averaging period, set an updated data amount to (size of the data packet+(the data amount*the averaging period)/(the interval)), and an updated start time to (the current time−the averaging period); and calculate an estimated data rate for the subset as (the updated data amount)/(the current time−the start time).

In some embodiments, the communication layer component is further configured to provide a plurality of reserved bandwidth streams, wherein each of the reserved bandwidth streams further comprises a bandwidth allocation; assign each data packet to a reserved bandwidth stream; and determine the order of transmitting each data packet based at least in part on a determination that the data rate of a reserved bandwidth stream for which a packet is assigned to does not exceeded the bandwidth allocation for the reserved bandwidth stream. In some embodiments, the communication layer component is further configured to assign a priority to each reserved bandwidth stream; and upon determining that the data rate for a reserved bandwidth stream has not exceeded the bandwidth allocation for that stream, transmit data packets assigned to a stream with a higher priority before transmitting data packets assigned to a stream with a lower priority.

According to another aspect of the disclosure, a digital network communication system comprises a communication layer component that is configured to manage transmission of data packets among a plurality of computing nodes, at least some of the plurality of computing nodes comprising physical computing devices, the communication layer component comprising a physical computing device configured to create a queue for each of a plurality of reserved bandwidth streams; add data packets that cannot be transmitted immediately and are assigned to a reserved bandwidth stream to the queue for the stream; create a ready-to-send priority queue for ready-to-send queues; create a waiting-for-bandwidth priority queue for waiting-for-bandwidth queues; move all queues in the waiting for bandwidth priority queue with a ready-time less than a current time into the ready to send priority queue; select a queue with higher priority than all other queues in the ready to send priority queue; and remove and transmit a first data packet in the queue with higher priority than all other queues in the ready to send priority queue. In some embodiments, the communication layer component is further configured to create the queue for the plurality of reserved bandwidth streams on-demand upon receiving a first data packet assigned to one of the plurality of reserved bandwidth streams.

In accordance with another aspect of the disclosure, a method for managing a queue of data items for processing comprises under control of a physical computing device having a communication layer that provides communication control for a plurality of computing nodes, at least some of the plurality of computing nodes comprising physical computing devices; determining whether the queue of data items is empty; adding a new data item to the queue of data items; removing a data item from the queue for processing; and removing a data item from the queue without processing the data item, wherein removing the data item from the queue without processing further comprises selecting the data item based at least partly on a probability function of time.

In some embodiments, the probability function of time is configured to have a value of zero for a period of time and increased values after the period of time. In some embodiments, the probability function further comprises a quadratic function for the increased values. In some embodiments, the method further comprises upon determining that the queue changes from being empty to non-empty, setting a start time based at least in part on a current time minus a time when a last data item is inserted to the queue or a time when a last data item is removed from the queue without processing. In some embodiments, the method further comprises setting an decay end time to zero; upon determining that the queue is empty and a data item is being inserted to the queue, setting the start time based on the current time and the decay end time, wherein the start time is set to the current time if the current time is greater than or equal to the decay end time, and is set to (the current time−(the decay end time−the current time)) if the current time is less than the decay end time; and upon determining that the queue is not empty and a data item is being inserted to the queue or removed from the queue, updating the decay end time based at least partly on the interval between the current time and the start time. In some embodiments, the method further comprises calculating an interval between the current time and the start time; calculating a saturation time; upon determining the interval is smaller than the saturation time, setting the decay end time to the current time plus the interval; and upon determining that the interval is larger than or equal to the saturation time, setting the decay end time to the current time plus the saturation time.

In accordance with one aspect of the disclosure, a digital network communication system comprises a communication layer component that is configured to manage transmission of data packets among a plurality of computing nodes, at least some of the plurality of computing nodes comprising physical computing devices, the communication layer component configured to receive, from a computing node, a plurality of data packets to be transmitted via a plurality of network data links; estimate a latency value for at least one of the network data links; estimate a bandwidth value for at least one of the network data links; determine an order of transmitting the plurality of data packets based at least partly on the estimated latency value and the estimated bandwidth value; send the plurality of data packets over the network data links based at least partly on the determined order.

In some embodiments, the communication layer component is further configured to aggregate two or more of the network data links into one connection. In some embodiments, the two or more of the network data links comprise at least two different types of network data links. In some embodiments, the communication layer component is further configured to determine a priority of data transmission, wherein the priority comprises percentage of available bandwidth of at least one of the network data links. In some embodiments, the communication layer component is further configured to calculate an expected arrival time of a data packet for each network data link and send the data packet via a network data link with the lowest expected arrival time. In some embodiments, the communication layer component is further configured to calculate an expected amount of time needed to send a data packet and an expected arrival time of a data packet, and send the data packet via a network data link with the lowest expected arrival time.

In some embodiments, the communication layer component is further configured to determine a priority of data transmission, wherein the priority comprises an amount of bandwidth guaranteed for a plurality of respective levels of priority. In some embodiments, the communication layer component is further configured to divide the plurality of data packets into a plurality of segments and record a starting position and a length of each segment. In some embodiments, the communication layer component is further configured to estimate the bandwidth value based at least partly on a start time, a current time, an amount of data sent since the start time, and an averaging period. In some embodiments, the communication layer component is further configured to reserve an amount of bandwidth for the plurality of data packets using one or more priority queues. In some embodiments, the priority queues are further configured to be represented as in a no packet in queue state, a waiting for bandwidth state, and a ready to send state.

In some embodiments, the communication layer component is further configured to determine a maximum amount of time that data packets are accepted for one of the priority queues and probabilistically drop data packets arriving after the maximum amount of time using a probability function. In some embodiments, the probability function is a quadratic drop rate function. In some embodiments, the communication layer component is further configured to identify a first data packet with the earliest arrival time from a priority queue with a lowest priority among the priority queues, identify a second data packet with the earliest arrival time from bandwidth that is not reserved, and compare priority of the first data packet and priority of the second data packet, and drop one of the first and second data packets with the lower priority.

According to another aspect of the disclosure, a computer-implemented method for digital network communication comprises under control of a communication layer that provides communication control for a plurality of computing nodes, at least some of the plurality of computing nodes comprising physical computing devices; receiving, from a computing node, a plurality of data packets to be transmitted via a plurality of network data links; estimating a latency value for at least one of the network data links; estimating a bandwidth value for at least one of the network data links; determining an order of transmitting the plurality of data packets based at least partly on the estimated latency value and the estimated bandwidth value; and sending the plurality of data packets over the network data links based at least partly on the determined order.

In some embodiments, the method further comprises aggregating two or more of the network data links into one connection. In some embodiments, the method further comprises a priority of data transmission, wherein the priority comprises percentage of available bandwidth of at least one of the network data links. In some embodiments, the method further comprises determining a priority of data transmission, wherein the priority comprises an amount of bandwidth guaranteed for a plurality of respective levels of priority. In some embodiments, the method further comprises estimating the bandwidth value based at least partly on a start time, a current time, an amount of data sent since the start time, and an averaging period. In some embodiments, the method further comprises under control of a communication layer that provides communication control for a plurality of computing nodes, at least some of the plurality of computing nodes comprising physical computing devices, receiving, from a first computing node, a plurality of data packets to be transmitted via a plurality of network data links; setting a start time to current time and an amount of data sent to zero; calculating an interval as the difference between the current time and start time; upon determining the interval is larger than an averaging period, setting an updated new amount of data sent to (size of a data packet+(the amount of data sent*the averaging period)/(the interval)); setting an updated new start time to the difference between current time and averaging period; and calculating an estimated bandwidth as (the updated new amount of data sent/(current time−start time).

In a first aspect, a digital network communication system comprises a communication layer component that is configured to manage transmission of data packets among a plurality of computing nodes, at least some of the plurality of computing nodes comprising physical computing devices. The communication layer component comprises a physical computing device configured to estimate network bandwidth of a network data link between two computing nodes by sending a current bandwidth request to a remote side of the network data link, the current bandwidth request comprising a request index, a current timestamp, and an amount of data sent since a previous bandwidth request or since creation of the network data link. The communication layer component is configured for receiving from the remote side of the network data link a response to the bandwidth request, the response comprising the request index, the current timestamp, an amount of data received since the previous bandwidth request, and a receive interval between when the current bandwidth request was received and when the previous bandwidth request was received. The communication layer component is further configured for calculating an achieved network bandwidth based on a ratio of the amount of data received since the previous bandwidth request and the receive interval, and determining an estimated network bandwidth based at least in part on the achieved network bandwidth.

In a second aspect, the digital network communication system of aspect 1, wherein if network packet loss is greater than a threshold and the achieved bandwidth is less than (1-threshold) of the estimated network bandwidth, the communication layer component is configured to reduce the estimated network bandwidth by a factor based at least in part on the amount of data received since the previous bandwidth request and the amount of data sent since a previous bandwidth request.

In a third aspect, the digital network communication system of aspect 2, wherein in a subsequent time period, if an amount of data received is greater than an amount of data sent, the communication layer component is configured to restore the estimated network bandwidth based at least in part on an amount by which the estimated network bandwidth was reduced, an amount by which the received data is greater than the sent data, and an amount of data lost in earlier time periods.

In a fourth aspect, the digital network communication system of any one of aspects 1-3, wherein the communication layer component is further configured to calculate a percentage of data lost in transit based at least in part on the amount of data sent since the previous bandwidth request and the amount of data received since the previous bandwidth request.

In a fifth aspect, the digital network communication system of any one of aspects 1-4, wherein the communication layer component is further configured to calculate a link latency based at least in part on a difference between the current timestamp in the response and the current time.

In a sixth aspect, the digital network communication system of any one of aspects 1-5, wherein the communication layer component is configured to send a first plurality of network bandwidth requests having a first period of time between successive network bandwidth requests, and to calculate a first network bandwidth based on the first plurality of network bandwidth requests.

In a seventh aspect, the digital network communication system of aspect 6, wherein the communication layer component is configured to send a second plurality of network bandwidth requests having a second period of time between successive bandwidth requests, and to calculate a second network bandwidth based on the second plurality of network bandwidth requests, wherein the second plurality of network bandwidth requests is sent after the first plurality of network bandwidth requests is sent, and the second period of time is longer than the first period of time.

In an eighth aspect, the digital network communication system of aspect 6, wherein the communication layer component is configured to send the first plurality of network bandwidth requests only when other network data is being sent over the network data link.

In a ninth aspect, the digital network communication system of aspect 6, wherein if no data is being sent over the network data link, the first period of time is a multiple of a round trip time (RTT) for the network data link, the multiple greater than one.

In a tenth aspect, the digital network communication system of aspect 6, wherein network data is queued into a queue with a maximum queue size, and the first period of time is less than one-half of a time to drain the maximum queue size.

In an eleventh aspect, the digital network communication system of any one of aspects 1-10, wherein the communication layer component is further configured to detect queuing based on an interval stretch calculated based at least in part on a time period between successive network bandwidth requests and the receive interval between when the current bandwidth request was received and when the previous bandwidth request was received.

In a twelfth aspect, the digital network communication system of aspect 11, wherein the communication layer component is configured to reduce the estimated network bandwidth if the interval stretch is greater than a threshold.

In a thirteenth aspect, the digital network communication system of aspect 12, wherein the threshold is based at least in part on an estimated latency of the network link.

In a fourteenth aspect, the digital network communication system of any one of aspects 1-13, wherein the communication layer component is further configured to estimate intrinsic packet loss by maintaining an estimate of current packet loss and a measure of confidence in the estimate of current packet loss, utilizing a model for time variability of packet loss and available bandwidth, and applying a filter to update the estimated current packet loss and estimated network bandwidth based at least partly on the model.

In a fifteenth aspect, the digital network communication system of aspect 14, wherein the model comprises a Bayesian model or a Markov model.

In a sixteenth aspect, the digital network communication system of aspect 14 or aspect 15, wherein the filter comprises a Kalman filter.

In a seventeenth aspect, the digital communication system of any one of aspects 1-16, wherein the current bandwidth request is associated with a timeout, and if the response is not received within the timeout, the communication layer component is configured to reduce the estimated network bandwidth and to increase an estimate of network jitter.

In an eighteenth aspect, a computer-implemented method for estimating network bandwidth and latency of a network data link between two computing nodes of a communication network is provided. The method is performed under control of a communication layer component configured to manage transmission of data packets among a plurality of computing nodes, with at least some of the plurality of computing nodes comprising physical computing devices, and with the communication layer component comprising physical computing hardware. The method comprises sending a current bandwidth request to a remote side of the network data link, with the current bandwidth request comprising a request index, a current timestamp, and an amount of data sent since a previous bandwidth request; and receiving from the remote side of the network data link a response to the bandwidth request, with the response comprising the request index, the current timestamp, an amount of data received since the previous bandwidth request, and a receive interval between when the current bandwidth request was received and when the previous bandwidth request was received. The method further comprises calculating an achieved network bandwidth based on a ratio of the amount of data received since the previous bandwidth request and the receive interval; and calculating a link latency based at least in part on a difference between the current timestamp in the response and the current time.

In a nineteenth aspect, the computer-implemented method of aspect 18 further comprises calculating a percentage of data lost in transit based at least in part on the amount of data sent since the previous bandwidth request and the amount of data received since the previous bandwidth request.

In a twentieth aspect, the computer-implemented method of aspect 18 or aspect 19, further comprising detecting network queuing based on an interval stretch calculated based at least in part on a time period between successive network bandwidth requests and the receive interval between when the current bandwidth request was received and when the previous bandwidth request was received.

Non-transitory computer-readable storage comprising machine-executable instructions, that when executed by a computing device, cause the computing device to execute the method of any one of aspects 18-20.

### X. CONCLUSION

The present disclosure describes non-limiting examples of some embodiments of estimating bandwidth and/or latency, among other network parameters. Other embodiments of the disclosed systems and methods may or may not include the features described herein. Moreover, disclosed advantages and benefits may apply to only certain embodiments of the disclosure and should not be used to limit the disclosure.

Each of the processes, methods, and algorithms described in this specification may be embodied in, and fully or partially automated by, code modules executed by one or more physical computing systems, computer processors, application-specific circuitry, and/or electronic hardware configured to execute computer instructions. For example, computing systems can include general purpose computers particularly configured with specific executable instructions, special purpose computers, servers, desktop computers, laptop or notebook computers or tablets, personal mobile computing devices, mobile telephones, network routers, network adapters, and so forth. A code module may be compiled and linked into an executable program, installed in a dynamic link library, or may be written in an interpreted programming language. Various embodiments have been described in terms of the functionality of such embodiments in view of the interchangeability of hardware and software. Whether such functionality is implemented in hardware or software depends upon the particular application and design constraints imposed on the overall system.

Code modules may be stored on any type of non-transitory computer-readable medium, such as physical computer storage including hard drives, solid state memory, random access memory (RAM), read only memory (ROM), optical disc, volatile or non-volatile storage, combinations of the same and/or the like. The methods and modules may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The results of the disclosed processes and process steps may be stored, persistently or otherwise, in any type of non-transitory, tangible computer storage or may be communicated via a computer-readable transmission medium.

Any processes, blocks, states, steps, or functionalities in flow diagrams described herein and/or depicted in the attached figures should be understood as potentially representing code modules, segments, or portions of code which include one or more executable instructions for implementing specific functions (e.g., logical or arithmetical) or steps in the process. The various processes, blocks, states, steps, or functionalities can be combined, rearranged, added to, deleted from, modified, or otherwise changed from the illustrative examples provided herein. In some embodiments, additional or different computing systems or code modules may perform some or all of the functionalities described herein. The methods and processes described herein are also not limited to any particular sequence, and the blocks, steps, or states relating thereto can be performed in other sequences that are appropriate, for example, in serial, in parallel, or in some other manner. Tasks or events may be added to or removed from the disclosed example embodiments. Moreover, the separation of various system components in the implementations described herein is for illustrative purposes and should not be understood as requiring such separation in all implementations. In certain circumstances, multitasking and parallel processing may be advantageous. It should be understood that the described program components, methods, and systems can generally be integrated together in a single software product or packaged into multiple software products. Many implementation variations are possible.

The processes, methods, and systems described herein may be implemented in a network (or distributed) computing environment. Network environments include enterprise-wide computer networks, intranets, local area networks (LAN), wide area networks (WAN), personal area networks (PAN), cloud computing networks, crowd-sourced computing networks, the Internet, and the World Wide Web. The network may be a wired or a wireless or a satellite network.

The various elements, features and processes described herein may be used independently of one another, or may be combined in various ways. All possible combinations and subcombinations are intended to fall within the scope of this disclosure. Further, nothing in the foregoing description is intended to imply that any particular feature, element, component, characteristic, step, module, method, process, task, or block is necessary or indispensable for each embodiment. The example systems and components described herein may be configured differently than described. For example, elements or components may be added to, removed from, or rearranged compared to the disclosed examples.

As used herein any reference to “one embodiment” or “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present. In addition, the articles “a” or “an” as used in this application and the appended claims are to be construed to mean “one or more” or “at least one” unless explicitly specified otherwise.

The foregoing description, for purpose of explanation, has been described with reference to specific embodiments, applications, and use cases. However, the illustrative discussions herein are not intended to be exhaustive or to limit the inventions to the precise forms disclosed. Many modifications and variations are possible in view of the above teachings. The embodiments were chosen and described in order to explain the principles of the inventions and their practical applications, to thereby enable others skilled in the art to utilize the inventions and various embodiments with various modifications as are suited to the particular use contemplated.

What is claimed is:

1. A digital network communication system comprising:
a communication layer component that is configured to manage transmission of data packets among a plurality of computing nodes, at least some of the plurality of computing nodes comprising physical computing devices, the communication layer component comprising a physical computing device configured to estimate network bandwidth of a network data link between two computing nodes by:
sending a current bandwidth request to a remote side of the network data link, the current bandwidth request comprising a request index, a current timestamp, and an amount of data sent since a previous bandwidth request or since creation of the network data link;
receiving from the remote side of the network data link a response to the bandwidth request, the response comprising the request index, the current timestamp, an amount of data received since the previous bandwidth request, and a receive interval between when the current bandwidth request was received and when the previous bandwidth request was received;
calculating an achieved network bandwidth based on a ratio of the amount of data received since the previous bandwidth request and the receive interval; and
determining an estimated network bandwidth based at least in part on the achieved network bandwidth.

2. The digital network communication system of claim 1, wherein if network packet loss is greater than a determined threshold, the determined threshold greater than or equal to 0 and less than or equal to 1, and the ratio of the achieved bandwidth to the estimated network bandwidth is less than (1−the threshold), the communication layer component is configured to reduce the estimated network bandwidth by a factor based at least in part on the amount of data received since the previous bandwidth request and the amount of data sent since a previous bandwidth request.

3. The digital network communication system of claim 2, wherein in a subsequent time period, if an amount of data received is greater than an amount of data sent, the communication layer component is configured to restore the estimated network bandwidth based at least in part on an amount by which the estimated network bandwidth was reduced, an amount by which the received data is greater than the sent data, and an amount of data lost in earlier time periods.

4. The digital network communication system of claim 1, wherein the communication layer component is further configured to calculate a percentage of data lost in transit based at least in part on the amount of data sent since the previous bandwidth request and the amount of data received since the previous bandwidth request.

5. The digital network communication system of claim 1, wherein the communication layer component is further configured to calculate a link latency based at least in part on a difference between the current timestamp in the response and the current time.

6. The digital network communication system of claim 1, wherein the communication layer component is configured to send a first plurality of network bandwidth requests having a first period of time between successive network bandwidth requests, and to calculate a first network bandwidth based on the first plurality of network bandwidth requests.

7. The digital network communication system of claim 6, wherein the communication layer component is configured to send a second plurality of network bandwidth requests having a second period of time between successive bandwidth requests, and to calculate a second network bandwidth based on the second plurality of network bandwidth requests, wherein the second plurality of network bandwidth requests is sent after the first plurality of network bandwidth requests is sent, and the second period of time is longer than the first period of time.

8. The digital network communication system of claim 6, wherein the communication layer component is configured to send the first plurality of network bandwidth requests only when other network data is being sent over the network data link.

9. The digital network communication system of claim 6, wherein if no data is being sent over the network data link, the first period of time is a multiple of a round trip time (RTT) for the network data link, the multiple greater than one.

10. The digital network communication system of claim 6, wherein network data is queued into a queue with a maximum queue size, and the first period of time is less than one-half of a time to drain the maximum queue size.

11. The digital network communication system of claim 1, wherein the communication layer component is further configured to detect queuing based on an interval stretch calculated based at least in part on a time period between successive network bandwidth requests and the receive interval between when the current bandwidth request was received and when the previous bandwidth request was received.

12. The digital network communication system of claim 11, wherein the communication layer component is configured to reduce the estimated network bandwidth if the interval stretch is greater than a threshold.

13. The digital network communication system of claim 12, wherein the threshold is based at least in part on an estimated latency of the network link.

14. The digital network communication system of claim 1, wherein the communication layer component is further configured to estimate intrinsic packet loss by:
maintaining an estimate of current packet loss and a measure of confidence in the estimate of current packet loss;
utilizing a model for time variability of packet loss and available bandwidth; and
applying a filter to update the estimated current packet loss and estimated network bandwidth based at least partly on the model.

15. The digital network communication system of claim 14, wherein the model comprises a Bayesian model or a Markov model.

16. The digital network communication system of claim 14, wherein the filter comprises a Kalman filter.

17. The digital communication system of claim 1, wherein the current bandwidth request is associated with a timeout, and if the response is not received within the timeout, the communication layer component is configured to reduce the estimated network bandwidth and to increase an estimate of network jitter.

18. A computer-implemented method for estimating network bandwidth and latency of a network data link between two computing nodes, the method comprising:
under control of a communication layer component configured to manage transmission of data packets among a plurality of computing nodes, at least some of the plurality of computing nodes comprising physical computing devices, the communication layer component comprising physical computing hardware:
sending a current bandwidth request to a remote side of the network data link, the current bandwidth request comprising a request index, a current timestamp, and an amount of data sent since a previous bandwidth request;
receiving from the remote side of the network data link a response to the bandwidth request, the response comprising the request index, the current timestamp, an amount of data received since the previous bandwidth request, and a receive interval between when the current bandwidth request was received and when the previous bandwidth request was received;
calculating an achieved network bandwidth based on a ratio of the amount of data received since the previous bandwidth request and the receive interval; and
calculating a link latency based at least in part on a difference between the current timestamp in the response and the current time.

19. The computer-implemented method of claim 18, further comprising calculating a percentage of data lost in transit based at least in part on the amount of data sent since the previous bandwidth request and the amount of data received since the previous bandwidth request.

20. The computer-implemented method of claim 18, further comprising detecting network queuing based on an interval stretch calculated based at least in part on a time period between successive network bandwidth requests and the receive interval between when the current bandwidth request was received and when the previous bandwidth request was received.

21. Non-transitory computer-readable storage comprising machine-executable instructions, that when executed by a computing device, cause the computing device to execute the method of claim 18.

22. The non-transitory computer-readable storage comprising machine-executable instructions of claim 21, that when executed by the computing device, further cause the computing device to calculate a percentage of data lost in transit based at least in part on the amount of data sent since the previous bandwidth request and the amount of data received since the previous bandwidth request.

23. The non-transitory computer-readable storage comprising machine-executable instructions of claim 21, that when executed by the computing device, further cause the computing device to detect network queuing based on an interval stretch calculated based at least in part on a time period between successive network bandwidth requests and the receive interval between when the current bandwidth request was received and when the previous bandwidth request was received.
